(19) United States
(12) Patent Application Publication
(10) Pub. No.: US 2013/0183971 A1
(43) Pub. Date: Jul. 18, 2013

(54) Systems And/Or Methods For Providing Relay Mobility

(71) Applicants: Nobuyuki Tamaki, Melville, NY (US); Pouriya Sadeghi, Verdun (CA); Ghyslain Pelletier, Laval (CA); Janet A. Stern-Berkowitz, Little Neck, NY (US); Pascal M. Adjakple, Great Neck, NY (US); Li-Hsiang Sun, (US)

(72) Inventors: Nobuyuki Tamaki, Melville, NY (US); Pouriya Sadeghi, Verdun (CA); Ghyslain Pelletier, Laval (CA); Janet A. Stern-Berkowitz, Little Neck, NY (US); Pascal M. Adjakple, Great Neck, NY (US); Li-Hsiang Sun, (US)

(73) Assignee: INTERDIGITAL PATENT HOLDINGS, INC., Wilmington, DE (US)

(21) Appl. No.: 13/571,915

(22) Filed: Aug. 10, 2012

Related U.S. Application Data
(60) Provisional application No. 61/678,936, filed on Aug. 2, 2012.
(60) Provisional application No. 61/644,967, filed on May 9, 2012.
(60) Provisional application No. 61/591,435, filed on Jan. 27, 2012.
(60) Provisional application No. 61/522,361, filed on Aug. 11, 2011.

(51) Int. Cl. H04W 36/16

(52) U.S. Cl. CPC H04W 36/165
USPC 455/436

(57) ABSTRACT

Systems or methods for managing a handover (e.g. over a Un or Uu connection or interface) of a relay from an eNB such as a source eNB to another eNB such as a target eNB may be provided where the source eNB or DeNB may provide a backhaul link to the relay and the relay may provide an access link to a user equipment (UE). To manage the handover, access information may be received and a determination may be made regarding whether one or more target eNBs may be capable of handling the relay based on the access information. Additionally, the relay that may be handed over may be configured to use radio access network (RAN) sharing, a mobility management entity (MME) may be selected, and/or a EUTRAN radio access bearer (E-RAB) may be modified.

### CROSS-REFERENCE TO RELATED APPLICATIONS

This application claims the benefit of U.S. Provisional Application Nos. 61/678,936, filed Aug. 2, 2012, 61/644,967, filed May 9, 2012, 61/591,435, filed Jan. 27, 2012, and 61/522,361, filed Aug. 11, 2011, the contents of which are hereby incorporated by reference in its entirety.

### BACKGROUND

Today, devices such as mobile phones, laptops, tablets, and the like and the use thereof have become increasingly popular as communication mediums in a home, office, and/or school environment. Typically, such devices use wireless communication systems to access data and content. For example, current wireless communication systems include evolved NodeBs (eNodeBs or eNBs) connected to the core network of the wireless communication system. The eNBs communicate directly with the devices to provide access to the core network and, thus, communication functionality including data and content access between the core network and devices. Unfortunately, the cost of such eNBs tends to be expensive and as the demand for wireless communication systems continues to increase and expand, the number of eNBs also increases thereby further driving up cost.

### SUMMARY

Systems and methods for providing and managing wireless communications (e.g., including mobile relays) may be disclosed herein. In one embodiment, such systems and methods may include managing a handover (e.g. over a Un or Uu connection or interface) of a relay such as a mobile relay, relay node (RN), or mobile RN (MRN) from a base station or eNB such as a source eNB or a source donor eNB (DeNB) to another base station or eNB such as a target eNB or DeNB. According to an embodiment, the source eNB or DeNB may provide a backhaul link to the relay and the relay may provide an access link to a user equipment (UE) or wireless transmit and receive unit (WTRU). To manage the handover, access information may be received where the access information may be configured to indicate target eNBs that may be relay capable or relay accessible and/or may include measurements. A determination may then be made regarding whether one or more target eNBs may be capable of handling the relay based on the access information. A target eNB that may be capable of handing the relay based on the determination may be selected from the one or more target eNBs to handover the mobile relay to. In an example embodiment, the selected target eNB may have a communication link with the source eNB. The relay may then be handed over from the source eNB to the selected target eNB using the communication link between the source eNB and selected target eNB. In embodiments (e.g. during or after the handover), the relay may be configured to use radio access network (RAN) sharing, a mobility management entity (MME) may be selected; and/or a EUTRAN radio access bearer (E-RAB) may also be modified.

The Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to any limitations that solve any or all disadvantages noted in any part of this disclosure.

### BRIEF DESCRIPTION OF THE DRAWINGS

A more detailed understanding may be had from the Detailed Description below, given by way of example in conjunction with drawings appended hereto.

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 2 is a diagram illustrating an example communications system including a relay.

FIGS. 3A and 3B are diagrams illustrating example relay handover operations, procedures, or methods.

FIG. 4-5 illustrate example embodiments of network and/or radio resources that may be shared.

FIG. 6 is a diagram illustrating example subframes available for Un reception, Uu transmission, and/or related intra-frequency and inter-frequency measurement opportunities.

FIG. 7 is a diagram illustrating an example subframe configuration with a fractional subframe timing offset (FSTO) between Un and Uu.

FIG. 8 illustrates an example embodiment of a relay handover procedure with a relay node E-RAB modification.

FIG. 9 illustrates an example embodiment of a MME relocation procedure and/or method.

FIG. 10 illustrates an example embodiment of an ATTACH and/or authentication operation, procedure, or method where the authentication to operators may be performed in separate RRC procedures.

FIG. 11 illustrates an example embodiment of an ATTACH and/or an authentication operation, procedure, or method where the authentication to operators may be performed in a single RRC procedure.

### DETAILED DESCRIPTION

Although the detailed description is illustrated and described herein with reference to specific embodiments, the invention is not intended to be limited to the details shown. Rather, various modifications may be made in the details within the scope and range of equivalents of the claims and without departing from the invention.

Systems and methods for implementing relay node (RN) mobility for mobile relays or RNs and/or user equipment (e.g. RN UEs) using various interfaces (e.g. Uu, Un, S1, X2, and the like), resource sharing, and/or radio access bearer modifications may be provided as described herein. For example, RN access information including the collection and/or transfer of access related information for a RN and/or donor eNode-B (DeNB), measurement control associated with a Un interface for a RN, a RN handover initiation and procedure or method, and/or a RN IDLE mode mobility procedure or method may be provided and/or used. Additionally, Un/Uu subframe re-alignment and/or offset handling or management during or after a RN handover, management or handling of RN cell configuration and/or Uu system information changes, management or handling of Uu after transitioning to an IDLE mode and/or a RN detach, and/or management or handling of a tracking area and/or TAU may be provided and/or used. In embodiments, management or handling of RN and/or RN UE context information including RN configurations between a target and/ source DeNB during a preparation for a RN handover and negotiations for enhanced call admission control during a RN handover, management or handling of UE MME changes during a RN handover, management or handling of E-CGI of RN and neighbor eNB information exchange, and/or management or handling a data plane during a RN handover may further be provided and/or used. According to additional embodiments, RN configurations for RAN sharing (e.g. using mobile relays), RN attach and/or authentication (e.g. to multiple PLMN operations) for RAN sharing, RAN sharing procedures or methods, and/or multiple Un support to multiple DeNBs (e.g. methods or procedures for providing multiple Un interfaces to multiple DeNBs) may be provided and/or used. RN MME interface disconnect detection, UE MME relocation, enhanced RN start up for an attach to a DeNB (e.g. a “correct” DeNB), management or handling of RN E-RAB modification during a RN handover and/or call admission, management or handling of RN UE E-RAB based on the RN E-RAB modification during a RN handover, and/or MME selection when a UE (e.g. a RN UE or RN UE E-RAB) may move away from a RN or mobile relay in a connected and/or IDLE mode may also be provided and/or used.

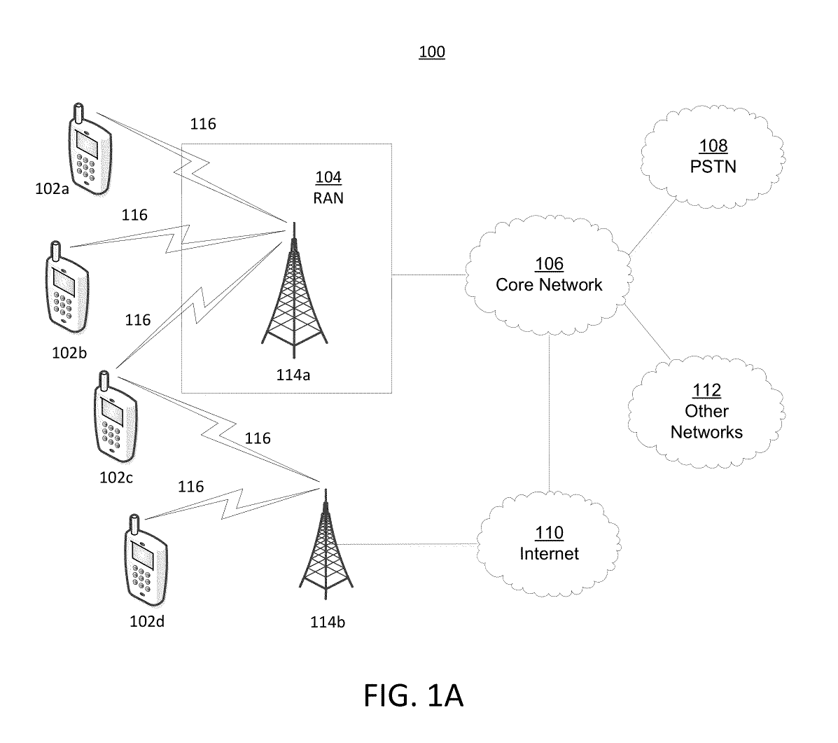

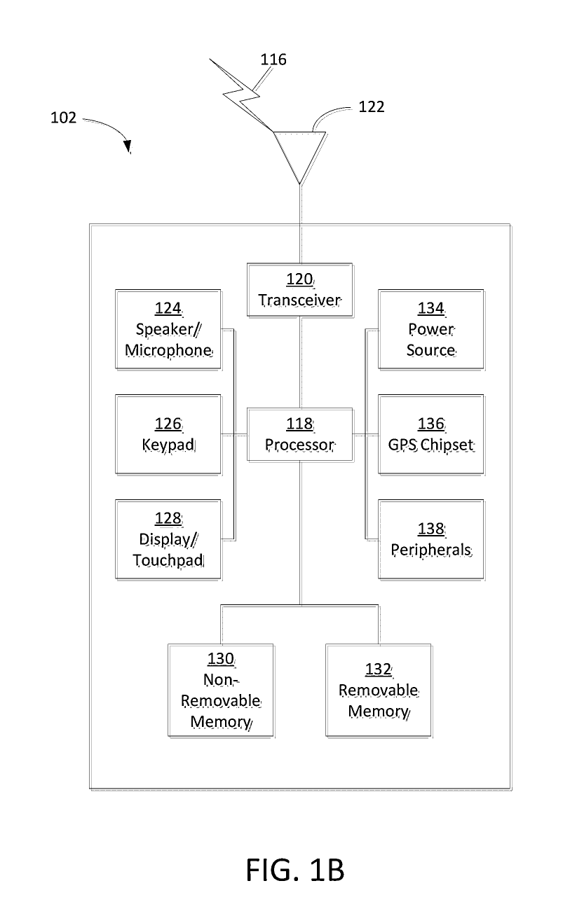

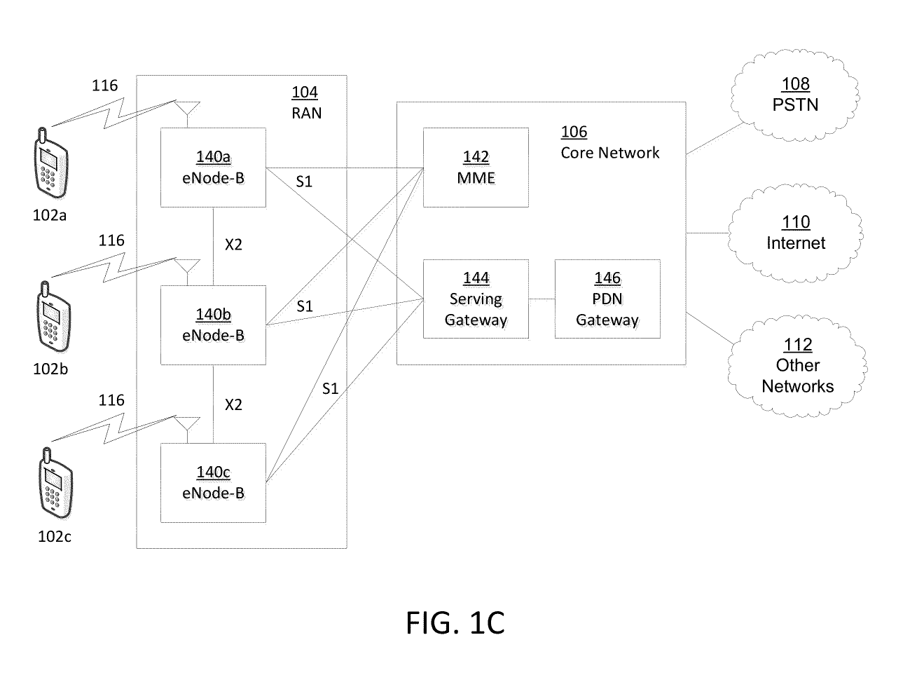

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1x, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

As described above, a wireless communication system such as the communication system 100 shown in FIGS. 1A-1C may include one or more RNs that may be substituted for or installed instead of or in conjunction with one or more eNBs such as the eNBs 140a-140c. According to an example embodiment, a RN may be a lower cost option than installing an eNB or additional eNBs in a wireless system (e.g. to increase bandwidth and support demand from users). For example, RNs may provide a cost reduction, for example, by eliminating capital and operating expenses that may be associated with a wired link to the network of the wireless communication system. As such, in an embodiment, the RN may communicate over the air to a “donor eNB” (DeNB) rather than using such a wired link. Additionally, the RN may communicate directly with user equipment (UE) or a wireless transmit/receive unit (WTRU) to provide access to the network. According to an example embodiment, the RN may appear or look like (e.g. may mimic) an eNB to a legacy or currently available UE or WTRU (e.g. a 3GPP Release 8 and/or 9 UE and WTRU) that may be used in the wireless communication system and network thereof.

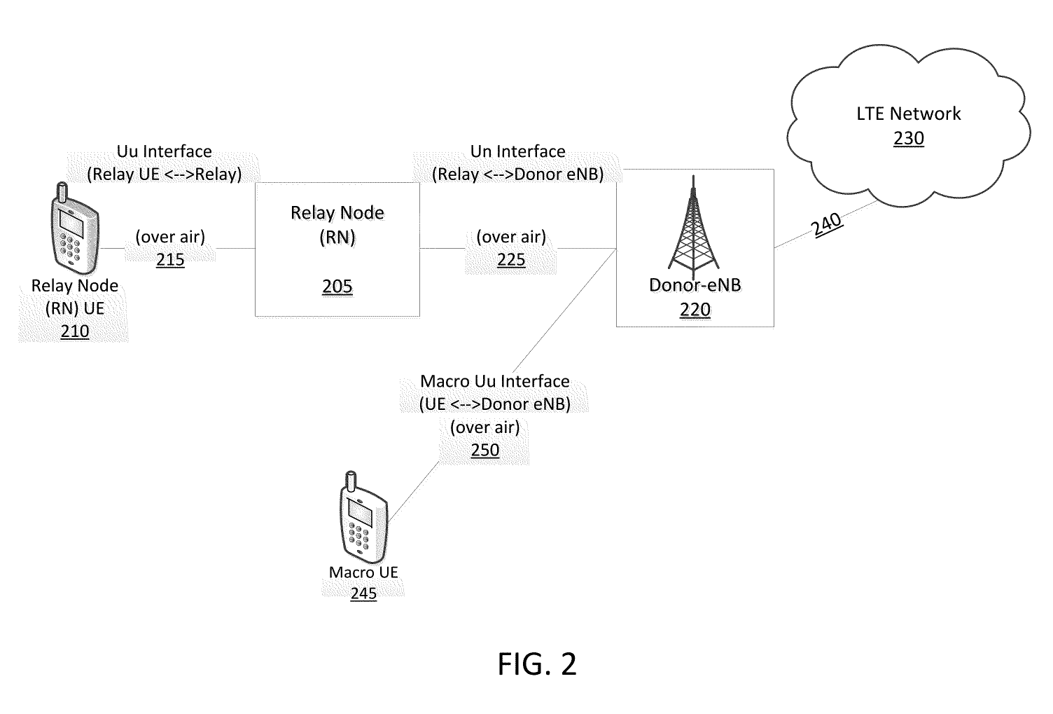

FIG. 2 illustrates an example embodiment of a relay node (RN) such as the RN 205 that may be used in a wireless communication system such as a LTE or LTE-A system (e.g. wireless communication system 100 shown in FIGS. 1A-1C). As shown in FIG. 2, the RN (e.g. the RN 205) may be in communication with a UE such as a relay node UE 210 via an over the air interface or link such as a first link 215. According to an example embodiment, the RN (e.g. the RN 205) may be a node compatible with a LTE system.

The RN (e.g. the RN 205) may further be in communication with a DeNB such as a DeNB 220 via another over the air interface or link such as a second link 225. According to an example embodiment, the over the air interface or links (e.g. the first link 215 and/or the second link 225) may be Uu and/or Un interfaces. In example embodiments, the Uu interface and/or RN Uu interface may be the interface between the RN (e.g. the RN 205) and a particular UE (e.g. the UE 210) that the RN may be serving. Including, for example, an RN access link. An Un Interface generally refers to an interface between the RN and its donor eNB (DeNB) (e.g., the backhaul interface or backhaul link).

As shown in FIG. 2, the DeNB (e.g. the DeNB 220) may further be in communication with a network such as a network 230 and/or one or more UEs such as a macro UE 235. In an example embodiment, the DeNB (e.g. the DeNB 220) may be in communication with the network (e.g. 230) via a wired interface or link (e.g. S1 interface) such as an interface 240. The DeNB (e.g. the DeNB 220) may also be in communication with one or more additional or macro UEs (e.g. 245) via an over the air interface or link such as a third link 250 that may be a macro Uu and/or Un interface.

Referring to FIG. 2, the RN (e.g. the RN 205) may be various different types or RNs. For example, the RN may be a Type 1 RN that may use the same carrier frequencies on the Uu and Un interfaces and that may be unable to transmit on one interface and receive on the other at the same time due to self-interference (e.g. its transmission on one link may interfere with its reception on the other); a Type 1a RN that may use different carrier frequencies on the Uu and the Un such that no subframe partitioning may be used; a Type 1b RN that may use the same carrier frequencies on the Uu and Un interfaces and may have adequate antenna isolation such that there may be self-interference may be reduced or eliminated and subframe partitioning may not be used; and the like. In example embodiments, for the type 1 RN, subframes may be partitioned between the two links to avoid self-interference and a Un subframe configuration is provided to the RN to identify the subframes for backhaul communication.

Additionally, RN subframes for a Type 1 RN and/or a Type 1 relay operation or method may be provided and/or used as described herein. For example, the RN (e.g. the RN 205) may be a Type 1 RN that may be configured to operate on the same carrier for both the Un and the Uu interfaces and may be provided with a Un subframe configuration (e.g. a RN subframe configuration) by the DeNB (e.g. the DeNB 220). The RN subframe configuration may identify the subframes that may be used between the RN and DeNB for Un communication (e.g. backhaul communication). During Un subframes, the RN may receive a transmission from the DeNB over the Un interface, and during non-Un subframes, the RN may schedule transmissions to its UEs over its Uu interface. According to an example embodiment, the Un subframe pattern may be configured for a 40 subframe period, and subframes {0, 4, 5, 9} may not be configured as Un subframes.

The subframes that may be used for Un may be configured by the RN as MBSFN subframes on the Uu interface of the RN such that the RN UEs may ignore the content of those subframes except for the unicast control signals that may be transmitted in the first 1 or 2 OFDM symbols. In such subframes, the RN may transmit the unicast control signals to the UEs, may then switch from transmission (Tx) mode to reception (Rx) mode, and/or may listen to the DeNB on the Un interface.

The unicast control signals may be used for HARQ acknowledgement (e.g. PHICH may be used to acknowledge uplink transmissions). MBSFN subframes may also be supported and/or used such that older or prior UEs (e.g. Rel-8 UEs) may take advantage of the RNs (e.g. RN access may be backward compatible to older or prior UEs such as Rel-8 UEs). In embodiments, using MBSFN subframes may cause losses of throughput efficiency, because there may be OFDM symbols (e.g. 3 OFDM symbols) that may be wasted at the beginning of each subframe (e.g., a maximum of 2 symbols for unicast control region and 1 for the switching time between RN Tx and RN Rx).

A RN startup and/or configuration may also be provided, performed and/or used as described herein. For example, a startup method or procedure may be performed, initiated, or invoked by a RN (e.g. the RN 205). Upon startup, the RN may first connect to the network following a UE attach procedures, and may retrieve configuration information including a donor eNB (DeNB) list from the RN Operation, Administration, and Maintenance (RN OAM). The DeNB list may include information used for the RN to find and to connect to an appropriate RN supporting the DeNB. The RN startup may have the RN attach to the network via the DeNB selected from the DeNB list. Once connection establishment and authentication may be completed, the RN may be provided with its configuration information to start operation of the RN cell. The configuration may include information such as a Uu carrier frequency, cell related information, and/or Un subframe configurations. Once the X2 and S1-AP connections may be established to the DeNB, the RN cell may be ready to service one or more UEs.

Additionally, in embodiments, a handover such as an intra E-UTRAN handover (e.g. that may be provided in Rel-10) may be performed, used, modified, and/or initiated as described herein. For example, mobility of connected mode UEs within a LTE network may be supported by network-controlled UE-assisted handovers. The decision to handover a UE from one cell to another within the E-UTRAN may be made by the source eNB that may be servicing the UE. The decision may be based on measurement reports provided by the UE as well as other network aspects including, for example, the traffic load. Once the source eNB may decide or determine to move the UE to another cell on a target eNB, it may initiate the handover procedure. In embodiments, the resources that may be used to support moving the UE at or to the target eNB may be prepared prior to notifying the UE of the handover.

From a control plane perspective, the eNB may initiate the handover procedure on either the X2-AP interface or the S1-AP interface. To perform the handover via the X2 handover, one or more of the following criteria may be met by the source eNB: there may be an X2 connection between the source and target eNB, there may be no change of an EPC node (MME) due to the moving of the UE, the source eNB may not receive negative reply from the target eNB for an attempted X2 handover, and the like. In additional example embodiments, the handover procedure may be initiated via the S1-AP interface towards the MME when the criteria above may not be met.

Additionally, from a user plane perspective, to minimize data loss while the UE may move from the source to target cells, the source eNB may establish an X2 or S1 tunnel to forward incoming data that may not have been delivered to the UE to the target eNB. This may continue until the UE may synchronize with the target eNB on the target cell and the data path to and/or from the serving GW may be switched.

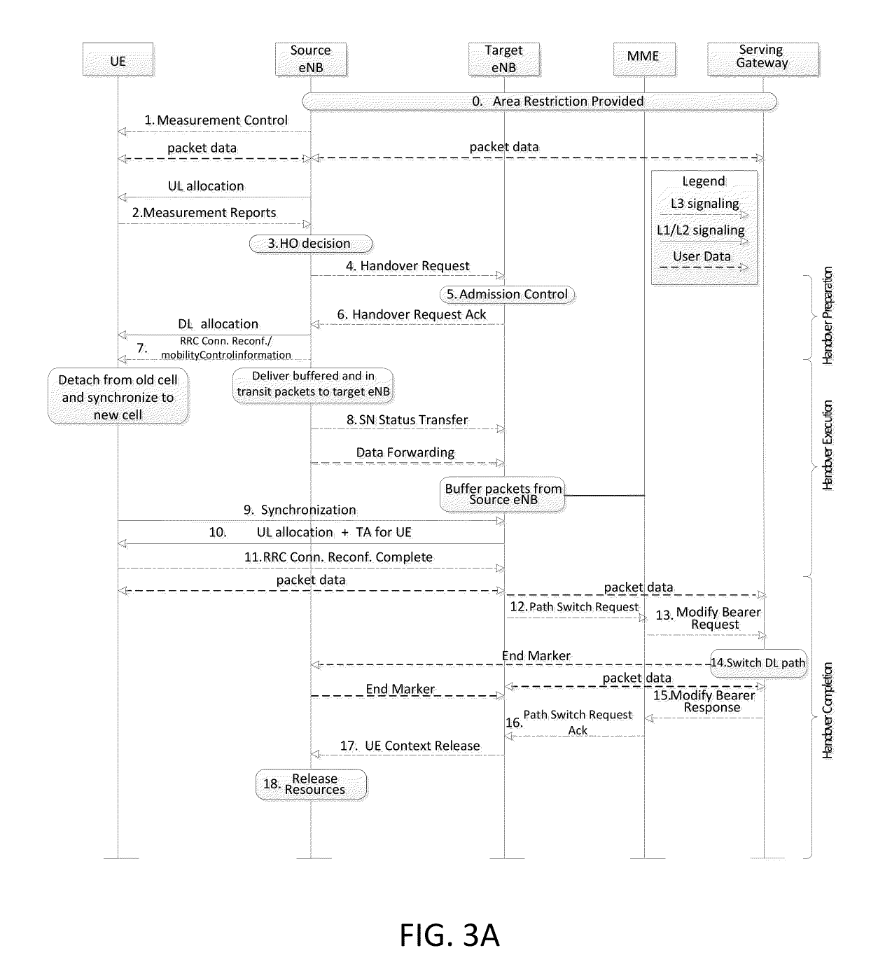

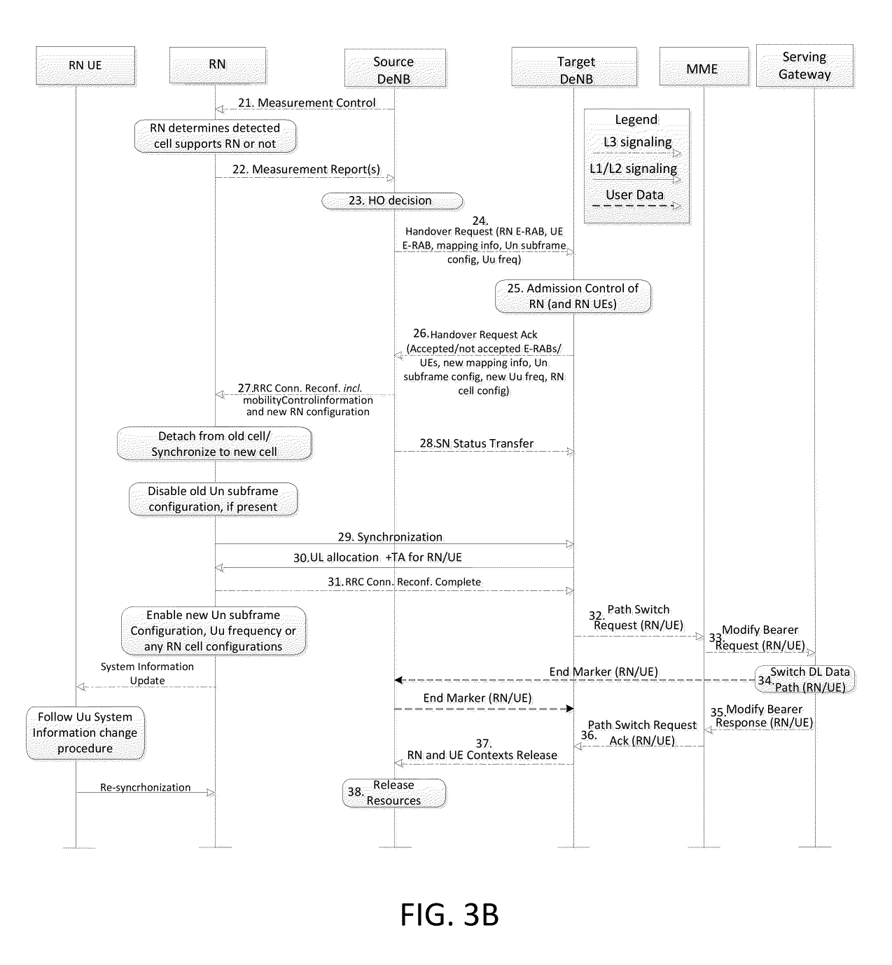

According to example embodiments, a RN handover procedure, method and/or operation may be provided, performed, and/or used as described herein for communication systems with one or more RNs. FIGS. 3A and 3B depict example embodiments of RN handover operations, procedures, and/or methods. As shown in FIG. 3A, an X2 handover sequence that may not involve a MME or S-GW change may include, for example: (1) a handover decision procedure; (2) a handover preparation procedure; (3) a handover execution procedure and/or (4) a handover completion procedure.

For example, at 0 in FIG. 3A, an area restriction may be detected, determined, and/or provided. After detecting, determining, and/or providing an area restriction, a handover decision may be performed and/or initiated (e.g. at 1-3 in FIG. 3A). In the handover decision, a source eNB, based on measurement reports from the UE, load conditions and/or other criteria, may determine or decide whether to hand a UE over to target eNB.

In an embodiment, when determining or deciding to perform a handover (e.g. at 1-3 in FIG. 3A), a handover preparation may be performed and/or initiated (e.g. at 4-7 in FIG. 3A). For example, the source eNB and the target eNB may prepare the handover of the UE by transferring information between each other. The source eNB may provide UE specific information to the target eNB, including information regarding the UE's active EUTRAN Radio Access Bearers (E-RABs) (e.g. that may be included in or associated with a handover request at 4). The target eNB then may perform admission control for the UE (e.g. at 5), and may provide the source eNB with information that may be used for the UE to be able to synchronize to the new cell and resume E-RAB services (e.g. that may be included in or associated with a handover request acknowledgement at 6). Additionally, the source eNB may provide a downlink (DL) allocation and/or may provide a command or signal such as a RRC Conn Reconfig and/or as mobility control information (e.g. mobilityControlinformation) to the UE (e.g. at 7).

A handover execution may then be performed and/or initiated (e.g. at 8-11 in FIG. 3A). For example, the UE may attempt to synchronize with the target cell by using RACH, and may complete the RRC reconfiguration procedure. Additionally, the source eNB may provide a status transfer such as an SN status transfer (e.g. at 8) and data forwarding to, for example, the target eNB. The UE may perform synchronization with the target eNB (e.g. at 9) and the target eNB may provide uplink (UL) allocation and/or TA (e.g. timing advance) to the UE (e.g. at 10). The UE may then provide a command or signal such as a RRC Conn Reconfig complete to the target eNB (e.g. at 11).

A handover completion may then be performed and/or initiated (e.g. at 12-18). For example, the source and target eNB, along with a EPC may switch the data path from the source eNB to the target eNB and the source eNB may release the resources that may be allocated for the UE. To switch the data path and/or release resources, a path switch request may be provided from the target eNB to a MME (e.g. at 12), a modify bearer request may be provided from the MME to a serving gateway (e.g. at 13), the DL path may be switched by the serving gateway (e.g. at 14), a modify bearer response may be provided from the serving gateway to the MME (e.g. at 15), a path switch request acknowledgement may be provided from the MME to the target eNB 9 e.g. at 16), a UE context release may be provided from the target eNB to the source eNB (e.g. at 17), and/or resources may be released (e.g. at 18).

As shown in FIG. 3B, an RN handover procedure and/or method may also be performed as described herein. For example, a handover decision may be performed and/or initiated (e.g. at 21-23 in FIG. 3B). In the handover decision, the source eNB, based on measurement reports from the RN, load conditions and/or other criteria, may determine or decide whether to hand the RN over to a target eNB.

In an embodiment, when determining or deciding to perform a handover (e.g. at 21-23 in FIG. 3B), a handover preparation may be performed and/or initiated (e.g. at 24-27 in FIG. 3B). For example, a RN and a source eNB may prepare the handover of the RN by transferring information between each other. The source eNB may provide RN specific information to the target eNB, including information regarding the RN's and/or UE's active EUTRAN Radio Access Bearers (RN E-RABs), and/or RN UE's E-RAB, mapping information, a subframe configuration such as Un subframe config., frequency such as Uu frequency, and the like (e.g. that may be included in or associated with a handover request at 24). The target eNB then may perform admission control for the RN and the RN UE (e.g. at 25) and may provide the source eNB with information including accepted and/or not accepted E-RABs and/or UEs (e.g. lists thereof), new mapping information, a subframe configuration such as Un subframe config., new frequency information such as a new Uu frequency, a RN cell configuration, and the like that may be used for the UE to be able to synchronize to the new cell and resume E-RAB services (e.g. that may be included in or associated with a handover request acknowledgement at 26). Additionally, the source eNB may provide a command or signal such as a RRC Conn Reconfig with mobility control information (e.g. an IE (information element)) to the RN (e.g. at 27).

A handover execution may then be performed and/or initiated (e.g. at 28-31 in FIG. 3B). For example, the RN may attempt to synchronize with the target cell (e.g. by using RACH) and may complete the RRC reconfiguration procedure. Additionally, the source eNB may provide a status transfer such as an SN status transfer (e.g. at 28) to, for example, the target eNB. The RN may perform synchronization with the target eNB (e.g. at 29) and the target eNB may provide uplink (UL) allocation and/or TA (e.g. timing advance) to the RN (e.g. at 30). The RN may then provide a command or signal such as a RRC Conn Reconfig complete to the target eNB (e.g. at 31).

A handover completion may then be performed and/or initiated (e.g. at 32-38). For example, the source and target eNB, along with a EPC may switch the data path from the source eNB to the target eNB and the source eNB may release the resources that may be allocated for the RN UE and/or RN. In an embodiment, to switch the data path and/or release resources, a path switch request for the RN UE and/or RN may be provided from the target eNB to a MME (e.g. at 32), a modify bearer request may be provided from the MME to a serving gateway (e.g. at 33), the DL path for the RN UE and/or RN may be switched by the serving gateway (e.g. at 34), a modify bearer response may be provided from the serving gateway to the MME (e.g. at 35), a path switch request acknowledgement for the RN UE and/or RN may be provided from the MME to the target eNB (e.g. at 36), a RN and UE context release may be provided from the target eNB to the source eNB (e.g. at 37), and/or resources may be released (e.g. at 38).

Additionally, as shown in FIG. 3B, system information between the RN and RN UE may be updated, a system information procedure or method may be performed and/or re-synchronization between the RN UE and RN may be performed.

In embodiments, the handover (e.g. S1 handover) shown in FIGS. 3A and 3B may involve the MME in between the source and target eNB during the handover preparation procedure. The interaction between the source eNB and the UE and/or RN, and subsequently the target eNB and UE and/or RN may remain the same in S1 handover procedure, as in the X2 handover procedure. Additionally, although FIGS. 3A and 3B illustrate example handover procedures, other variations of such procedures and methods may be possible based on embodiments described herein.

In embodiments, the UE and/or RN may send measurement reports (e.g. as shown in FIGS. 3A and 3B at 2 and 22 respectively according to the configuration received by an eNB (e.g. a source and/or target eNB). The eNB may configure intra-frequency measurement objects, inter-frequency measurement objects and/or inter-RAT measurement objects. The UE and/or RN may be configured with measurements gaps for inter-frequency measurements, during which gaps the UE and/or RN may not monitor any downlink signals and/or may not perform any uplink transmissions. In the IDLE mode, the UE and/or RN may receive measurement configurations used for cell re-selection procedure via broadcast information. In the connected mode, the UE and/or RN may receive measurement configurations via dedicated RRC signaling. The configuration of measurements may be partitioned by one or more of following parameters: measurement object where an object may be for a single E-UTRAN carrier frequency, either intra- or inter-frequency, and/or the object may include a list of cells to measure and/or a black list of cells (e.g. that may include cells that may be excluded from measurements); a reporting configuration where a configuration may include reporting criterion (e.g. periodic or single event) and/or a reporting format; measurement identities including, for example, a list of measurement identities that may link a measurement object with a reporting configuration; a quantity configuration that may define the measurement quantities and/or filtering that may be used for event (e.g. an all event) evaluation and reporting where, in embodiments, the quantity configuration may be defined for each radio access technology (RAT); a measurement gap such as a configuration for measurement gaps that UEs and/or RNs may use to perform measurements; and the like.

Additionally, in embodiments, high speed train networks may be provided and/or used. For example, according to an embodiment, a rising prevalence of such high speed train networks may increase the use UEs and/or RNs on board high speed trains with velocities reaching, for example, upward of 500 km/h. In example embodiments, the high speed train may provide one or more of the following the following set of issues that may lead to a higher rate of failure of mobility procedures (e.g. a handover in connected mode) that may affect the user experience): a high signaling overhead due to high frequency of mobility procedures; a bursty nature of signaling due to mobility of a large number of UEs at the same time; a lack of time for adequate measurements used as a trigger for mobility procedures; and the like.

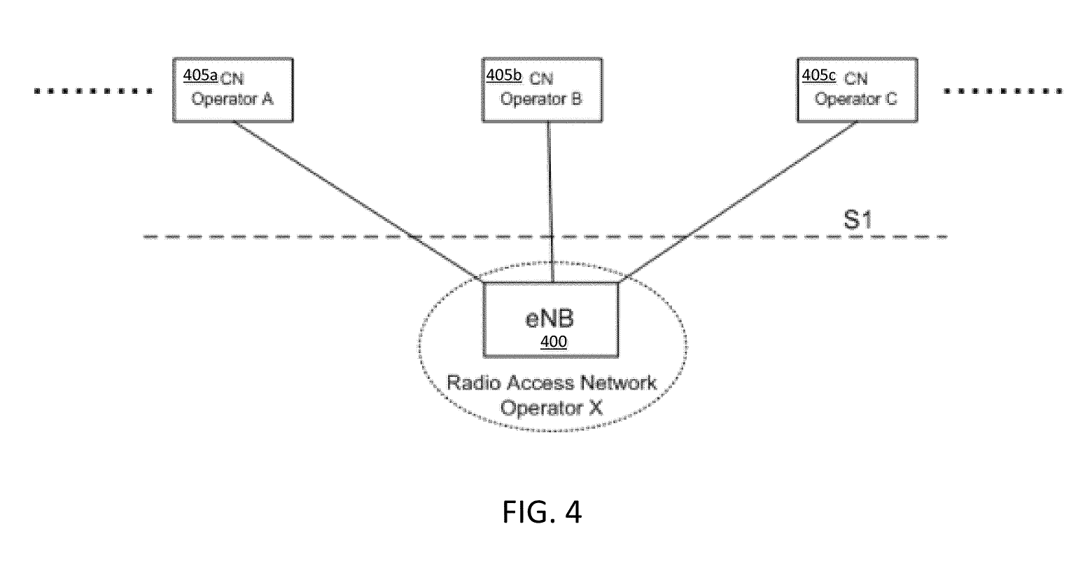

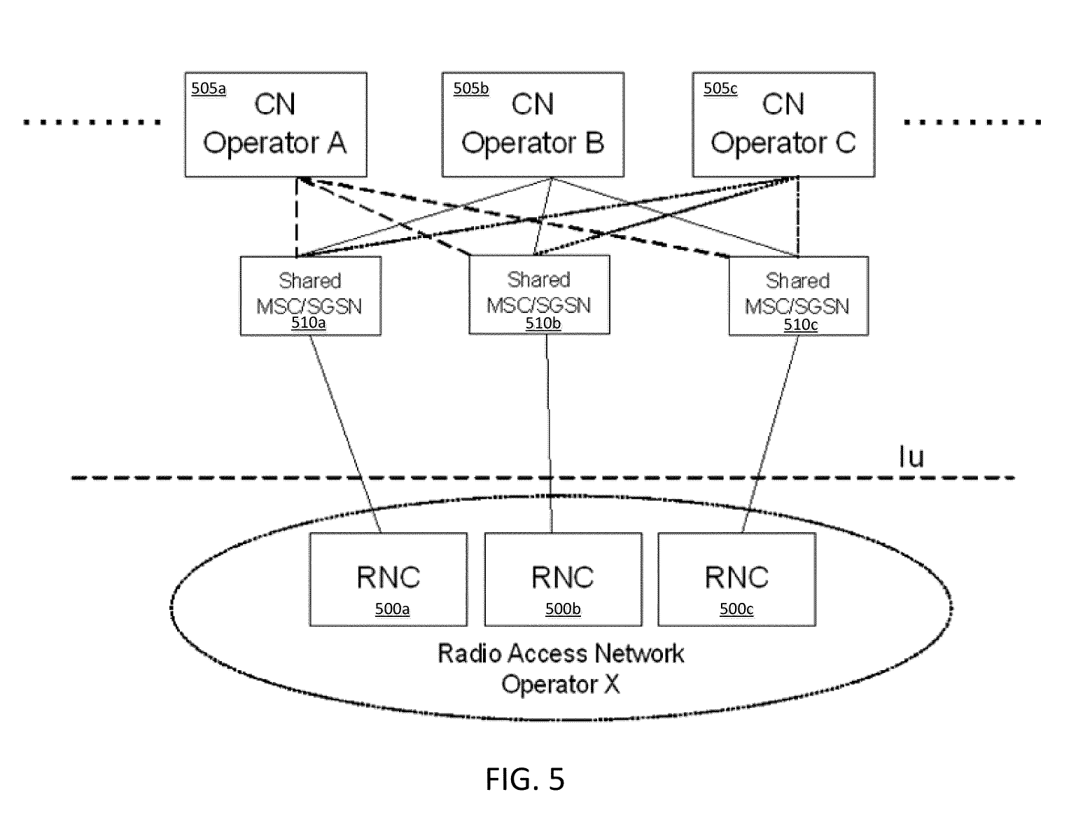

As described herein, in embodiments, radio access network (RAN) sharing for eNBs may be provided and/or used. FIGS. 4-5 illustrate example embodiments of network and/or radio resources that may be shared. For example, as shown in FIGS. 4-5, an eNB such as eNB 400 and/or RNCs such as RNC 505a-c and the radio resources associated therewith may be shared by multiple operators such as operators 405a-c and 505 a-c (e.g. RAN sharing). According to one embodiment, as shown in FIG. 4, RAN sharing may include a Multi-Operator Core Network (MOCN) (e.g. 405a-c) where the eNB (e.g. the eNB 400) may be shared and the core network (e.g. that may be provided by 405a-c) may not be shared. In another embodiment, as shown in FIG. 5, RAN sharing may include a Gateway Core Network (GWCN) where both the core network (e.g. shared MSC/SGSN 510a-c) that may be provided an operator) and the E-UTRAN (e.g. RNC 500a-c) may be shared by multiple operators (e.g. the operators 505a-c).

RAN sharing (e.g. as shown in FIGS. 4 and 5) may be reflected in the eNB through broadcast information that may include a list of supported PLMNs indicating operators that may be sharing the eNB. The UE and/or RN may not be aware of RAN sharing arrangements of the eNB, and may use the list of PLMN IDs as part of its PLMN selection process when attaching to the network.

Additionally (e.g. due to physically constraining nature of a train carriage), a RAN sharing of mobile relays (MRN) or RNs may be supported such that a MRN and/or RN may support multiple operators for on board LTE service. In embodiments, one or more of the following RAN sharing models may be provided and/or used: both a MRN or RN and a DeNB may be shared (e.g. model 1); a MRN or RN may be shared and a DeNB may not be shared (e.g. model 2); a MRN or RN may not be shared and a DeNB may be shared (e.g. model 3); and the like.

In model 1 (e.g. where both a MRN or RN and a DeNB may be shared, a MRN or RN may provide connectivity to MMEs via a DeNB. In model 2 (e.g. where a MRN or RN may be shared and a DeNB may not be shared), multiple Un connections (e.g. either physically or logically) may be supported and/or used (e.g. which may increase compiclations). Additionally, in model 3 (e.g. where a MRN or RN may not be shared and a DeNB may be shared), a MRN may not in handle RAN sharing (e.g. from a MRN perspective it may be transparent) and the DeNB may already support RAN sharing.

According to an example embodiment, a RN (e.g. Rel-10 or R-10 RN, a Rel-11 or R-11 RN, and the like) may not support inter-DeNB handover. RRC UE procedures (e.g. Rel-10 or R-10) may also be applicable to the RN and may not be provided such that RRC mobility-related procedures may not be excluded.

Additionally, in certain example embodiments, the RN may provide and/or use (e.g., support or manage) one or more mobility procedures as described herein. For example, the RN may perform a handover from a source DeNB to a target DeNB.

According to example embodiments, RN mobility for a RN or MRN may include one or more of the procedures and/or methods described herein. For example, in one embodiment, RN mobility may include a Un connection control with mobility where the RN may perform and/or provide mobility-related measurements, control of mobility procedures, Un handover procedures, and/or recovery from a radio link failure of the Un interface. Additionally, RN mobility may include Uu impacts of Un mobility where the RN may handle or manage the UEs connected over the Uu interface to the RN during a mobility-related event (e.g., during a measurement period such as a measurement gap and/or while the RN may perform a handover procedure for the Un) and/or X2/S1 impacts of Un mobility where DeNBs may exchange information over the X2 interface and/or may handle or manage the RN and UE contexts as well as data path for the RN and the UEs under the RN. RN mobility may also include RAN sharing for Mobile Relay Nodes (MRNs) or RNs and/or Donor eNBs (DeNBs).

In embodiments, RAN sharing for MRNs or RN and/or DeNBs may include, for example, a RN configuration for RAN sharing (e.g. RNs being configured by a RN OAM and/or DenB and a determination that RN properly performed RN start up and attachment procedures or methods); RN attachment for RAN sharing (e.g. RN UE-like attachment and authentication procedures that may be performed prior to operation of the RN cell and may employ multiple operators and multiple MME/HSS entities); RN P-GW selection for RAN sharing including selection of a different RN P-GW per operator, for example, if EPC entities such as RN P-GW, UE P-GWs, and the like of different operations may not be interconnected and a RN P-GW may be selected from a EPC rather than a DeNB co-located P-GW; and/or RAN sharing and MRN mobility (e.g. as a RN or MRN may move through a network associated with a DeNB, the RAN sharing configuration associated with the RN or MRN may change, for example, due to the availability of PLMNs and operators (e.g. across country or geographic borders) such that an RN may reconfigure the RAN sharing configuration associated with the RN or MRN while minimizing disruptions to the UEs being served by the RN and RN cell). According to an example embodiment, the embodiments disclosed herein for RAN sharing may be used with Rel-10 RNs and other type or RNs or MRNs. Additionally, in example embodiments, operators may use already-deployed eNBs (e.g. that may not be configured for RAN sharing) to support RNs as DeNBs and may extend RAN sharing configurations described herein (e.g. using with model 2 where a MRN or RN may be shared and a DeNB may not be shared as described herein). The RN may also support two separate connections to two separate DeNBs from different operators in order for the RN to support UE service to such operators.

As described herein, systems and/or methods for providing Un mobility and/or connection control for a RN may be provided. In such systems and/or methods, system access including a determination or whether or not a cell may be accessible for a RN operation may be provided and/or used; an IDLE mode for Un including performance by a RN of idle mode procedures or methods for the Un interface may be provided and/or used; mobility-related measurements including an application of the measurement configuration may be provided and/or used; mobility and connection control over Un and/or control of the Un connection including an initiation of a mobility-related procedure or method may be provided and/or used; a handover procedure or method over Un including performance of a handover procedure or method for the Un interface may be provided and/or used; and/or Radio Link Failure (RLF) handling on Un including managing and/or handling of a radio link failure (RLF) on the Un interface and/or connection re-establishment may be provided and/or used.

To provide system access in Un mobility and/or connection control for RNs, RN access information may be used. For example, the RN may be configured by an OAM entity with a list of DeNB or DeNB list (e.g. in an LTE system such as LTE Rel-10). The RN may use the DeNB list to determine the cell or cells that may support RN operation. The DeNB list information may be exchanged (e.g. directly exchanged) between the concerned RN and the OAM entity.

When mobile RNs may be used, such information (e.g. the DeNB list and/or additional information) may vary as a function of relay mobility. For example, a serving DeNB may have additional techniques or procedures (e.g. in additional to the list of DeNBs or DeNB list information and/or additional information) to determine whether or not a neighbor eNB may support a RN operation, and, if a neighbor eNBs may support the RN operation, which cell or cells may be used for the RN operation. The serving DeNB may use the information to configure measurements for a RN and/or to initiate a mobility procedure or method for the particular RN.

Additionally, the RN may have additional techniques or procedures to determine whether or not a neighbor cell may support RN operation. The RN may use such information (e.g. the list of DeNBs or DeNB list information and/or additional information) to determine the procedures for application of its measurement configuration and/or the procedures for performance of measurements.

For example, the serving DeNB and/or RN may use RN access information including RN-capable cell (s) and/or RN-accessible cell(s). In embodiments, an RN-capable cell may be a cell that may support RN operation and may include a cell that supports redirection to another cell that is RN-capable. An RN-accessible cell may be a cell on which a RN may camp (e.g. if IDLE mode may be supported for a RN) and/or may perform initial access and may include a cell that may support redirection to another cell that may be RN-capable. Accessibility of a cell may be further refined on a service level, for example, for LTE Rel-8 a cell may support three different service levels: limited service (e.g., emergency calls and ETWS), normal service (e.g., public use) and operator service (e.g., reserved cell). In such RN access information, accessibility of a cell may be further refined on a RN type level, for example, in case different RN types may be specified such that a DeNB may not support the same RN type.

In example embodiments, the RN and/or DeNB may determine accessibility information of the RN based RNAI or RN Access Information. The RN access information may include a DeNB list, a cell list, and/or a parameter list.

According an example embodiment, the “DeNB list” may include one or more of the following: at least one DeNBs with at least one RN-capable cell; at least one DeNB with at least one RN-accessible cell; and/or for each DeNB, a list of one or more cells, e.g., a “cell list” as described herein; one or more additional parameters or a “parameter list” as described herein; and/or an eNB-ID of the DeNB. Additionally, the “cell list” may include one or more cells based on at least one of the following: a cell that may be RN-capable; a cell that may be RN-accessible; a cell that supports redirection to another cell that is RN-capable; an indication of whether or not the RN may autonomously perform an initial access to the cell; RN-specific paging information including, for example, RN-RNTI and/or specific paging occasions; and/or cell selection information where the cell selection information may include at least one of the following: whether or not the cell is part of the list of detected cell maintained by the RN, e.g., for keeping stored information for cell selection; information on cell parameters, e.g., cell frequency information, physical cell ID, and/or global cell ID; cell selection criterion including, e.g., a minimum reception level in the cell Qrxlevmin, a related signaled offset Qrxlevminoffset, a minimum quality level in the cell Qqualmin, and/or a related signaled offset Qqualminoffset; and the like; and/or for each cell, one or more additional parameters or a “parameter list” as described herein. The “parameter list” may include one or more parameters according to at least one of the following: a RN subframe configuration, if applicable; an indication of the type(s) of relay that may be supported; an indication of whether or not RN mobility may be supported; supported service level(s); a measurement threshold to apply, for example, for mobility and/or cell selection or reselection; and/or a priority indication including, for example, cell selection and/or re-selection priority information (e.g. that may be used in idle mode for cell selection or in connected mode for RRC re-establishment procedure); cell priority information (e.g. that may be used for RN-autonomous handover procedure (e.g., forward handover); and the like.

The RN access information may also include validity criteria or criterion as described herein and/or an indication of whether or not the RN may update the RNAI including, for example, whether or not the RN may autonomously modify the RNAI using various methods described herein or by other methods or procedures such as with assistance from a DeNB where the RN may determine whether to update and/or not update the RNAI during a specific time such as while the RNAI meets a validity criterion and/or according to certain precedence rules such as a valid RNAI received from OAM may not be updated or the RNAI autonomously derived may be updated by the dedicated RRC configuration.

In example embodiments, the RN access information may further include an operating frequency that may be used for Un as described herein and/or contents of the Master Information Block (MIB) that may be transmitted by the cell allowing the RN to read the cell system information without having to read the MIB beforehand.

The RNAI may be configured or structured as a list of zero or more elements corresponding to at least a portion of the information such as the RN access information described herein. For example, the DeNB list (e.g. the LTE Rel-10 DeNB list) may be equivalent to or substantially similar to the RNAI that includes a list of DeNB that support RN operation on at least one cell. Additionally, certain information (e.g. aspects of RNAI) may be part of the neighbor relationship information compiled by the DeNB and the RN. For example, as part of neighbor cell information, the RN and/or the DeNBs may indicate whether the neighbor cell may be RN-accessible and/or RN-capable. Such information may also indicate whether a handover of the RNs may be allowed (e.g., the “No RN HO” indicator may be separate from the “No HO” indicator for UE handovers).

In embodiments, a particular instance of the RNAI may represent at least one of the following: information pertaining to a single PLMN network; information pertaining to a single tracking area; and/or a sequence of one or more elements organized such that it may represent a mobility path including, for example, when the RN may be deployed it may follow a deterministic geographical movement (e.g., following a known itinerary for a train or a bus).

In certain example embodiments, the RN/DeNB may determine a priority of accessibility information or RN access information from the RNAI. Each element in the priority list (e.g. conceptual list) may be assigned a priority and may be: (1) based on an explicit priority indication or the priority; (2) derived from the position of the element in the ordered list; and/or (3) derived from the type of the element in the list (e.g., the DeNB, the cell, in-band or out-band operation, and/or the RN subframe configuration, among others). The absence of an explicit priority indication may indicate a default priority (e.g., the lowest or the highest priority). In example embodiments, the RN and/or DeNB may determine validity of accessibility information for RNAI.

One or more elements of the conceptual list (e.g. or the entire list) may be associated with a validity criterion or validity criteria, indicating when (e.g. at least parts of) the RNAI may be determined to be valid and/or obsolete. Such criterion or criteria may be based on or include at least one of: a validity time, for example, when the determined (or particular) information may not have been updated for a period corresponding to the validity time, the information may no longer be considered valid); a Public Land Mobile Network (PLMN), for example, when the RN node may leave a PLMN, the particular information may no longer be considered valid; a Tracking Area (TA), for example, when the RN node may leave a Tracking Area, the particular information may no longer be considered valid; and the like

The particular node (e.g. a RN and/or serving DeNB) may determine that when one or more elements of the RNAI may be obsolete (or are about to become obsolete), a procedure to update at least the concerned information may be initiated. For example, a RN may maintain the RNAI for which a qualifier based on TA Identity (TAI) list may have been configured. If the RN may detect that it may have moved to a TA outside the TAI list, and/or if the RN may determine that one or more of its neighbor cells and/or DeNBs may be outside the TAI list, the RN may update the RNAI. The TAI list may identify the tracking areas that a UE (or a RN) may enter without performing a tracking area updating procedure. The TAIs in the TAI list assigned by an MME to a UE (or RN) may pertain to the same (e.g. a common) MME area.

The RN may obtain and/or update the RNAI using at least one of the following methods: network-initiated, for example, under network control (e.g., initiated by a DeNB or by the OAM entity) using, for example, certain example methods described herein; RN-initiated, for example, using a request-based procedure (e.g. by sending a request to a serving DeNB or to the OAM entity) using, for example, certain example methods described herein; and/or autonomously, for example, using, certain example methods described herein.

For example, in an embodiment, to obtain and/or update RN access information using the methods described herein, the RN may receive the RNAI from OAM. Alternatively, the RN may be pre-configured with the RNAI. For example, the RNAI may represent a pre-configured set of RN-accessible cells, where each cell may correspond to a deterministic mobility path (e.g. cells along the path of a train). The RNAI may be received with an indication that the RN may not autonomously update the RNAI for a certain time period. The time period may correspond to a validity criterion or validity criteria that may be indicated by OAM. As described herein the validity criterion or criteria may be a validity period, a PLMN, and/or a TAI, and the like. When the RN may move out of the PLMN and/or TAI, the RNAI may no longer be valid.

In example embodiments, the RN may provide the RNAI to a DeNB (e.g., the DeNB may obtain and/or update the RNAI from the RN). The DeNB may be a serving DeNB of the concerned RN. For example, the RN may transmit the RNAI to the DeNB as part of one or more of the following procedures: the initial RRC connection establishment over the Un interface; a RN (re)configuration procedure over the Un interface; a measurement report over the Un interface; a procedure that may establish an X2 interface between the DeNB and the RN; a procedure that may request the RNAI over either the Un interface or over the X2 interface; and/or a RRC reconfiguration procedure involving mobility of the RN.

For example, the RN may be provided with the RNAI (e.g. such as a DeNB list) from the OAM entity as part of the RN's initial start-up procedure. The RN may have a list of RN-accessible cells, some of which may also be neighbors of the particular or concerned DeNB. The RN may provide the RNAI to its serving DeNB (e.g., during the RN attach procedure). For example, the RN may send the DeNB list information to the DeNB as part of RRC connection setup complete message, along with an “I am RN” indication and/or Un subframe indication. As an alternative, the RN may send an X2-eNB configuration update message to notify the DeNB of neighbor cells that may support RN (e.g. these cells may be derived from the DeNB list).

For example, a serving DeNB may use the RNAI to determine the measurement configuration for the RN such that frequencies and/or cells that may be RN-capable and/or RN-accessible and/or that may support redirection to another cell that may be RN-capable and/or RN-accessible may be included.

In embodiments, a first DeNB may provide RN access information or RNAI to a second DeNB. For example, a DeNB may obtain and/or update the RNAI from another DeNB. According to one embodiment, the DeNBs may be neighbor DeNBs. For example, the RNAI may be exchanged as part of one or more of the following procedures or methods: a neighbor information exchange procedure between neighbor DeNBs (e.g. over a X2 interface); a procedure or method that may establish an X2 interface between the DeNB and the RN; a procedure or method (including but not limited to over the X2 interface) that may enable or allow such an exchange of information; and the like.

For example, neighboring eNBs may provide a DeNB that may be serving a RN with information on whether or not their respective cell or cells may support RN access, as part of the neighbor information exchange. As part of a procedure that may exchange information between neighboring eNBs, the DeNBs with one or more RN accessible cells may provide additional information via the X2 interface in an eNB Configuration Update message, for example, as part of the Served Cell Information element. The DeNB may indicate to its neighbor or neighbors at least which cell or cells may support RN access. The DeNBs may construct neighbor eNB information and may know which neighbor eNBs and/or which cells may support RN operation. The DeNBs may include RN subframe configuration for the concerned cells. This may be translated into the RNAI.

According to another example embodiment, an eNB may provide another eNB information regarding whether or not it may be currently serving RNs; whether or not it may serve RNs; whether or not it may support handover of RNs, for example incoming mobile RNs; and/or one or more parameters that may be part of the RNAI for one or more of the RNs it may be currently serving or may serve such as Un subframe configuration and/or Un carrier frequency; and the like.

The eNB, to which the information may be provided, may be, for example, an eNB with which it may have an X2 interface, an eNB it may know to be the DeNB currently serving one or more RNs, and/or an eNB it may know to be capable of being a DeNB, among others.

The eNB providing the information may do so without receiving a request from the other eNB, for example, based on an event such as a change of Un subframe configuration, based on a request from the other eNB, and/or as part of another procedure such as an RN handover procedure.

Additionally, in embodiments, existing or new messaging and procedures may be used, such as an eNB Configuration Update message. The RNAI may be transferred between a source and target using the X2 or S1 handover signaling. For example, the source eNB may include the RNAI in X2 Handover Request, and in response, the target eNB may include the RNAI in an X2 Handover Request Acknowledge message.

According to example embodiments, a DeNB may provide RNAI to a RN and/or the RN may obtain the RNAI from the serving DeNB over the Un interface. For example, the RN may receive the RNAI by one or more of the following procedures or methods: during a procedure or method for system information acquisition, for example, the RN may read system broadcast information over the Un interface and may acquire RNAI, for example as part of a SystemInformationBroadcast element; during a procedure or method that may reconfigure the connection using dedicated signaling, for example, the RN may receive a RRCConnectionReconfiguration message including at least one of system broadcast information, a RN configuration, a measurement configuration, and/or a mobilityControlInformation IE (e.g., during a handover procedure) where at least one of the above messages may include the RNAI and/or method or procedures for the RN to derive at least part of the RNAI; during an initial attach procedure, for example, to the serving MME; during a procedure that reconfigures the X2 interface, e.g., the RN may receive a X2 eNB Configuration Update exchange from a DeNB; during a procedure or method to re-establish the connection, for example, a RRC re-establishment procedure or method with the serving DeNB; during a procedure or method that may release the connection, for example, the RN may receive a RRCConnectionRelease message that may include the RNAI and/or methods or procedures for the RN to derive at least part of the RNAI, for example, using the idleModeMobilityControlInfo; during RRCRNReconfiguration procedure or method in which the RN may receive updated system broadcast information from the DeNB; and the like.

As described above, the RN (and/or the DeNB) may autonomously determine or derive at least part of the RNAI using any of the example methods described herein. In example embodiments, the RN may determine or not a cell may be RN-Accessible and/or the RN may determine accessibility of a cell based on the System Information (SI).

For example, in an example method, the RN may acquire broadcasted system information (MIB/SIB) for a cell where the SIB may indicate that RN services that may be supported (e.g., as part of the cell's service levels). In embodiments, the RN may autonomously determine RN-Accessible cells based on a measurement configuration received from the DeNB, the SI on the serving cell, the SI on the neighbor cells, the physCellID/ECGI and/or based on the outcome of a cell selection or reselection procedures.

An RN may autonomously determine at least part of the RNAI (e.g. its own set of suitable RN supporting cells) without receiving the RNAI such as a DeNB list from OAM and/or from the serving DeNB. The RN may autonomously update and manage the initial received DeNB list by means or procedures of measurements, measurement configurations, cell selection or reselection procedure, and/or the reading of neighbor cell system information (which may be performed periodically, or based on a trigger/condition, among others).

The RN may determine whether or not a cell is RN-capable and/or RN-accessible, or any other criteria associated with the RNAI depending on the method used, based on, for example, at least one of the following. In one embodiment, the RN may receive a measurement configuration including a list of measurement objects. For example, a frequency indicated in the measurement object may correspond to a frequency with at least one cell that may be RN-capable and/or RN-accessible. The measurement configuration may include measurement object(s) that may correspond to a frequency with at least one cell that maybe RN-capable and/or RN-accessible. The RN may use the measurement configuration as an indication of which cells may be included in the RNAI.

Additionally, in another embodiment, the RN may receive and/or acquire SI for the concerned neighbor cell. For example, the RN may acquire and/or monitor SI on the neighbor cell to determine whether or not the cell may be RN-capable and/or RN-accessible. The list of neighbor cells may be received from SI in the serving cell or, alternatively, from dedicated signaling. The RN may monitor SI periodically for neighbor cells. The RN may receive SI for neighbor cells during a cell selection/reselection procedure.

According to another example embodiment, the RN may receive the physical cell identity and/or the E-UTRAN Cell Global Identifier (ECGI). For example, the RN may determine whether or not the cell may be RN-capable and/or RN-accessible if the concerned identity may be within (or alternatively outside) a pre-determined range of values.

Furthermore, in embodiments, the RN may make an initial connection establishment using UE procedures and indicating that it may support the RN operation and also mobility procedures, and may subsequently receive a configuration, accordingly, to indicate that the cell supports RN-operation and/or RN mobility.

According to an embodiment, the RN may perform any of the foregoing during a cell selection or reselection procedures. For example, the RN may determine which neighbor cell or cells are RN-capable and/or RN-accessible during the cell selection procedure and maintain this information as at least parts of its RNAI.

The RN may track RN-Accessible cells based on neighbor relationship information and/or the RNAI and/or the RN may use neighbor relationship information to find suitable RN supporting cells in conjunction with the RNAI (e.g., a DeNB list). The RN may use connected mode measurements discussed below to further track suitable cells and update the RNAI (e.g., a DeNB list, accordingly).

An RN may support and/or perform methods or procedures in IDLE mode as described herein. When the RN may be in IDLE mode, the RN may perform at least one of the following: cell selection or reselection, registration, paging reception, re-establishment failure, Uu operation in IDLE mode, and the like.

In cell selection or reselection, the RN may select a “suitable cell” as a function of the RNAI, if available, for initial cell selection and/or for cell re-selection. For example, the RN may use different priority for different type of cells. The RN may first perform the selection procedure in a first set of candidates that consists of one or more RN-accessible cells, if provided. The selection may be performed when the RN performs initial access to the system, for a redirection procedure, for a procedure to register to the system and/or to re-establish a connection to the system. If no suitable cell may be found in the first set of candidates, the RN may perform the selection procedure in a second set of candidates that includes of one or more RN-capable (e.g. but not RN-accessible) cells, if provided. The selection may be preformed when the RN may perform a procedure to register to the system and/or for a redirection procedure. If no suitable cell may be found in the first and second sets of candidates, the RN may perform the selection procedure using any suitable cell, for example, according to criteria such as LTE R10 criteria. The selection may be performed when the RN may perform a procedure to register to the system such as the LTE system. Such a method may also be applicable when the RN may perform cell reselection and/or if the RN may autonomously initiate a mobility procedure in connected mode (e.g., a forward handover).

As another example of use of the RNAI for suitable cell selection, the RN may select a suitable cell amongst available RN-accessible cells based on supported RN type (e.g. priority of inband operation over outband) or based on a known Un subframe configuration. The RN may consider a more suitable cell to be one that may have more available bandwidth, for example, based on the known Un subframe configuration in the RNAI for that candidate RN-accessible cell.

In registration, the RN may register and perform tracking area update to a given or particular cell, for example, to a certain type of cell in combination with the PLMN and/or Tracking Area (TA) of the concerned or particular cell. Whether or not the RN may register and may perform tracking area updates may be a function of the RNAI. The RN may perform tracking area update each time upon moving to a different cell such that the network may know the location of the RN at the cell level (e.g. granularity) rather than tracking area level (e.g. granularity).

In paging reception, the RN may monitor a paging occasion and/or a RNTI (e.g., a RN-RNTI) that may be cell-specific, PLMN-specific, system-specific, specific to RNs and/or on a RN-capable cell (e.g., a cell that may not be RN-accessible). The RN may initiate a registration procedure to the network, a traffic area update and/or a RRC connection establishment when it may receive a paging message. The paging information may be a function of the RNAI.

In re-establishment failure, when the RN may initiate the connection re-establishment procedure, the RN may transit to idle mode.

Additionally, when the RN may in IDLE mode, the RN may maintain Uu operation. The RN may redirect a UE that may initiate a RRC connection (e.g. including a registration request) to another cell of another eNB (e.g. the UEs may be redirected). For example, the RN may maintain Uu operation while in IDLE for the Un connection (e.g. when not serving any UEs) to enable or allow measurement operations by UEs in the same coverage area. The RN may start accepting connections once the RN may have an established RRC connection for the Un (e.g., once it is in connected mode) and may redirect a request to an eNB (e.g. the macro eNB).

In a first example of the above methods or procedures, the following principles may be applied, provided, and/or used. The RN may be responsible for performing registration and to update its tracking area, while the network may be responsible for initiating the Un RRC connection based on operator policy, time of day and/or RN location tracking (e.g. for a given or particular PLMN). For example, the RN may register or may be allowed to register to a given or particular cell (e.g. a cell of a given or particular PLMN), using UE procedures or methods such as LTE Rel-10 UE procedures, and the RN may not autonomously perform an initial access to the system to establish a RRC connection for Un operation. In an example embodiment, the MME, to which the RN may register, may perform location update based on information stored in the core network or the HSS. The network may page the RN to establish a RRC connection, to configure the Un interface and to setup a Uu interface. The RN may monitor the paging channel at its “UE-specific” occasion, and when it may receive paging, it may initiate the RRC connection establishment to the cell on which it may receive the paging message. Additionally, the RN may perform a cell selection procedure, for example, according to the above following the reception of a paging message. The RN may be redirected or handed over by the eNB to a different cell and/or DeNB. Once the RN may have an established RRC connection with a DeNB, the RN may receive a configuration for the Un (e.g. and/or for Uu) and may start operating the Uu interface.

In another example of the above methods, the following principles may be applied, provided, and/or used. The RN may monitor a paging occasion such as a cell-specific or PLMN-specific paging occasion and RN-RNTI and may respond to a paging message. The network may be responsible for initiating the Un RRC connection, for example, based on operator policy, time of day and/or RN location tracking (e.g. for a given or particular PLMN). The RN may not register to the network and may not perform tracking area updates and/or the network may not determine the location of the RN in a given tracking area. The RN may initiate a registration procedure to the network or, alternatively, the RN may initiate a RRC connection establishment to the cell on which it may receive the paging message. Additionally, in an embodiment, the RN may perform a cell selection procedure, for example, according to the above following the reception of a paging message. The RN may be redirected or handed over by the eNB to a different cell and/or DeNB. Once the RN may have an established RRC connection with a DeNB, the RN may receive a configuration for the Un (and/or for the Uu) and may start operating the Uu interface.

In example embodiments, cell selection or reselection may use RNAI and priority information For example, if a RN may have access to the RNAI and when the RN may perform cell selection or reselection, it may perform at least one of the following. If priority information (e.g. for the selection of a DeNB and/or RN-capable cell and/or RN-accessible cell) may be available, for example, in the RNAI, the RN may perform the cell selection or re-selection procedure similar to a Rel-10 procedure including prioritization of the concerned element in the selection procedure. Such a procedure may further be performed, in embodiments, if the RN determines that the element may correspond to a suitable cell for the corresponding cell selection or re-selection procedure and/or if the RN may determine that the element may also be part of the cell selection or re-selection priority information, for example, provided by the idleModeMobilityControlInfo, if available (e.g. from system information acquisition or dedicated signaling). For example, the RN may consider that the best cell may be a cell in the RNAI that may be a suitable cell and that may have a highest priority (e.g. a priority level) in the set of candidate cells where a candidate cell may be a cell that may be RN-capable and/or RN-accessible.

Additionally, in an embodiment, the RN may perform or otherwise perform the cell (re)selection procedure (e.g., similar to a Rel-10 procedure) using cells that may be RN-capable and/or RN-accessible as indicated by the RNAI. For example, the RN may consider in the selection procedure a cell for which the RN may determine that the cell may be RN-accessible for at least the desired service level, for example, as indicated by the RNAI. For example, the RN may consider that the best cell may be the cell in the RNAI that may be a suitable cell where a candidate cell may be a cell that may be RN-capable and/or RN-accessible.

In embodiments, if a RN may not have access to the RNAI, the RN may perform the cell (re)selection procedure, for example, similar to a current procedure such as a Rel-10 procedure. Additionally, the RN may select a suitable cell if it may determine that the cell may be RN-capable and/or RN-accessible, for example, according to the methods described herein including, but not limited to, cells for which the RN may determine that the cell may be considered RN-accessible for at least a desired service level (e.g. “normal services”, or explicit indication of support for RN services). For example, the RN may consider that the best cell may be a cell that may be a suitable cell where a candidate cell is a cell that may be RN-capable and/or RN-accessible. The RN may use the above priorities in addition to or in lieu of the priorities used for the (re)selection process or procedure.

According to an example embodiment, the RN may autonomously update a RN-capable and/or RN-accessible cell to avoid repeated cell selection attempts to non-RN supporting cells. The RN may update its RNAI for previously RN-supporting or RN-capable cells and DeNBs that may have failed in an attempt to attach to the cell based on the above-mentioned cell selection or re-selection procedure. Upon a failure to attach to RN-capable or RN-supporting cell, the RN may update the cell information of that cell to indicate that it may no longer be RN-capable or RN-accessible. The RN may update the cell information upon multiple failed attach attempts. Since the failure to attach to these cells may be temporary, the RN may invalidate these cells and regard them as non-RN-accessible or non-RN-capable cells for a pre-defined time period. Once that time period may expire, the RN may consider these cells to be RN-capable and/or RN-accessible once again. Alternatively, the RN may continue to regard these cells as invalid until the RN may be updated with the RNAI indicating that the cells may be again RN-accessible or RN-capable. The update of RNAI cell information may prevent the RN from repeatedly attempting to attach to a suitable cell that may no longer be RN-accessible or RN-capable.

A startup and attach to a DeNB may further be based on factors other than a strongest cell. For example, in an embodiment, a RN may not select the most suitable DeNB cell that may be available in the DeNB list to attach and perform the RN start up procedure. For example, the RN on a high speed train may be travelling along a pre-defined path and may seek to attach to the next most suitable DeNB cell, for example, the cell with the longest time of coverage, to attach, may configure its RN cell, and/or may begin RN operations. The RN may use one or more of the following RN access information or RNAI included information instead of or possibly along with the DeNB list (e.g. per Rel-10 RN startup process along with Rel-10 UE cell selection procedures): location factors; a limited neighbor list; release and/or redirection; and the like.

The location factors may include information of current RN location, speed and direction, for example, information based on pre-determined, train information, location based on measurements, GPS information, as well as DeNB cell locations included in the DeNB list and RNAI. The RN may prioritize the next available DeNB cell based on location (e.g. rather than cell quality and strength). If the RN startup procedure may fail, for example, the RN may fail to properly complete the RN attach procedure with DeNB cell rather than re-starting the suitable DeNB cell search, it may try to re-attempt the RN attach on the same DeNB cell unless another suitable cell based on location information may be available to the RN.

The limited neighbor list may include neighbor information associated with RNs and/or DeNBs and cells associated therewith. For example, a RN may be limited with a small number of neighbor DeNB cells or DeNBs in its neighbor relationship information which the RN may use as candidate cell for the next RN start up procedure.

The release and re-direction may include information associated with re-directed cells that may be used. For example, a RN may, as part of its detach from network operation, receive re-direction information that may include (e.g. rather than a prioritized carrier frequency) a single or list of few candidate cells to which the RN may perform an RN attach.

In an embodiment, a RN may be triggered to start the RN start up procedure by a trigger beyond a startup trigger (e.g. Rel-10 RN startup triggers) such as a RN power up, radio link failure recovery, and the like. For example, the RN may receive a page from DeNB or possibly a new DeNB list from OAM. The RN may continue to monitor for DeNB cells in the vicinity such that it may immediately initiate the RN start up procedure based on the new DeNB list and available and suitable RN supporting DeNB cell. While waiting for the trigger, the RN may remain in IDLE mode, with operations as described herein, or may be in detached wait state until a trigger to perform start up may be received.

Additionally, in embodiments, mobility-related measurements may be provided and/or used as described herein. For example, RN specific procedures to support RN mobility including measurement configurations and measurement opportunities for the RN may be provided and/or used. The RN may be configured (e.g. by a serving DeNB) to perform measurements on both intra-frequency and inter-frequency cells, along with measurement gaps for inter-frequency measurement opportunities (e.g. similar to the Rel-8 UE procedure or method).

Systems and/or methods to determine a measurement configuration may be provided and/or used For example, the RN may perform measurements based on a neighbor frequency and cell list and/or on a measurement configuration. The neighbor frequency and cell list and/or the measurement configuration may be determined autonomously by the RN or may be configured by a serving DeNB. In example embodiments, the RN may autonomously determine IDLE mode measurements based on RNAI and/or SI.

For example, the RN may determine at least part of a neighbor frequency and cell list and/or a measurement configuration autonomously, network-controlled, and the like. To perform a determination autonomously, the RN may determine which carrier frequency and/or which cell or cells to measure for each frequency based on at least one of the following: the RNAI, if available, as described above, for example for IDLE mode measurements (e.g. the RN in IDLE mode may use the RNAI to autonomously determine the frequencies and/or cells to use for the initial selection process) and/or neighbor Frequency and Cell List (NFCL) where the NFCL may be received from a broadcast channel as part of SI (e.g. SIB3 or similar information) and/or it may be received from a RN-capable DeNB and/or cell, for example, for IDLE mode measurements.

For example, in an embodiment, a RN may acquire system information on a RN-capable cell including one or more list of frequencies, e.g., in the idleModeMobilityControlInfo, and may use the RNAI to autonomously determine the corresponding frequencies and/or cells to use for the re-selection process, for example, for the RN in IDLE mode when searching for a better cell and/or for the RN in connected mode when performing the RRC connection re-establishment procedure.

Additionally, a RN in connected mode and without an explicit measurement configuration may use the RNAI to autonomously determine the frequencies and/or cells to use for initiating a mobility procedure. When the RN may detect a stronger RN-capable and/or accessible cell, it may initiate a mobility procedure such as a forward handover, if the measured cell may be better than the serving cell by an offset value (e.g. which may be configurable based, for example, on user input). In example embodiments, the RN may receive a measurement configuration and may apply the RN access information or RNAI.

To perform a determination of network-controlled measurement configuration, the RN may receive from a DeNB a neighbor frequency and cell list and/or a measurement configuration that may include at least one measurement object and a list of reporting configurations. In embodiments, the configuration may include RN-capable and/or RN-accessible cells; the RN may perform measurements for a frequency/cell that may be included in the RNAI, if available; the list and/or measurement configuration may be received (e.g. the RN may receive the list and/or measurement configuration) using dedicated signaling (e.g. as part of a RRC reconfiguration procedure when the RN is in connected mode) where the RN may receive a measurements configuration that may be for connected mode measurements and/or the RN may derive a Neighbor Frequency and Cell List for IDLE mode measurements from the connected mode measurements; the list and/or measurement configuration may be received using dedicated signaling (e.g. in a RRCConnectionRelease message when the RN may be in connected mode); and/or the RN may receive a Neighbor Frequency and Cell List that may be for IDLE mode measurements.

For example, a RN in connected mode may use an explicit measurement configuration to autonomously determine the frequencies and/or cells to use for cell selection or reselection when in IDLE mode, for example, using a measurement configuration that may match the RNAI. The RN may use a list of carrier frequencies such that it may perform measurements on elements of the RNAI that may correspond to a concerned carrier frequency from the list. The RN may measure and/or provide reports using a priority based on an order of the configuration.

The RN may perform measurements following a specific order; for example, for inter-frequency measurements, the order of the carrier frequency list and/or cell list may indicate priority of frequency or cells. Similarly, the RN may report measurements results following a specific order; for example, the order of the carrier frequency list and/or cell list may indicate priority of frequency or cells or alternatively, the order may be based on measurement results such that, for example, the best cell may be reported first.

In example embodiments, if the RNAI may be known by the DeNB, the measurement configuration may include RN-capable cells. Additionally, the RN may receive from the serving DeNB a Neighbor Frequency and Cell List, including a list of neighbor cells with physical cell index information. The cell list may include neighbor cells that may support RN operation (e.g. cells that may be RN-capable and/or RN-accessible) or may include various types of cells, depending on whether or not the DeNB may have methods or procedures to determine which neighbor cells may or may not support RN operation. In an example embodiments, if the RNAI may not be known, for example, by the DeNB, the measurement configuration may be adjusted to provide measurements for the RN-capable cells measurement configuration.

In another example, the RN may determine which frequency to use for inter-frequency measurements and/or may initiate a mobility-related procedure including a trigger for the transmission of a measurement report (e.g., for network-controlled mobility) and/or a trigger for a mobility event (e.g., for RN-autonomous mobility using, for example, a forward handover) as a function of the RNAI, if available. The RN may determine the frequency (or cell) that may have the highest priority, for example, according to one or more of the following: a semi-static configuration, a sequential position in the RNAI, and/or a cell that may beknown to support RN operation for the type of relay supported by the RN.

For example, the RN may be configured with one or more of the following measurement events: event A1 in which the serving may be better than threshold; event A2 in which the serving may be worse than threshold; event A3 in which the neighbor may be offset better than the serving; even A4 in which the neighbor may be offset better than threshold; event A5 in which the serving may be worse than a threshold 1 and the neighbor may be better than a threshold 2; and the like where the serving may be the frequency that corresponds to the serving DeNB cell; the neighbor may be a frequency that corresponds to one entry in the list of DeNB candidates (e.g. frequency or cell) in the RNAI, for example; threshold 1 and threshold 2 may be, for example, configured by the DeNB using the RRC signaling, and the like.

In an embodiment, the RN may be configured with the RNAI (e.g. a list of RN-capable and/or RN-accessible neighbor cells). The RNAI may not be known by the DeNB (e.g., in case of OAM-provisioned RNAI, or in case the RNAI is derived autonomously by the RN), and/or may represent a sequence of cells for which the RN may be expected to move through (e.g., in the train scenario where the sequence of handovers may be deterministic). The RN may be configured with a measurement event. The measurement event may be applicable to each entry in the neighbor list of candidate DeNB cells, to the one with the highest associated priority, and/or to one with a specific position in the sequence of the list.

Additionally, the RN may be configured by the DeNB with a measurement event for a given or particular frequency where the RN may perform measurements for the cells on the frequency that may correspond to one of the entry in the list or to a cell that may be or may be known to be RN-accessible. In embodiments, mobility procedures may be triggered based on the measurements, for example, for either measurement reporting or a forward handover.

The RN may also autonomously determine certain aspects, classifications and/or parameter of the measurement configuration (e.g. using RNAI) according to at least one of the following for each parameter set: neighbor frequency and cell list, measurement report, measurement gap configuration, and the like.

For example, using neighbor frequency and/or cell list, the RN may determine the appropriate frequencies and the neighbor DeNB cells to measure based on its RNAI, if available, for example, if the RN may not receive a frequency and/or a cell list from the DeNB. In such an embodiment, if frequencies and/or cell lists may be configured in the RN and may include cells that may not support RN (or the RN type supported by the RN) as determined using the RNAI (e.g. if available), the RN may choose not to perform measurements on those cells. Additionally, if frequencies and/or cells lists may be configured in the RN and may not include frequencies and/or cells that may be part of the RNAI (e.g. if available), the RN may include those frequencies or lists in it measurements configuration including, for example, measurement results for detected cells in a measurement report transmitted to the serving DeNB. The RN may also autonomously allocate priorities to the measurement frequencies based on the order of the frequencies in the RN Access Information, if available, for example, if the RN does not receive any priority indication for the concerned cells/frequencies.

In embodiments, using a measurement report, the RN may autonomously configure or may be pre-configured with periodic or event based reporting based on measurement thresholds, for example, if the RN may not receive a measurement report configuration. In such embodiments, the RN may report cells, both listed and detected, regardless of whether they may be known to be RN supporting cells or not. Additionally, the RN may report cells, both listed and detected, that may be included in the RN access information (e.g. if available including cells that may support RN operation). The RN may also report a single cell or a set of cells which the RN may have determined to be suitable as a target cell for RN handover, for example, for a cell that may be included in the RN access information or RNAI (e.g. if available).

According to additional embodiments, a measurement gap configuration may be provided and/or used. For example, if the RN may not be provided with a measurement gap for inter-frequency measurements, the RN may autonomously configure for measurement gaps as described herein.

Systems and methods to determine a measurement opportunity may also be provided and/or used as described herein. For example, in an embodiment, the RN may determine when to start measurements based on a threshold. In such an embodiment, the RN may monitor RSRP (and/or RSRQ) on the serving cell for the Un interface. Similar to the s-Measure parameter, the RN may be configured with a parameter that the RN may use to determine when to perform measurements. The parameter may indicate a threshold value. When the RN may determine that the RSRP measurement (e.g. after some layer 3 filtering) may be lower or less than a threshold value, the RN may start to perform inter-frequency measurements. The RN may be configured with a single threshold value for inter-frequency measurements, or alternatively with multiple threshold values such as one for each frequency on which the RN may perform measurements. The RN may be provided with a threshold to start performing intra-frequency measurements on neighbor cells and/or to start measurements on neighbor cell in general, both for intra- and inter-frequency. In example embodiments, the RN may further determine a measurement opportunity as a function of the RN subframe configuration.

Additionally, the RN may be configured with a measurement gap for inter-frequency measurements. The RN may further autonomously determine which measurement opportunities to use for inter-frequency measurements. The measurement gap and/or measurement opportunities may be a function of the RN subframe configuration (e.g. if provided and/or configured). The RN may use the Un configuration pattern for cells included in the RN access information (e.g. if available) to determine what gap pattern to use and which cells to measure in different measurement opportunities, for example when concerned or particular cells may be a single frequency network (SFN) and the subframes may be aligned.

The RN may also be configured with an Un subframe configuration. In an embodiment, the configuration of Un subframes may affect the measurement opportunities for inter-frequency and intra-frequency measurements on the Un interface. The RN configured with the Un subframe configuration may perform at least one of the following. intra-frequency measurements, inter-frequency measurements, and the like as described herein.

For example, the RN may perform intra-frequency measurements during subframes that may be configured as Un subframes and the RN may search for R-PDCCH. The RN may also perform intra-frequency measurements during subframes that may be configured as non-Un subframes, but may have not scheduled a transmission over the RN Uu interface in the DL to RN UEs. For example, the RN may use the intra-frequency opportunities to detect and synchronize to neighbor cells that may not be subframe aligned with the RN and/or perform measurements on neighbor cells for which the Physical Cell Identifier (PCI) may be known and Reference Signal Received Power/Reference Signal Received Quality (RSRP/RSRQ) measurements may be taken.

Additionally, the RN may perform intra-frequency measurements during subframes that may be allocated for RN Uu transmission, e.g., subframes {0, 4, 5, 9}, such that the RN may turn off transmission on the RN Uu for that duration of time. For example, the RN may use this intra-frequency measurement opportunity to synchronize and to detect cells which are subframe aligned with the RN, for which the RN does not have PCI and/or MIB information. The RN may turn off transmission infrequently enough such that it may not affect the incoming or connected UEs.

According to an embodiment, the RN may perform inter-frequency measurements during subframes that may be scheduled for RN Uu interface transmission. In such embodiment, FDD and/or TDD may be used. For FDD, subframes {0, 4, 5, 9} may be available for inter-frequency measurements, independent of Un subframes configurations. Opportunities for inter-frequency measurements on other subframes may be a function of the Un subframe configuration and non-Un subframes may be used for inter-frequency measurements. For TDD, subframes {0, 1, 5, 6} which are not allocated for Un transmission may be available for inter-frequency measurements by the RN. Other subframes, for inter-frequency measurements, may depend on the allocated Un subframe configuration. Additionally, the RN may perform inter-frequency measurements using the Uu interface receiver during subframes where it may have scheduled no UL grants to the RN UEs.

In an embodiment, the configuration of Un subframes by the DeNB may be a function of the measurement configuration, in addition to or in lieu of available DeNB resources and/or RN load. Additionally, according to an example embodiment, the RN may be configured with Un subframe configuration of {11xxxxxx}.

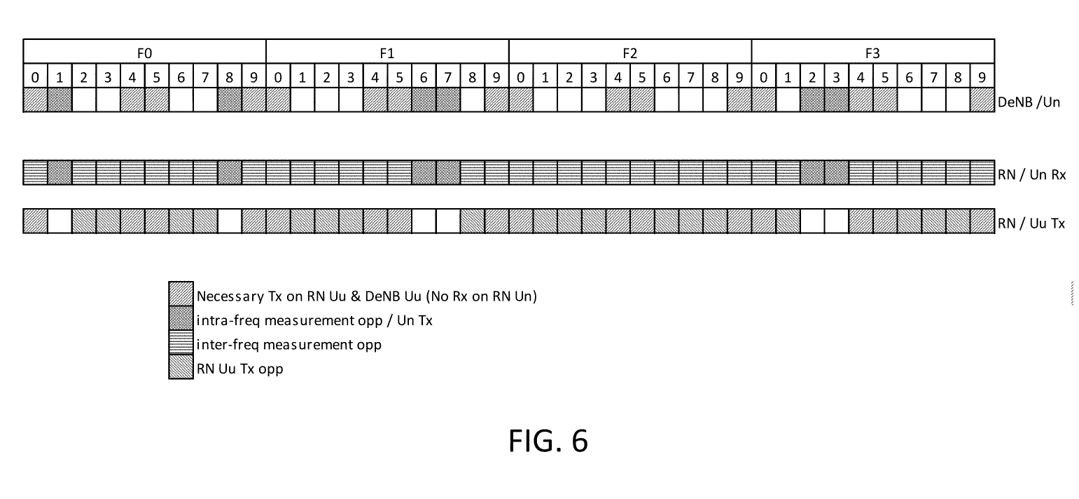

FIG. 6 illustrates an example embodiment of subframes that may be available for Un reception, Uu transmission and related intra-frequency, and/or inter-frequency measurement opportunities. As shown in FIG. 5, the Un subframe configuration may increase the support of higher data rates over the Uu by the RN and may enable or allow for additional inter-frequency opportunities and/or intra-frequency measurement opportunities. The Un subframes may be configured and re-configured as a function of data rate and/or measurement configurations may be set for the RN, both explicitly by configuration or implicitly by the RNAI. As shown in FIG. 6, a plurality of frames F0 to F3 include subframes 1 to 9 for the DeNB Un, RN Un Receive (Rx) and the RN Uu Transmit (Tx). Intra-frequency measurement and inter frequency measurement opportunities may also be illustrated in FIG. 6 respectively.

In an embodiment, the RN may be configured with the Un subframe configuration and may use such a configuration as a pre-determined reception schedule over the Un interface for scheduling of intra-frequency and inter-frequency measurements. During the subframes for which the RN may know that it may receive a Un transmission, it may perform intra-frequency measurements. For the subframes which it may know that it will may receive data over the Un, it may schedule inter-frequency measurements on the Un. Additionally, according to an embodiment, the Un subframe configuration may not affect reception on the Uu interface, for example, if the Uu interface may be configured on a separate frequency than that of the Un interface (e.g. the RN may be configured for outband RN operation). For inter-frequency measurement on a frequency that may be the same as the frequency of the RN Uu carrier, the RN may refrain from scheduling a DL transmission during the measurement subframes. The RN may schedule those subframes as MBSFN subframes such that the UEs connected over the Uu interface may not expect unicast data transmissions in the DL during a pre-determined set of subframes. The RN may also autonomously determine which measurement gaps to configure for the UEs connected over the Uu interface, for example, based on the number of cells to be measured in the particular frequency, for example, if the Uu interface may be configured on a separate frequency than that of the Un interface (e.g. the RN may be configured for outband RN operation).

Systems and/or methods for providing mobility and/or connection control over Un may further be provided and/or used. For example, for UEs such as a Rel-8 UE, the source eNB may initiate a handover based on load balancing criteria and/or based on measurement reports received from the UE. The source eNB may notify the target eNB for preparation of a UE handover, and may provide the signaling for handover to the UE. In case of a RN handover, the decision and initiation may be handled by the DeNB or autonomously by the RN or mobile RN.

In an example embodiment, a network-controlled handover procedure may be provided and/or used as described herein. For example, the serving DeNB may trigger a handover of RN based on measurement reports received from RN, current load conditions, for example, traffic loads due to other RNs, and the like. Additionally, the RN may indicate to the serving DeNB, the handover to another cell by reporting a list of candidate cells (e.g. RN-accessible or RN-capable cells). In example embodiments, the cell list may include a neighbor cell that the RN may have detected and the DeNB may determine the appropriate target RN-accessible or RN-capable cell based on the RNAI. Initiation of handover to the RN from the DeNB may be reflected in a RRC Reconfiguration message with mobility information that the RN may receive. Additionally, in an embodiment, the source DeNB's intent to handover the RN to another cell may be indicated to the RN by X2 signaling. In either signaling instance, along with information used for the RN to synchronize to the target DeNB, information related to the RN configuration in the target DeNB cell may be included as described herein.

A RN-autonomous handover procedure (e.g. a forward handover) may also be provided and/or used as described herein. In such an embodiment, the RN may decide to initiate a handover based on the DeNB configured or autonomously configured measurements. The RN may also make the decision for handover (e.g. may determine to initiate the handover) based on other events such as an increase in Un resources which the current DeNB cell may not be able to provide. Additionally, the RN may decide to move to another neighboring cell based on a load status reports indicating that the neighbor cell may be less congested, for example, in terms of Un data activity. For example, the RN may receive L2 measurements for the Un subframe PRB usage via X2 signaling from the serving DeNB and other neighboring eNBs. The RN may determine that the candidate cell for handover may be RN-capable by referencing its RNAI or its DeNB list. In example embodiments, the RN may indicate initiation of RN handover to the source DeNB.

After making the handover decision, the RN may autonomously initiate the mobility procedure as described herein. In one example method, the RN may indicate to the serving DeNB that it may perform a forward handover to a different cell, for example, of a different DeNB. The notification may include an identity of the target cell and/or DeNB to allow the serving DeNB to perform the RN handover preparation for the target DeNB. The indication from the RN may include a request for handover related information used to move to the target DeNB cell. In response, the DeNB may acknowledge the indication from the RN and, as requested, may provide information used for the handover to the RN and the RN configuration upon or after handover to target DeNB cell. If the RN may have been pre-configured with this information, the RN may receive a response from the source DeNB with an acknowledgement for the RN to continue with its handover. The DeNB may also initiate the preparation of handover with the target DeNB. The RN may receive an acknowledgement from the source DeNB with a different target DeNB cell, and the associated mobility and RN configuration information. The RN may also receive a rejection of request to handover from the source DeNB.

As an example of the indication described above, the RN may send an X2 Handover Request message to the DeNB to initiate a handover for itself. The parameters in the message may include an X2AP ID, a target Cell ID, a GUMMEI of the RN MME and/or other context information. In example embodiments, the information may be the target cell ID, or other subsets of the information, as the DeNB may already have information regarding the RN. The RN may include the indication to send the handover information as the RN may not have been pre-configured with the target cell information.

As a response, the DeNB may use an X2 Handover Request Acknowledge to indicate to the RN that its handover request may have been acknowledged and may take place. The information elements in the message may be filled with or may include the information the RN may use to perform the handover procedure. Additionally, in an embodiment, the RN may receive an acknowledgement with no other information such that RN may proceed with the handover and attempt to synchronize with the specified target DeNB cell, for example, when the source DeNB may have prepared the target eNB for the handover.

According to additional embodiments, the RN may receive from the source DeNB in response to the indication for handover, a handover command for the RN to move to the target DeNB cell as specified or for example a different target DeNB cell. The RN may receive appropriate target cell information from the source DeNB depending on whether RN has been preconfigured for handover. The RN may receive an RRC Connection Reconfiguration message, for example. In example embodiments, the RN may initiate such a RN handover by providing RACH to the target DeNB.

In another method, upon or after the decision for the handover (e.g. to perform the handover) to a selected target DeNB cell, the RN may initiate the handover by attempting to synchronize to the target cell by RACH procedures. The RN may use a valid configuration corresponding to the selected target cell to access the target cell that may have been provided by the RNAI or the pre-configuration. The RN may also indicate or provide to the target DeNB the source DeNB information and/or the RN configuration or information.

In an embodiment, the target DeNB may initiate a transfer of information concerning the RN and the RN UEs and any related information from the source DeNB. The RN may attempt to synchronize to the target cell, as part of its autonomous initiation of handover, while maintaining the original Un connection to the source DeNB, and may maintain RN Uu operation to continue serving the RN UEs. The RN, in this case, may be capable of supporting multiple carriers (and/or carrier aggregation) on the Un interface (e.g., the Un interface may have multiple radio capabilities (access technologies, for example).

Systems and/or methods for performing a RN pre-configuration may be provided and/or used. For example, in another method, the RN may be pre-configured with the RNAI for a set of RN-capable and/or RN-accessible cells and the associated DeNBs. The RN may be pre-configured with the RN configurations that may include one or more of Un subframe configurations, E-CGI, PCI, and/or Uu carrier information, among other information that may be used when being served by the cell (e.g. whether by attach, re-selection, or handover). Pre-configuration, in such an embodiment, may be defined by the RN being provided with information to operate on a given or particular DeNB cell, for example, prior to establishing a connection with that cell and operating as an RN. The RN may be pre-configured by the OAM (e.g. pre-loaded with DeNB list or RNAI prior to power up) by being configured with the DeNB list or the RNAI upon attach to any eNB); being configured by the operator manually via operator input; being configured by the serving DeNB, for example provided with the RNAI of neighbor cells via dedicated RRC or X2 signaling; and the like.

An example of using pre-configuration may be an RN that may be deployed on a high speed train. In such an embodiment, the mobility path of the RN may be pre-determined by the route of the train, and the set of DeNBs that may serve the RN may also be deterministic based on the deployment of the DeNBs surrounding the route of the train. With a known mobility path of the RN, the RN may be pre-configured with a set of RNAI for the DeNBs and RN-capable/RN-accessible cells along with RN configuration (e.g. different with each RN-capable cell or common for RN-capable cells on the route). The RN may autonomously initiate a handover to the neighboring RN-capable cell with a RACH procedure and reduce latency of handover that may be useful in a high speed train. In an embodiment, with a RN pre-configuration, the DeNBs may also be provided with the configuration that may have been applied to the RN.

Systems and/or methods for providing a handover procedure over Un (e.g. using a RN) may also be provided and/or used. For example, as described above, RRC UE procedure (e.g. Rel-10 procedures) including the procedure for mobility may be applicable to the RN. When the RN may perform a handover for the Un interface, the RN may be serving a plurality of UEs connected to one or more cells over a Uu interface. When the RN changes the DeNB, the impact on the UEs served over a Uu interface may be reduced or minimized.

In an example embodiment, systems and methods for handling and/or managing a RN configuration during a handover (e.g. using a RN) may be provided and/or used. For example, as part of the RN handover procedure, various configurations and/or information for the RN cell operation may be provided to the RN during handover including, for example, a Un subframe configuration, a RN Uu carrier frequency, a global cell ID (e.g. E-CGI), a physical cell ID (e.g. PCI), and the like.

For example, in one embodiment, the RN may be configured with a Un subframe configuration with the source DeNB prior to handover and also may be configured with Un subframe configuration that may be a different subframe configuration with the target DeNB. Additionally, the RN may include (e.g. may receive) information that may indicate to carry over the same subframe configuration upon moving from the source DeNB to the target DeNB. The RN may further release a Un subframe configuration upon handover to the target DeNB and may operate as type 1a RN, based on one or more of the following: no new Un subframe configuration being received; the Un and/or Uu carrier frequencies; the DeNB cell's capability to support the RNs of certain types that may be derived from the RNAI; and the like.

Additionally, in embodiments, the Uu carrier frequency on the RN may be maintained on the same frequency during the RN mobility procedure. In other example embodiments, the Uu carrier frequency on the RN may be changed when moving to the target DeNB. When the frequency may be changed, the new Uu carrier frequency may be determined by one or more of the following: the OAM upon indication of an intent to move to a new target DeNB cell; the target DeNB determining the RN Uu carrier frequency as a function of one or more of its own operating frequencies (e.g., a Un carrier frequency, the RN type supported by both the RN and the target DeNB cell, and/or interference conditions at the time of handover) where dynamic changes to cell conditions may be considered when the DeNB determines the new RN Uu carrier frequency rather than the OAM providing such a determination; and the like.

In example embodiments, the RN may determine the Uu carrier frequency when moving to the target cell based on one or more of its Uu and Un frequencies when operating with the source DeNB, the target DeNB operating frequency (e.g. Un carrier frequency), the RN type when operating with the source DeNB, and/or the RN type supported by both the RN and DeNB cell.

According to one embodiment, a global cell ID (E-CGI) may be provided and/or used, for example, during a handover. For example. the DeNB eNB ID may be embedded within the RN ECGI such that the ECGI may change for each RN mobility procedure to a different DeNB. The new ECGI value may be provided by the RN OAM. In example embodiments, the DeNB may provide the new value. For example, the RN may autonomously determine the ECGI value based on the new DeNB eNB ID and may re-apply the old E-CGI for the remaining portion (e.g. 8 bits) of the identity. Additionally, a fixed E-CGI may be allocated for an RN that may not depend on DeNB eNB ID and may stay the same through mobility procedures. The neighboring eNBs to the RN and/or the serving DeNB may be associated with the DeNB and the E-CGI of the RN when addressing X2 signaling to the RN. In additional embodiments, a mapping between a fixed E-CGI and the DeNB eNB ID based E-CGI may be updated and may be maintained by the neighboring eNBs such that the neighboring eNBs may identify and track the RN moving through the network.

As described above, a physical cell ID (PCI) may also be provided and/or used, for example, during a handover. In such an embodiment, the PCI of the RN may stay the same unless a PCI collision or confusion may occur with the neighboring cells after the RN mobility procedure. Additionally, in such an embodiment, the OAM or DeNB may re-configure the PCI value or allow for the RN to employ automatic PCI selection.

Systems and/or methods in which the RN may receive one or more of the configurations described herein may include one or more of the following. For example, the RN may receive a configuration prior to synchronization to target DeNB cell. In such an embodiment, the RN may receive the configuration from the source DeNB along with information that may be used for the RN to synchronize to the target DeNB cell, for example, as part of the handover initiation signaling as described herein and/or the RN may receive the RN configuration from the target DeNB through the source DeNB during the handover preparation procedures. For example, the RN may receive the Un subframe configuration for the target DeNB cell as part of the RRC reconfiguration message or may use a separate RN reconfiguration message. The RN, in this case, may determine that the new Un subframe configuration may be applied with the target DeNB cell. Alternatively or additionally, the RN may retrieve the RN configuration from the OAM once the target DeNB cell and, for example, the RNAI related information for the target cell may be known, prior to synchronizing with the target cell.

In another embodiment, the RN may receive a configuration upon synchronization to target DeNB cell. For example, in such an embodiment, the RN may be configured for RN Uu operation (e.g. including configuration parameters such as the Un subframe configuration, the PCI, the E-CGI, the RN Uu carrier frequency) upon or after completion of the RN mobility procedure such as after transmission of a RRC Reconfiguration Complete message to the target DeNB, and/or after the connection to the RN OAM entity may have been re-established via the target DeNB. The RN may receive broadcast information, for example, a new Un subframe configuration, if appropriate, and physical channel related configuration information by the RRC RN Reconfiguration from the DeNB, or, for example, from the RN OAM. Alternatively or additionally, the RN may retrieve the RN configuration from the re-connected RN OAM including parameters such as the RN Uu carrier frequency information, the E-CGI and/or the PCI, among others.

Additionally, the RN may use a pre-loaded RN configuration (e.g. that may be provided and/or configured). The RN may be preconfigured with the RN configuration, for example, as part of RNAI to be used by the RN for a predetermined set of potential cells that the RN may move through during its operation. The pre-loaded configuration may be used, for example, if the mobile RN may be on a train, or other scheduled route, moving along a pre-determined route. The network and the eNBs supporting a mobile RN or RN may also be configured such that the RN configuration may be similar or the same from cell to cell (e.g. source DeNB cell to target DeNB cell, repeatedly) and the change of the RN configuration may be minimized during the mobility procedure such as a handover procedure. For example, the RN may be provided with the RN configuration for neighboring DeNBs upon completion of mobility procedure to the target DeNB cell. The RN may retrieve the RN configuration information from the OAM or, the RN configuration information may be provided by the new serving DeNB including a configuration that may be used by the RN for a set of neighboring RN-capable cells to which the RN may subsequently handover.

Systems and/or methods for managing and/or handling a RACH procedure during a RN handover may also be provided and/or used. For example, a RN such as Rel-10 RN or other RN may perform a RACH procedure for an initial attachment and/or a RRC re-establishment upon a radio link failure (RLF), D-SR failure, and/or intra-cell handover. In these embodiments, the RN may release active Un subframe configurations prior to performing a RACH procedure and may re-activate it upon completion of the procedure.

The mobile RN or RN may perform the RACH procedure for synchronization to the target DeNB cell as indicated by the source DeNB or determined autonomously. For example, the mobile RN or RN may perform contention based RACH or contention free RACH depending on whether the RN may be provided with dedicated RACH resources from the source DeNB and/or may have been preconfigured with dedicated RACH resources of the target DeNB cell.

During the RN RACH procedure for synchronization with the target DeNB cell, the Un subframe configuration of the RN may have been applied with the source DeNB and may be applied (e.g. based on handover procedures) with the target DeNB cell. According to an example embodiment, minimizing the release or disabling of Un subframe configuration during the RACH procedure may lead to improved service in the RN Uu and to the UEs.

The RN handling of RACH and transition from old to new Un subframe configuration, if configured, may be performed, for example, as follows. When there may be no Un subframe configuration with the source or target DeNB (e.g. the RN being type 1a/1b on both cells), the RN may perform a RACH procedure without restriction.

Additionally, when there may be a Un subframe configuration with the source DeNB and no Un subframe configuration with the target DeNB, the RN may disable the Un subframe configuration on the Un interface and may perform a RACH procedure without restriction. The RN Uu may operate with MBSFN subframes allocated in conjunction with the original Un subframe configuration until the RN may update the broadcast information upon a move to the target DeNB.

According to an additional embodiment, when there may be no Un subframe configuration with the source DeNB and a new Un subframe configuration may be with the target DeNB, the RN may perform a RACH procedure without restriction. Once synchronization to the target DeNB cell may be completed, the RN may activate the Un subframe configuration as provided or configured.

When there may be a Un subframe configuration with both the source and the target DeNBs and whether the Un subframe configuration with the source and target DeNB are the same or different, the RN may release the Un subframe configuration used with the source DeNB prior to performing the RACH procedure, and may activate the new Un subframe configuration with the target DeNB after (e.g. immediately after) the RACH procedure may be completed. For example, the RN may de-activate the Un subframe configuration, at least on the Un, prior to transmission of the RACH pre-amble to the target DeNB. Once the RN may have received the RACH response, the RN may activate the new Un subframe configuration prior to transmitting the RRC Reconfiguration Complete message.

When the RN may not be provided with Un subframe configuration for the target DeNB prior to the RACH, the RN may release Un subframe configuration, if present, to perform the RACH procedure.

Additionally, during the RN mobility procedure, due to the changes of the RN configuration and/or handover of the Un interface, disruptions to RN Uu interface and the UEs being serviced by the RN may occur. To reduce or minimize such impacts, systems and/or methods along with those described above may be provided and/or used as disclosed herein.

For example, systems and/or methods for managing or handing a RN handover failure may be provided and/or used as described herein. In particular, the RN handover procedure may end in failure, for example, due to a T304 timer expiration that may indicate such a handover failure. In such an embodiment, the RN may follow procedures as specified in the RRC including one or more of the following: setting an IE measResultNeighCells to include the best cells from the RN accessible list if known, where the best cell may be listed first (e.g. listed in priority order); if measurements may have been performed, including the carrier frequency and measurement results in the RRC Connection re-establishment message; and/or revert back to the previous RN configuration including the RN subframe configuration.

Additionally, as part of handover call admission control of the RN at the target DeNB, resource availability for the RN and/or the UEs that may be served by the RN may be considered. As part of the handover preparation, the RN may be provided by the source DeNB with one or more following outcomes: a partial failure where the RN may have been accepted but a subset of UEs may have not been accepted due to a lack of resources such that the RN may initiate a re-direction/handover of UEs that have been rejected to another neighboring cell that is different from its own target DeNB cell, prior to the RN handover; a partial failure where the RN may have been rejected but each of the UEs or a subset of UEs may have been accepted such that the RN may initiate a re-direction or handover of UEs to the original target cell prior to re-attempting a handover to another target RN-capable cell; and/or a full failure where the RN and the RN UEs may have been rejected such that the RN or the DeNB may re-attempt a handover to another target RN-capable cell.

In further embodiments, systems and/or for handling or managing a behavior of a RN upon Radio Link Failure (RLF) for a Un may be provided and/or used as described herein. For example, a RN such as a Rel-10 RN or other RN may experience RLF on the Un interface (e.g. with a low probability). When RLF may occur, re-establishment procedures for RLF recovery enable recovery to the same cell or to the same DeNB. When using a mobile RN or RN, upon RLF detection, recovery to the same DeNB may no longer be available (e.g. possible) as the RN may have moved away. To expedite RLF recovery while being able to maintain service to RN UEs, the re-establishment procedure for RN may be used on each cell in the DeNB list such as, for example, a cell detected that may also support the RN.

Additionally, the RN may select a RN-capable cell that may be a different DeNB than the original serving cell and may perform re-establishment procedures without having to move to the IDLE mode such that the RN may perform a quick recovery for re-establishing the Un with a DeNB. For example, the RN may perform an RRC connection re-establishment procedure with the newly selected DeNB. Upon acceptance of the re-establishment procedure of the RN, the DeNB may request RN context information from the original serving DeNB or may be able to derive the RN context and/or the RN configuration information from its RNAI. The RN may also attempt to transfer the RN UE contexts to the new DeNB and/or RABs although the transfer of each of the RABs may not be possible or guaranteed. In example embodiments, the RN may attempt to temporarily move UEs to IDLE mode or, for example, move the UEs via a handover or cell re-selection to neighboring cells.

According to an embodiment, the RN may not successfully re-establish an RRC connection to a DeNB such that the RN may move to IDLE state or mode. In such an embodiment, the RN UEs may be managed and/or handled such that the RN may move to the IDLE mode as described herein.

Additionally, Uu systems, procedures and/or methods related to Un connection including mobility-related procedures may be provided and/or used as described herein including a RN's management or handling of synchronization of system related parameters for connected and/or IDLE UEs on Uu; a RN's management or handling of different Un/Uu subframe timing boundaries (e.g. when the Un subframe boundaries may differ from those of Uu with less than one subframe such as, for example, a fractional subframe timing difference); a RN's management or handling of different Un/Uu MBSFN subframe alignment (e.g., when the Uu MBSFN subframes may be shifted in time by one or multiple subframes compared to the Un MBSFN subframes); a RN's management or handling of the Uu interface with respect to a Traffic Area (TA), the Traffic Area Update and the PLMN along with updating other system parameters; a RN's management or handling of the Uu interface when performing a transition to connected mode for the Un interface (e.g., upon successful establishment of the RRC connection applicable to the Un interface, for example, when performing initial access or a re-establishment procedure); a RN's management or handling of a RLF on the Un interface with respect to the UEs such as the RN UEs on the Uu interface (e.g. in connected mode or in IDLE mode); a RN's management or handling of the Uu interface when performing a transition to IDLE mode for the Un interface; a RN's management or handling of the Uu interface when performing a procedure that may detach the RN from the core network; a RN's management or handling of a Tracking Area for the Uu interface; and the like.

Systems and methods for system information acquisition for a Uu interface may also be provided and/or used as described herein. For example, the RN may initiate a system information acquisition procedure for the UEs (e.g. either in connected mode or, for example, camping in IDLE mode) on the Uu interface. The RN may, for example, initiate such a procedure to force one or more connected UEs such as rUEs (RN UEs or UEs that may be served by the RN) to re-acquire at least the SystemInformationBroadcast Type 1 (SIB1). In such an embodiment, the SIB1 may carry parameters that may be used for accessing the cell. These parameters may include the tracking area identity (e.g., the trackingAreaCode) that may be used by the network (MME) to determine the location of a UE at the granularity of multiple cells for paging; the PLMN identity (e.g. plmn-Identity); the identity of the cell (e.g. cellIdentity); the access level of the cell (e.g. cellBarred); the validity of the system information (e.g. systemInfoValueTag); and/or other parameters such as those related to scheduling of further System Information; and the like.

A UE may also periodically monitor the paging channel and/or the SIB1 to detect changes in SI (e.g. system information). The RN may trigger SI acquisition for the Uu interface by indicating that the SI may have been updated in a paging message (e.g. applicable to connected and IDLE mode UEs) including, for example, a systemInfoModification indication. A UE may acquire the new SI from (e.g. immediately from) the start of the next SI modification period. The RN may indicate that the SI may have been updated using the systemInfoValueTag.

Additionally, a UE may initiate an ATTACH procedure to the EPS (e.g., the MME) when it detects a change in the Tracking Area (and/or the PLMN). Example methods may be used by the RN on the Uu interface as a function of the Un operation.

Systems and/or methods to disconnect UEs on the Uu interface (e.g. a hard system resynchronization) may be provided and/or used as described herein. For example, the RN may initiate a resynchronization procedure for the UEs (in connected mode or, for example, while camping in idle mode) on the Uu interface. Such a procedure may first disconnect a UE such as rUE or RN UE from the Uu and, for example, may include a reconnection procedure for the concerned or particular UE such as the rUE or RN UE. The reconnection may be a delayed reconnection as described here.

Additionally, in embodiments, the RN may determine that the procedure be initiated according to methods described herein (e.g. below). For example, a request-based method (RRC or PDCCH) that may include a disconnect, for example, with redirection and/or reconnection may be provided and/or used. In such an embodiment, the RN may request that the UEs or rUEs (e.g. RN UEs) first disconnect from the Uu. For example, the request may be part of a RRC procedure and the RN may use the RRC Connection Reconfiguration procedure (e.g. using a RRCConnectionReconfiguration message) that may include the handover command (e.g., a mobilityControlInfo IE that may indicate a target cell which may be a cell of the RN similar to an intra-eNB handover procedure). In embodiments, the RN may use and/or perform the RRC Connection Release procedure (e.g. using a RRCConnectionRelease message including a redirection e.g., a RedirectedCarrierinfo IE) that may indicate the same downlink frequency and/or cell or a different frequency and/or cell (e.g. of the same RN) in a ARFCN-ValueEUTRA parameter. For example, the target cell may be the same as the source cell or a different cell, for example, that may be indicated by including a value of the targetPhysCellId different than that of the Uu on a different frequency. The RN may use a target cell that may correspond to the DeNB of the RN such that UEs such as rUEs may be redirected to, for example, the macro cell to which the RN may have itself established the RRC connection. For example, the RN may use a target cell that may correspond to cells within its configured mobility measurements. The selection of a cell as a target cell for a given or particular UE such as a rUE may be based on the RN's own mobility measurement results, for example, in the absence of measurement results for the concerned or particular UE or rUE. The target cell indicated may be provided by the DeNB (e.g. using a procedure on the Un such as a RRCConnectionRelease message including a redirection for the rUEs on the Uu).

According to example embodiments, the request may include layer 1 signaling such as a PDCCH DCI that may request the UE to resynchronize. For example, the DCI may be a request for performing a random access procedure (e.g. a PDCCH DCI format 1A). Additionally, the request may be a group mobility procedure. For example, the request may include a back-off time that may represent a delay before which the UEs or rUEs may initiate the random access procedure in the indicated target cell.

In additional embodiments, the RN may determine that the procedure be initiated based on a change to Uu transmissions such as a disconnect. For example, the RN may modify or may turn off at least a portion (e.g. some or each) of its Uu transmissions. In such an embodiment, the RN may turn off the cell-specific reference signals. The absence of cell-specific reference signals (CRS) may cause or force UEs connected to the Uu into detection of radio link problems (e.g. out-of-sync indications from the physical layer to RRC) and may trigger a connection re-establishment procedure. For UEs that may be camping on the Uu (e.g. IDLE mode UEs) the change in CRS may lead to a cell re-selection procedure.

Such systems and/or methods (e.g. above) may be used by the RN on the Uu interface as a function of the Un operation described herein.

Additionally, according to an embodiment, a system and/or method for DL Timing synchronization may be provided and/or used as described herein. Such systems and/or methods may address management or handling by the RN of different subframe timing boundaries between its Uu subframes and the Un subframes that may occur when the RN may move from a source DeNB to a target DeNB (e.g. when the RN reconfigures the Un interface).

For example, a Fractional Subframe Timing Difference (FSTD) may be provided and/or used. The FSTD may be a condition when the difference between the subframe boundary of the Un and the Uu interfaces may be less than one subframe. Depending on the actual value of this subframe timing offset or difference, various example methods may be used. For example, different offset thresholds may be defined for the subframe timing offsets where each threshold may be used to trigger a particular method. These thresholds may be provided by the OAM and/or configured by the network.

Although methods here maybe described with respect to FSTD, such methods may be applied in combination with other example methods. For example, in one embodiment, the information associated with the different subframe timing boundaries of the target DeNB may be provided to the source DeNB and/or to the RN. Additionally, the timing offset may be measured by the RN itself and may be communicated to the source eNB and/or the target eNB. Based on such a timing offset, the RN may be handed over to a candidate DeNB that may have a suitable subframe timing boundary (e.g. a candidate eNB that may have the same subframe timing boundary as that of the RN). The information associated with the subframe boundary of a DeNB may be provided as part of the RNAI.

In another example method, the RN may perform a procedure that may result in the disconnection of the UEs that may be connected to the Uu interface (e.g. the UEs or rUEs). The RN may perform such a procedure before initiating a mobility procedure for Un or while the mobility procedure for Un is ongoing. According to an embodiment, the procedure that may disconnect the UEs or rUEs from the Uu interface may enable or allow the concerned or particular UEs to reconnect (e.g. using an intra-eNB handover) or resynchronize (e.g., using a procedure that may modify the synchronization signals and/or that may force cell re-selection procedure by the UEs or rUEs). Additionally, the UEs or rUEs may be redirected to another cell using a handover procedure, for example, the UEs or rUEs may be redirected to the DeNB.

The RN may also perform at least one of the following. For example, the RN may initiate a hard system resynchronization for the Uu interface using a request-based method. Additionally, the RN may initiate a hard system resynchronization for the Uu interface using a change to its Uu transmissions (e.g. the RN may shift at least the downlink cell-specific reference signals). A change in cell-specific synchronization timing that may exceed the timing error supported by the connected UEs may force the UEs or rUEs to resynchronize to the cell-specific reference signals. For example, the shift may be applied step-wise in different subframes in step units smaller than the maximum timing error that may be supported by a UE.

According to another example method, the RN may apply a proper Un subframe configuration that may enable or allow reception and/or transmission operations on Uu (e.g. even in the presence of a fractional subframe timing difference between Un and Uu). In such an embodiment, the RN may perform at least one of the following, for example. The RN may indicate to one or more network entities (e.g., the source and/or the target DeNBs) its subframe fractional timing offset measured directly by the RN and/or its subframe timing relative to a predefined reference. One example of such predefined reference may be the subframe timing boundaries of the source DeNB. In certain example embodiments, the target DeNB may receive such information from the source DeNB.

Additionally, the RN may receive the target DeNB relative subframe fractional timing offset. Such information may be received from (e.g. directly from) the target DeNB through the source DeNB, other network entities, and/or via a direct RN measurement.

According to embodiments, the RN may receive data on the Un DL subframes that may not fully or partially overlap with Uu DL subframes that may not be able to be configured as MBSFN (e.g. Uu DL subframes 0, 4, 5 and 9).

The RN may also extract the actual Un DL subframe arrangement by receiving the Un DL subframe configuration and/or using the knowledge of the target DeNB relative SFTO. For example, if the target DeNB subframe boundaries may be a fraction of a subframe advanced in time compared to those of the RNs, in the first Un frame, subframes 1, 2, 6 and 7 may be allocated to Un DL where if the there may be no fractional subframe offset subframes 1, 2, 3, 6, 7 and 8 may be allocated for Un DL.

In additional embodiments, the RN may transmit data on Uu DL subframes that may not fully or partially overlap with the actual subframes allocated on Un DL.

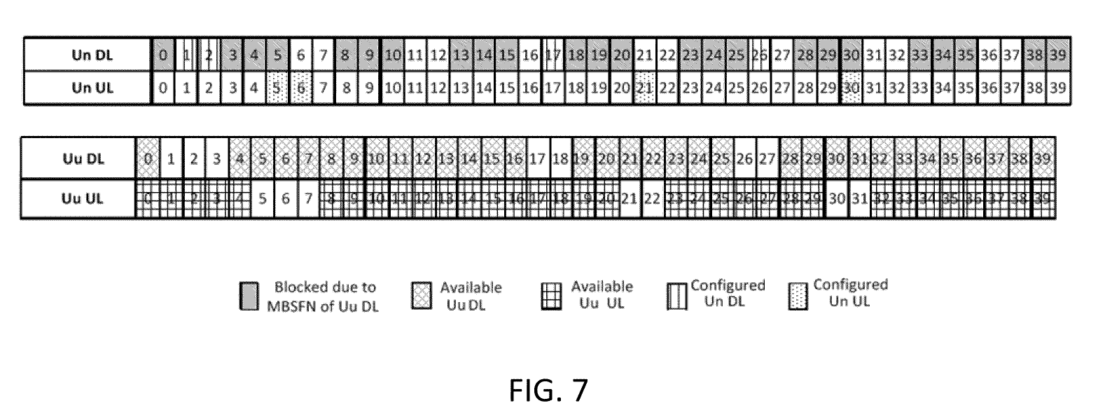

FIG. 7 depicts an example subframe configuration with FSTO between Un and Uu. As shown in FIG. 7, proper Un and Un subframe configuration that may enable receive and/or transmit operations on Uu even in the presence of fractional subframe timing difference. In this example, the RN and its corresponding DeNB may initially allocate a Un DL subframe configuration using the pattern “01100000” and the Un subframe boundary of the DeNB may be a fraction of a subframe advanced in time relative to the timing of the subframe boundary of the RN. If this may have been time-aligned (e.g. without FSTO), the pattern may make Un DL subframes {1, 2, 17, 18, 26, 33} available for Un DL Tx. Due to the shifting of alignment between the Un DL and the Uu DL from the FSTO (e.g. resulting from a handover), subframes 18 and 33 may no longer be available as they overlap with subframes that may be allocated for the Uu DL transmissions. Using example methods described herein, the RN and the DeNB may determine that the subframes 18 and 33 may not be used (or at least in part may not be used). For example, the overlapping subframes 18 and 33 may be determined using signaling between the source and/or target DeNB and the RN. The signaling may include information indicating the timing delta between the Un DL and Uu DL for the DL channel and/or information indicating the timing delta between the Un UL and Uu UL for the UL channel.

Systems and/or methods to manage or handle a different RN Un/Uu subframe alignment and/or such boundary or timing differences may also be provided and/or used as described herein. For example, the RN may handle different subframe timing boundaries between its Uu subframes and the Un subframes for subframe alignment, for example, when the RN may move from a source DeNB to a target DeNB (e.g. when the RN reconfigures the Un interface). Additionally, in example methods, the difference between the subframe boundary of the Un and the Uu interfaces may be one or multiple subframes. Such systems and/or methods for subframe alignment may further be applied by themselves or in combination with other methods described herein.

In one example method (e.g. for alignment), the RN may reconfigure its Uu subframes such that the position of restricted MBSFN subframe (e.g., subframes which cannot be configured as MBSFN) may match that of the Un configuration.

According to another example method, the relative subframe timing difference of the RN may be used during the subframe configuration process of the RN. Additionally, one or more of the following may be performed in such an embodiment. For example, the RN may transmit to one or more network entities (e.g. the source target DeNB, the target DeNB, etc.) an indication of its subframe timing shift. Such an indication may be relative to a predefined reference (e.g. the RN may use the subframe timing of the source or target DeNB as a timing reference). In example embodiments, the information may be shared between network entities (e.g. the source DeNB may inform the target DeNB of the timing shift (or offset) between the source DeNB and the RN and, for example, also between the source and target DeNB). The RN may receive a subframe configuration parameter that may be relative to the start of the RN frame. The RN may receive data on Un DL subframes that may not overlap with Uu DL subframes (e.g. the Uu DL subframes 0, 4, 5, and/or 9 on which the RN transmits on the Uu DL).

Systems and/or methods for updating System Information (SI) parameters on Uu may be provide and/or used. For example, in an embodiment, the RN may manage or handle the Uu interface with respect to events on the Un interface that may have an impact on a number of parameters for the Uu interface (e.g. Traffic Area, Traffic Area Update, a change of PLMN, a change in parameters related to System Information Blocks SIB1, SIB2, to SIBx, a change in MBSFN configuration and/or other parameters including a change of SI on the Un, a reconfiguration of the Un interface such as the mobility control information element that may be received by the RN from the DeNB and/or a mobility event when the RN may be in the IDLE mode (e.g. f some Uu operation is supported for RN idle mode)).

For example, as described above, the RN may mange or handle a Uu interface with respect to a change of system information parameters related to Un. In such an example embodiment, the RN may initiate a hard system resynchronization for the Uu interface, when the RN may determine that a change to the Un interface may provide or use a resynchronization of the UE or rUE state with the network (e.g. at the NAS level). For example, the RN may determine that the serving cell it is accessing for the RN Un operation corresponds to a different tracking area, to a different PLMN, and/or may be a different cell, for example, due to: (1) an update of the SI for the Un interface (e.g., a cell of the DeNB), (2) an initial access to a cell, for example, based on a cell selection procedure, reselection procedure and/or a handover procedure.

Additionally, the RN may mange or handle a Uu reconfiguration that may be received on Un. For example, in an embodiment, the RN may initiate a SI acquisition for the Uu interface, when it may determine that reconfiguration of the Un interface may provide or use a resynchronization of the UE or rUE state for the Uu interface (e.g. at the RRC level). For example, the RN may receive from the DeNB over the RN Un interface, a reconfiguration message that may include updated parameter values for one or more of the broadcasted SI on the Uu. The parameters may be less important for system access using a Uu interface and/or for IDLE UEs camping on the Uu interface. Such parameters may include, for example, the MBSFN configuration for the Uu.

In embodiments, the RN may initiate a hard system resynchronization for the Uu interface. For example, the RN may receive from the DeNB over the RN interface a reconfiguration message that may include updated parameter values for one or more of the broadcasted SI on Uu. Such parameters may be more important than other parameters for system access using a Uu interface and/or for IDLE UEs camping on the Uu interface. Such parameters may include the tracking area identity (trackingAreaCode), the PLMN identity (plmn-Identity), the identity of the cell (cellIdentity), the access level of the cell (e.g., cellBarred), or the downlink and/or uplink frequency for Uu operation, and the like.

The RN may also manage or handle a Uu reconfiguration that may be received on Un including the mobility control IE. For example, the RN may perform Uu reconfiguration when the RN may move from the source DeNB to the target DeNB. The reconfiguration of the Un interface may include the mobility control information element.

Systems and/or methods for transition to a connected mode for a Un connection may also be provided and/or used. For example, the RN may start broadcasting the primary synchronization signals (PSS), the secondary synchronization signals (SSS), the cell-specific reference signals (CRS), the physical downlink control channel (PDCCH), and/or SI on the physical broadcasting channel (PBCH) on the physical downlink data shared channel (PDSCH) when the RN may be in a connected state for the Un connection, for example, upon successful completion of the initial RRC connection establishment procedure and/or after successful completion of the RRC connection re-establishment procedure. As such, the RN may not transmit downlink channels on a frequency while the RRC connection for the Un may be in the IDLE mode. The RN may further modify the SI such that the cell may be available for normal service level (e.g. without access restrictions), for example, when a DeNB may request the RN to allow Uu access (e.g. in the case of a network-controlled RN access requested by the DeNB).

Systems and/or methods for managing or handling UEs on a Uu upon RLF on a Un may be provided and/or used as described herein. For example, in embodiments, the RN may manage or handle a RLF on the Un with respect to UEs on the Uu that are in connected mode or in idle mode. In one example method, when the RN may determine a RLF (e.g. in the downlink and/or uplink) and may perform a transition to IDLE mode, the RN may perform a method for recovery from RLF on the Un. Such a method may be performed upon detection of physical layer problems (e.g. from the radio link monitoring function, e.g., when the RN start T310).

Additionally, systems and/or methods for transitioning to an IDLE mode for a Un connection may be provided and/or used as described herein. For example, the RN may manage or handle the Uu interface when the RN may perform a transition to the IDLE mode for the Un connection. In such an embodiment, the RN may select and/or perform a transition to the IDLE mode for the Un connection (e.g. a particular method thereof) depending on the cause for which it left the connected mode. According to example embodiments, the RN may move to an IDLE mode based on at least one of the following: data traffic for a Uu, UEs not being connected to the Uu, a failure condition occurring, the Un being released, and the like.

For example, when there may be no or a small amount (e.g., less than a threshold amount) data traffic for the Uu, the RN may determine (e.g. based on one or more buffer levels for the connected rUEs for the downlink, and/or reported buffer levels by connected rUEs for the uplink) that the RN may move to (e.g. initiate) a low power state and/or move to (e.g., initiate) the IDLE mode. In such an embodiment, the RN may first release the connected UEs and may redirect or handover the concerned rUEs to another cell or another eNB.

Additionally, the RN may determine that there are no rUEs connected to the Uu interface such that it may move to (initiate) a low power state and move to (initiate) the idle mode.

According to an embodiment, a failure condition such as a handover failure, a radio link failure, problem, or quality, a connection or reconnection failure, and the like may occur or may be present. For example, the RN may determine that a handover failure for the Un interface may have occurred, that the physical layer for the Un interface may be experiencing a radio link problem, that a radio link failure (e.g. in the downlink and/or the uplink) may be detected for the Un interface, that a radio link quality of the Un interface may be below a certain threshold, and/or that a connection re-establishment for the Un interface may have failed. Based on the determination, the RN may initiate the IDLE mode, for example, after suspending data transmission for the UEs or rUEs on Uu for a certain time period (e.g. while the T310 may running when the RN may detect physical layer problems for the Un interface and/or while the T311 may be running when the RN may initiate a RRC connection re-establishment procedure for the Un interface).

The RN may also release the Un connection (e.g. for reasons different than a failure condition). For example, the RN may autonomously determine that the RRC connection for Un may be released (e.g. upon a request by upper layers such as NAS). The RN may receive control signaling from the DeNB that may release the RRC connection for Un (e.g. the RN may receive a RRCConnectionRelease message including a re-direction to another cell and/or the RN may receive a RRCConnectionReestablishmentReject message).

In example embodiments, when the RN may determine that it may move to IDLE mode (e.g. due to a lack of data traffic and/or no UEs being connected to Uu or a release of UN), the RN may turn off at least a portion of its Uu interface. Alternatively, the RN may continue to provide various signals for the UEs to camp on the Uu interface. For example, the cell may be available for emergency services. The SI may change to indicate that the cell may not be accessible or may have some access restrictions. The UEs may perform measurements for the cell, but may not autonomously initiate access to the cell, for example, in the case of a network-controlled RN access.

Additionally, when the RN may determine that it may move to an IDLE mode, because a failure condition may have occurred, the RN may perform at least one of the following: the RN may initiate a hard system resynchronization for the Uu interface using a request-based method; the RN may initiate a hard system resynchronization for the Uu interface using a change to its Uu transmissions; and the like.

According to an example embodiment, when the RN may select (e.g. successfully selects) a suitable cell, the RN may remain in the IDLE mode and the RN may change the SI on Uu to indicate, for example, that the cell may not be accessible or may have some access restrictions such that the UEs may perform measurements for the cell, but may not autonomously initiate access to the cell, for example, in case of a network-controlled RN access.

Systems and/or methods for handing or managing a RN detach on a Un connection and the impact to a Uu interface may also be provided and/or used. For example, in embodiments, the RN may handle the Uu interface upon an event that may detach the RN from the network. When the RN may initiate or receive a detach request from the MME, the RN may initiate a hard system resynchronization for the Uu interface, for example, the UE may perform a method that may redirect and/or hand over the UEs or rUEs to another cell of a different eNB.

Additionally, systems and/or methods for Tracking Area (TA) updates (TAU) procedures for UEs on a Uu may be provided and/or used as described herein. For example, the RN may handle and/or manage IDLE mode mobility and/or a change in Tracking Area on the Un with respect to Uu interface using, for example, a RN-specific Tracking Area (TA) code and/or a Un TA code on the UE that may be replicated by the RN.

For a RN-specific TA code, the RN may broadcast, for example, a RN-specific tracking area identity (trackingAreaCode) on the SI. The value may be configured by the OAM, by the DeNB or by the MME when the RN may initially connect to the network. The same procedure may also apply to the PLMN identity (plmn-Identity). For example, independently of mobility for the Un interface, the assigned tracking area identity for the RN's Uu interface may be valid even when the tracking area of the Un interface changes as long as the RN may remain connected to the same PLMN.

In such an embodiment, if the MME may have knowledge of the location of the RN at the eNB granularity (e.g. when the RN may be in connected mode) or at the tracking area granularity (e.g. when the RN may be in IDLE mode), and if the MME may have knowledge of the RN-specific tracking area identity that may be used by the RN for the Uu interface, the MME may map the location of a UE that may register through the RN Uu interface by creating the mapping between the RN location and the RN-specific TAI for a given or particular UE. Because such a TAI may be RN-specific, an IDLE mode UE that may reselect to a different cell with a different tracking area identity may automatically trigger a tracking area update to inform the MME. A UE that may reselect to or from the RN Uu interface may perform a tracking area update in both cases. In the case where the RN may move to another TAI and may keep its own tracking area identity, the MME may handle the new mapping for the UEs or rUEs that may have been last registered to the RN's tracking area identity; the RN may remain reachable, and the UEs may remain reachable through the RN.

For example, the RN-specific tracking area code may not be included in the TAI list of one or more eNBs of the same PLMN and/or MME area (e.g. the TAI list may identify the tracking areas that the UE can enter without performing a tracking area updating procedure and the TAIs in a TAI list assigned by the MME to the UE may pertain to the same MME area).

In embodiments, because the RN may use the UE's S-TMSI to forward on-board a UE's NAS (extended) service request message to a MME hosting UE's registration, and because the S-TMSI may not identify the MME-pool serving the UE, the MMEs serving the on-board UEs may be in a specific MME-pool pre-configured in the RN based on the RN start-up OA&M. Such a MME-pool configuration may not be UE specific, because RN may not maintain a UE's context for idle UEs. As the train moves from one location to another, such a MME-pool configured in the RN may at some point be different from the MME-pool that may be used by the eNBs neighboring the train track.

When a UE may initiate connection on-board, the service request message may be forwarded to the MME that may have a UE's registration and may belong to the pre-configured MME pool. In embodiments, issues may arise later when the connected UE disembarking from the train (e.g. a handover (HO)) as the target eNB may or may not have S1 connectivity to the pre-configured MME-pool, and as the UE may have physically moved far away from the original MME serving the UE. In such embodiments, the following scenarios may be provided and/or considered.

According to one embodiment (e.g. a first scenario), the target eNB may have S1 connectivity to the pre-configured MME-pool and/or X2 connectivity to the RN. In such an embodiment, a RN may initiate a X2 HO. However, the target eNB's TAI may be different from RN's TAI causing the UE to perform a TAU after the X2-HO. As such, during the TAU procedure, the eNB may forward the TAU request to the same MME before the HO (e.g. based on the GUMMEI field in the X2 handover request message), and the MME may add the eNB's TAI to the TAI list in the TAU complete message.

As the UE may move to idle and may initiate another connection in the same TA, the eNB may forward UE's initial NAS message based on the eNB's MME-pool, and the NAS message may be received by a new MME instead of the previously registered MME. This may cause problems if the initial NAS message may not be a TAU request. As such, according to an example embodiment, when the eNB may release the connection due to inactivity that may have been handed over from a RN on a train, the RRC may cause a “loadBalancingTAUrequired” to be included in a RRC release message. This may prompt a UE to perform a TAU to a MME that may normally serve the area.

In another embodiment (e.g. a second scenario), the target eNB may not have S1 connectivity to the pre-configured MME-pool. In such an embodiment, the RN may initiate a S1 HO. A handover messages such as a S1 “handover required” message may identify the globally unique target eNB ID.

For the source MME (e.g. the MME serving the UE on the train) to locate the target MME, the following additional embodiments (e.g. enhancements) may be provided and/or used. The source MME may be configured with (e.g. eNB ID->GUMMEI) mappings for eNBs along the track. Additionally, the source MME may construct a FQDN based on the globally unique target eNB ID to find the target GUMMEI by performing a DNS lookup procedure or method. The RN/DeNB may include in the handover message such as a S1 “handover required” message the TAI of the target eNB. The source MME may then use the current TAI FQDN lookup procedure to find the target GUMMEI. The RN/DeNB may acquire the target eNB TAI based on the X2 ENB CONFIGURATION UPDATE procedure.

In another example embodiment, the RN may replicate the Un Tracking Area Code on Uu by broadcasting on SI tracking area identity (e.g. a trackingAreaCode) that may bederived from that of the Un interface. In such an embodiment, when the RN may move to a different DeNB and the tracking area may be updated, the UEs or rUEs may notice a change in the tracking area in the Uu interface and the IDLE mode UEs may initiate a tracking area update while connected mode UEs may be handled over the Uu.

Although tracking area update procedures may be disclosed using a tracking area identity, the procedures (and/or principles) may further be applied to the PLMN identity. Alternatively, when the PLMN changes for the Un connection, the RN may initiate a hard system resynchronization for the Uu interface (e.g. the UE may use a method that redirects and/or hands over the rUEs to another cell of a different eNB).

X2 and S1 systems, procedures, and/or methods related to Un mobility may further be provided and/or used as described herein. For example, as part of a RN handover procedure, the source DeNB, target DeNB and/or RN MME may transfer RN context information and other information to enable or allow the RN to synchronize to the target DeNB cell. The RN cell configuration and/or the UEs being serviced by the RN (e.g. the RN UEs) may be managed or handled (e.g. properly handled) during the RN mobility procedure including the RN handover. In example embodiments, procedures or methods between or among the source eNB, the target eNB, and/or the MME may be included as operations in the RN handover procedure, for example, in addition to or as modification of one or more procedures included in the RN handover such as a Rel-10 UE handover procedure or other RN handover procedure.

According to an embodiment, RN and RN UE context information and/or configuration may be transferred in such RN mobility procedures and/or RN handover procedures as described herein. For example, as part the handover procedure, the source eNB may prepare the handover by transferring UE context and RAB information to the target eNB over the X2 and/or to the MME over the S1. The target eNB may respond with its own cell information and accepted or rejected E-RAB information as a result of call admission back to the source eNB (e.g. via the MME in the case of an S1 handover). The source eNB may forward the information from the target eNB via the RRC to the UE to initiate the handover.

The same transfer of information or a similar of transfer of information between the source and target DeNBs may be applied for a RN handover preparation. In such an embodiment, the source DeNB may provide RN context and/or RN E-RAB information to the target DeNB. The source DeNB may transfer RN configuration to support RN admission control at the target DeNB for the RN handover. In response, the target DeNB may provide the corresponding new RN configuration to the source DeNB, which then may be passed on to the RN.

According to example embodiments, the RN specific information may include one or more of the following: Un subframe configuration, supported RN type, Un carrier frequency, RN Uu carrier frequency, physical cell ID (PCI), mapping information such as RN RB to UE RB mapping information, RN UE information, and the like.

For the Un subframe configuration that may be included in the RN specific information, the procedure or method and/or exchange of information may include one or more of the following. If available, the source DeNB may provide the target DeNB with the configuration of Un subframes that may be used for a type 1 relay operation on the source DeNB cell (e.g. the Un subframe configuration for the specific RN which may be to be handed over if the source DeNB may be the DeNB for multiple RNs). The target DeNB may also determine whether the same Un subframe configuration that may be used for the new configuration may be allocated. The target DeNB may provide the source DeNB with the Un subframe configuration for the RN to use when operating with the target DeNB, which, for example, may be included in the RRC Handover Command in the RRC RN Reconfiguration message and/or both of which may be included in a transparent container of the X2 Handover Request Acknowledge message. The target DeNB may provide the source DeNB with an indication that no subframe configuration may be used for the RN when communicating with the target DeNB. For example, if no Un subframe configuration may be included in the X2 Handover Request Acknowledge message, its absence may be an indication to the source DeNB and to the RN that a Un subframe configuration may not be used with the target DeNB.

For supported RN type that may be included in the RN specific information, the procedures or methods and/or exchange of information may include the source DeNB providing the target DeNB with an indication of whether the RN supports type 1, type 1a, and/or type 1b operation. This may enable or allow the target DeNB to determine whether the RN may use the Un subframe configuration upon completion of the handover.

Additionally, for Un carrier frequency that may be included in the RN specific information, the procedure or method and/or exchange of information may include the source DeNB providing the target DeNB with a Un carrier frequency that the source DeNB may use or may be using with the RN.

In embodiments, for the RN Uu carrier frequency that may be included in the RN specific information, the procedure or method and/or exchange of exchange of information may include one or more of the following. The source DeNB may provide the target DeNB with a RN Uu carrier frequency that RN may be using while the source DeNB may be its DeNB. The target DeNB may determine the RN Uu carrier frequency to be used after the handover to the target DeNB. The target DeNB may base such a determination on its own carrier frequency that may be used for Un and, for example, the RN Uu carrier frequency when the RN may be operating with the source DeNB. The target DeNB may also determine whether the RN may continue on the same RN Uu carrier and/or the target DeNB may assign a different RN Uu carrier frequency. Additionally, in an embodiment, the target DeNB may provide the source DeNB with the RN Uu carrier frequency for the RN to use when operating with the target DeNB, indicated, for example, in Handover Request Acknowledge message. The target DeNB may also provide the source DeNB with an indication that no subframe configuration may be used for the RN when communicating with the target DeNB, for example, based on the Uu and Un frequencies that may be used when the RN may be operating with the target DeNB. Such an embodiment may be based on Uu and Un frequencies before and after a handover such that the RN operating type may change, for example, it may be adjusted from a type 1 RN to a type 1a RN or a type 1a RN to a type 1 RN and may cause or force the Un subframe configuration to change.

For the physical cell ID (PCI) that may be included in the RN specific information, the procedure or method and/or exchange of exchange of information may include one or more of the following. The source DeNB may provide the target DeNB with the RN PCI. This may allow for the target DeNB to determine whether a PCI collision may occur and re-configure the incoming RN with a different PCI. Additionally, the target DeNB may provide the source DeNB with a new PCI for the RN to use when operating with the target DeNB as its serving DeNB, indicated, for example, in X2 Handover Request Acknowledge message.

Additionally for mapping information such as RN RB to UE RB mapping information that may be included in the RN specific information, the procedure or method and/or exchange of information may include the source DeNB providing the target DeNB with specific DSCP to QCI mapping information that maps the UE RBs to the RN RBs. According to an embodiment, mapping information may enable or allow the target DeNB decision to accept certain or particular RN bearers and for mappings to be changed upon the RN being moved to the target DeNB cell or to retain the same mapping information.

In an example embodiment, for RN UE information that may be included in the RN specific information, the procedure or method and/or exchange of information may include one or more of the following. The source DeNB may provide the target DeNB with information related to the UEs being served by the RN which may include RN UE context information such as information associated with GUMMEI, allocated identities including SLAP IDs, security capability information, subscriber profiles, and the like; RN UE EPS bearer information such as information associated with active UE bearers and their QoS information. Additionally, the target DeNB may use RN UE information, for example, along with RN E-RAB bearer information to derive a snapshot of resource allocation for admission of the incoming RN and its active RN E-RABs.

RN UE context may also be provided to a source DeNB for preparation of a handover. For example, in embodiments, the source DeNB and/or target DeNB as part of a RN handover may not be aware of the context information (e.g. as described herein) of the UEs that may be served by the RN cell. This may be the case, for example, when the DeNB may be acting as a transparent node between the RN and UE MME for UE specific S1 control and data interactions.

For the target DeNB to receive the RN and RN UE contexts for more granular call admission of the RN during RN handover, the source DeNB may be informed of the contexts of UEs attached to the RN cell prior to or during a RN handover procedure. The source DeNB may be provided with the entire or part of the context information of each RN UE and its active EPS bearers from one or more nodes such as source nodes or RNs as described herein.

For example, the RN may provide the UE context information for each UE serviced by the RN cell along with their EPS bearer information for UEs in active and connected mode. Additionally, the RN may provide to the source DeNB, information for RN UEs that may have currently moved to IDLE mode and may have been in IDLE mode for a specific period of time. Historical information associated with EPS bearers and QoS of those bearers that the now IDLE mode UEs may have previously used may also be provided in statistical form to enable or allow further resource planning by the target DeNB at a time of call admission. In embodiments, the RN may provide such information to the DeNB using one or more of the following signaling methods: X2 signaling from the RN, a RN measurement report over Un; a query to the UE MME; a P-GW and/or S-GW of the RN; a query to the OAM; and the like

In an embodiment (e.g. using X2 signaling), the RN may provide DeNB with a list of UE context information of the UEs attached to the RN cell prior to a RN handover. Such information exchange signaling may be periodic with updated UE context information of UEs that may have attached or detached from the RN cell. Additionally, the information exchange may be triggered by new incoming or outgoing UEs.

The RN may also possibly provide DeNB with a list of selected GUMMEIs to service the RN UEs along with or alternatively to the UE context information. The DeNB may then use the MME information to query the MME for the UE context information as described herein below.

In another embodiment, the RN may include as part of its measurement report (e.g. over Un) that may trigger a decision by the source DeNB to perform a RN handover, the RN UE context information for UEs under the RN cell. According to an embodiment, the RN may include the UE context information as part of the measurement report based on an indication to provide UE information in the measurement configuration from the DeNB. The RN may also include attached and detached UE information in a periodic measurement report.

Additionally, upon decision to perform a handover of a RN, a source DeNB (e.g. in order to obtain RN UE context information) may query each UE MME that may be currently serving a UE under the RN cell. The set of UE MMEs may have been provided by the RN previously. Additionally, the DeNB may query each of the MMEs in the MME pool that may be selected for the RN UE. Such a query may take place over the S1 interface. As a response to the query, the DeNB may receive the UE context information or if the MME may not be serving UEs on the RN cell, it may indicate as such.

In an embodiment (e.g. for a P-GW and/or S-GW associated with a RN), along with or separately from RN context information, the DeNB may also retrieve the UE EPS bearer information and the associated QoS information in the Un/Uu EPS bearer mapping information retrieved from the P-GW and/or S-GW of the RN that may map the UE EPS bearers to RN EPS bearers on based on its QoS level. Along with the RN EPS bearer information, the DeNB may have information associated with resource usages for the incoming RN and RN UEs when making call admission decisions.

Furthermore, in an embodiment (e.g. for OAM), the DeNB may query the RN OAM to obtain context information and/or UE EPS bearer information.

Once the source DeNB may have the UE related information, the source DeNB may include such information (e.g. described above) in a X2 Handover Request message to the target DeNB for a X2 handover or in an S1 Handover to the MME for a S1 handover. The source DeNB may use its RNAI to fill the information associated with the RN, or for example, it may request the information from the RN, as part of RNAI transfer transaction.

In an example embodiment, a call admission negotiation between a source and target DeNB may be formed. For example, the source DeNB along with RN and UE context information may also provide (e.g. within the handover preparation message) an indication such as a priority indication to enable or allow influence in the target DeNB call admission process. The indication may provide the target DeNB with a preference to admit RN UEs with reduced EPS bearers or fewer UEs while maintaining the configured level of service for the admitted UEs. The source DeNB may supplement such an indication with an indication of UEs preferred service levels based on their subscribed information. Additionally, the source DeNB may indicate to target DeNB, the UE context information and UE EPS information of suitable UEs to allow or enable priority for their admittance to the target DeNB upon a handover. A target DeNB may respond to a call admission with full and/or partial admission of RN and/or UEs. For example, the target DeNB may indicate to the source DeNB, for example, in response to the message from the source DeNB, in an X2 message (e.g. via the MME if for S1 handover), information the RN may use to synchronize with the target DeNB cell. In an embodiment, the decision for the RN admission may be included. The response from target DeNB may include one or more of the following: admitted E-RAB information (e.g. the E-RABs that may have been admitted by the target DeNB may include the RN E-RABs and/or the UE E-RABs); not admitted E-RAB information (e.g. the E-RABs that may have not been admitted by the target DeNB may include the RN E-RABs and/or the UE E-RABs); a new RN RB to UE RB mapping (e.g. based on the target DeNB admission control, the DSCP to QCI mapping may change and the new mapping information may be indicated to the source DeNB and subsequently to the RN); not admitted UE information (e.g. the target DeNB may not admit certain or particular UEs under the RN as part of the RN handover and these UEs may be identified by their MME UE S1AP ID and/or the UE may not be admitted due to lack of resources or based on QoS such as the aggregated maximum bit rates).

The target DeNB may admit the RN for handover but not all the RN UEs. The target DeNB may transfer the above information as an acknowledgement to prepare for the RN handover. For example, in the case of a X2 handover, the target DeNB may include the above information as part of X2 Handover Request Acknowledge message. The target DeNB may include information in the S1 Handover Request Acknowledge for the S1 handover response back to the MME.

The target DeNB may also decide to not admit the incoming RN for a multitude of reasons, for a lack of resources, and/or may have already previously accepted an exceeding number of the RNs. In such an embodiment, the target DeNB may respond with a failure indication (e.g. with an X2 Handover Preparation Failure). A new cause code such as “Limit on supported RN exceeded” may be included in the message by the target DeNB.

The target DeNB may also indicate to the source DeNB that it may not support RNs, for example, an incoming RN and/or a mobile RN. Such an indication may be in response to a handover request such as an X2 Handover Request. Additionally, such an indication may be, for example, included with the X2 Handover Preparation Failure with a new cause code included indicating the RN may not be supported or an incoming RN or a mobile RN may not be supported.

In an embodiment, based on the information of admitted and/or rejected UEs and E-RABs that the source DeNB may receive as the preparation response from target DeNB, the source DeNB may resend a handover preparation message with slightly modified UE context and RN context information to re-negotiate the outcome of the target DeNB admission control.

Systems and/or methods for handling and/or managing UE E-RABs based on admission and/or rejection of RN E-RABs may also be provided and/or used as described herein. For example, a RN E-RAB may carry the UE E-RAB data that may have been mapped to it via the mapping configuration. The target DeNB may decide, for example, as part of its call admission for an incoming RN, that certain or particular RN E-RABs may not be admitted as part of the RN handover. Based on this decision, the target DeNB may re-map UE E-RABs mapped to a rejected RN E-RAB to an admitted RN E-RAB.

In such an embodiment of remapping, the target DeNB may notify the source DeNB of the RB re-mapping information, for example, as part of a response to a handover request from the source DeNB (for example, as part of the X2 Handover Request Acknowledge). The target DeNB may decide to reject UE E-RABs that have been mapped to a rejected RN E-RAB. The target DeNB may list each of the rejected RNs and, for example, UE E-RABs (e.g. explicitly). In example embodiments, the source DeNB and the RN may implicitly infer that a rejected RN E-RAB may designate or indicate that the mapped UE E-RABs may not have been admitted.

Additionally, for UE E-RABs that may have been rejected, the source DeNB or RN may initiate a procedure to release the rejected UE E-RABs of the affected RN UEs. If a released UE E-RAB, or group of UE E-RABs belonging to a RN UE, may be a remaining active E-RAB, or group of E-RABs, for the RN UE, the RN may move the UE to the IDLE mode (e.g. via an RRC Connection Release procedure). Alternatively, the RN may attempt to handover the RN UE to a suitable neighbor cell where the UE E-RAB(s) may continue to be supported. According to an example embodiment, the RN may choose a target eNB for the UE that may be different from the target DeNB that has been chosen for the RN handover. For example, the RN and target DeNB may apply the re-mapping of the RN to UE E-RABs upon completion of a handover to the target DeNB cell. The target DeNB may also reject the E-RABs of the RN UEs whose MMEs may no longer be accessible from the target DeNB.

Systems and/or methods for performing RN admission and/or E-RAB modification may be provided and/or used as described herein. For example, for call admission process of the target DeNB during a RN handover, the target DeNB may determine or decide to modify the RN and RN UE E-RAB QoS parameters (e.g. rather than wholly admit or reject a RN E-RAB based on resources availability and other factors) such that the target DeNB may admit the RN E-RAB with reduced parameters rather than reject it. Rejecting the RN E-RAB may affect the RN UE E-RABs that may be mapped to it, and, in an embodiment, to facilitate the service quality of RN UEs, such a E-RAB rejection may be avoided as much as possible during RN handovers.

For example, during RN handover, the RN may be configured with an E-RAB with a QoS profile of a GBR (e.g. a guaranteed bit rate) of 10 Mpbs. Such a RN E-RAB may be mapped to 10 UEs each with an UE E-RAB with a GBR of 1 Mbps. Additionally, the target DeNB, at the time of handover, may receive the RN E-RAB information from the source DeNB and may determine that the target DeNB may have resources available to support an RN E-RAB of 8 Mbps and, as such, may be unable to admit the RN with the E-RAB given its current GBR profile. In such an embodiment, using current admission procedures (e.g. a Rel-10 admission procedure), the target DeNB may reject the RN E-RAB during the RN handover. Such a rejection may impact each of the RN UE E-RABs that may map to the RN E-RAB and, as such, the RN UE E-RABs may either be released or re-mapped to an alternative RN E-RAB if it may exist.

Alternatively using the GBR modification during a RN handover, the target DeNB may accept the RN E-RAB with the reduced GBR parameter and may allocate a reduced 8 Mpbs to the RN E-RAB. The reduction in RN E-RAB GBR may then reduce the allocation of RN UE E-RABs such that each UE E-RAB GBR may be reduced to 0.8 Mbps or 2 UE E-RABs may be released while 8 UE E-RABs may be unchanged. As such, the impact to the RN E-RAB and RN UE E-RABs may be reduced with a E-RAB modification during admission as described herein compared to the standard admission and/or rejection procedures described above.

The following embodiments may be provided and/or used to enable and/or allow a target DeNB to modify RN E-RABs during RN handover and/or to modify the RN UE E-RABs in reaction to the modified RN E-RABs.

For example, in one embodiment, as part of the RN handover procedure, the following may be performed for a GBR modification procedure. In the handover preparation phase, a target DeNB may receive the configured RN E-RAB QoS information (e.g. ARP, GBR, QCI, and the like) from the source DeNB in, for example, the X2 Handover Request message. As an output of a RN call admission, the target DeNB may modify one or more of the E-RAB QoS parameter to accommodate the admission of certain or particular E-RABs.

According to an embodiment, to indicate the resulting modification of certain or particular RN E-RABs, the target DeNB may respond to the handover preparation by indicating the modified QoS parameter of the E-RAB in an admitted and/or not admitted E-RAB list (e.g. a list of the admitted and/or not admitted E-RABs) and/or a list of modified E-RABs to a source DeNB. According to an example embodiment, the list of modified E-RABs may be in a separate list or in a list with the admitted and/or not admitted E-RAB lists. Additionally, the admitted E-RAB list may include QoS information for E-RABs that may have been admitted with modified QoS parameters by the target DeNB. Table 1 below may illustrate an example X2 Handover Request Acknowledge message with the additional information elements for modified QoS parameters.

TABLE 1

| | | | IE type/ | Semantics |
|---|---|---|---|---|
| IE/Group Name | Presence | Range | reference | description |
| Message Type | M | | | |
| Old eNB UE X2AP ID | M | | eNB UE X2AP | May be allocated at |
| | | | ID | the source eNB |
| New eNB UE X2AP ID | M | | eNB UE X2AP | May be allocated at |
| | | | ID | the target eNB |
| E-RABs Admitted List | | 1 | | |
| E-RABs Admitted | | 1 . . . <maxnoof | | |
| Item | | Bearers> | | |
| E-RAB ID | M | | | |
| UL GTP Tunnel | O | | GTP Tunnel | May identify the X2 |
| Endpoint | | | Endpoint | transport bearer used |
| | | | | for forwarding of UL |
| | | | | PDUs |
| DL GTP Tunnel | O | | GTP Tunnel | May identify the X2 |
| Endpoint | | | Endpoint | transport bearer. used |
| | | | | for forwarding of DL |
| | | | | PDUs |
| E-RABs Modified List | | 1 | | |
| E-RABs Modified | | 1 . . . <maxnoof | | |
| Item | | Bearers> | | |
| E-RAB ID | M | | | |
| UL GTP Tunnel | O | | GTP Tunnel | May identify the X2 |
| Endpoint | | | Endpoint | transport bearer used |
| | | | | for forwarding of UL |
| | | | | PDUs |
| DL GTP Tunnel | O | | GTP Tunnel | May identify the X2 |
| Endpoint | | | Endpoint | transport bearer that |
| | | | | may be used for |
| | | | | forwarding of DL |
| | | | | PDUs |
| E-RAB Level QoS | M | | | May include QoS |
| Parameters | | | | parameters |
| E-RABs Not Admitted List | O | | E-RAB List | May include a value |
| | | | | for E-RAB ID shall |
| | | | | only be present once |
| | | | | in E-RABs Admitted |
| | | | | List IE + in E-RABs |
| | | | | Not Admitted List IE |
| Target eNB To Source eNB | M | | OCTET | May include the RRC |
| Transparent Container | | | STRING | E-UTRA Handover |
| | | | | Command message |
| Criticality Diagnostics | O | | | |

In an example embodiment, the RRC command for a handover for the RN may be constructed by the target DeNB. The additional modification of QoS configuration for RN RBs based on the modified E-RABs may be included in the RRC message by the target DeNB. Upon synchronizing with the target DeNB cell, the RN may then be configured with the modified bearer configuration.

As part of the handover completion phase, the target DeNB may send the PATH SWITCH message to a RN MME to indicate the switching of the data path from the source to target DeNB. At the same time, the message may be used to indicate the E-RABs that may have been accepted, and the previously E-RABs that may have been omitted from that list may be considered or indicated as implicitly released by the target DeNB and the RN MME may also release the E-RAB resources in the EPC.

According to an example embodiment, a PATH SWITCH may also be used by the target DeNB to indicate the modification of RN E-RABs during handover (e.g. as a result of or in response to a call admission control of the RN). In response to the PATH SWITCH command, the RN MME may initiate a NAS E-RAB modification procedure to confirm the E-RAB modification that may be performed or provided by the target DeNB as acceptable, or possibly, the modification procedure may be used to further modify the RN E-RABs according to its subscriber information as maintained by the MME. The procedure may also enable or allow RN E-RABs QoS changes to be notified to the RN at the NAS layer along with the RRC/RB level as indicated in or by the handover message.

The target DeNB may initiate the RN E-RAB modification procedure based on the modified E-RAB QoS parameters during a call admission according to an embodiment. The RN S-GW and P-GW functionality for such procedure may be performed or provided internally if, for example, the P-GW/S-GW of the RN may be co-located with the DeNB. In such an embodiment, the target DeNB may also include the NAS message for the E-RAB modification within the RRC reconfiguration message for the RN for handover command. The corresponding response NAS message from the RN may be included in the RRC reconfiguration complete or possibly be sent as part of the NAS direct transfer to the target DeNB.

Alternatively, in an embodiment, if the RN P-GW/S-GW may be part of the EPC, the E-RAB modification (or a decision to perform E-RAB modification) may be provided from the RN P-GW/S-GW, for example, upon receiving the PATH SWITCH from the RN MME during a RN handover procedure.

Upon completion of the RN handover procedure, the RN E-RAB and RBs may be modified according to the output of call admission of the RN by the target DeNB. As such, the UE E-RABs that may have been previously mapped to the modified RN E-RAB may also be modified as described herein.

For example, as described above, as part of the RN handover, the target DeNB may also receive the RN UE context information along with UE E-RAB QoS information. In such an embodiment, the target DeNB may determine or decide to modify each individual RN UE E-RAB according to the modified QoS parameters of the mapping RN E-RAB.

The target DeNB may notify the UE MMEs of the changes to UE E-RAB. The indication of the UE E-RAB change may be provided for each UE individually or may be provided for a group of UEs that may be served by the same MME. The target DeNB may then send an indication of a UE E-RAB reconfiguration for a group of UEs to each of the MMEs serving a RN UE.

The indication from the target DeNB may trigger the UE MMEs to perform a E-RAB modification procedure (e.g. as specified in Rel-10) to modify the E-RAB of the UE according to the QoS parameters set by the target DeNB and/or a differently modified set of QoS parameters based on the UE subscription information available to the UE MME. The indication from the target DeNB may also be forwarded by the UE MME to the UE P-GW/S-GW.

In an embodiment, when the target DeNB may have knowledge of the RN context information and not the context information of the UEs that may be served by the RN, the RN may indicate to the UE MMEs a E-RAB modification of specific UE E-RABs that may be mapped to the modified RN E-RAB. Such an indication may be sent over S1 and/or may include QoS parameters (e.g. new QoS parameters) for the UE E-RAB to indicate to the MME the usable or allowable bandwidth associated with the re-configured RN E-RAB after a RN handover. In an embodiment, the decision, however, may be taken by the MME in terms of the E-RAB parameters (e.g. the new E-RAB parameters) for the UE based on information from the RN. Since the RN may not use the PATH SWITCH in such an embodiment, a message (e.g. a new message) may be defined to convey such information to the UE MMEs. In embodiments, this may be performed or provided on a per UE basis or in a group manner in which the information of multiple UEs may be sent in a single message to each MME that may serve one or more UEs under the RN. Additionally, in embodiments, this procedure may be initiated by the RN upon completion of the RN handover procedure.

In response, UE MME may initiate an E-RAB modification procedure per Rel-10 procedures to modify the UE E-RABs according to indications from the RN.

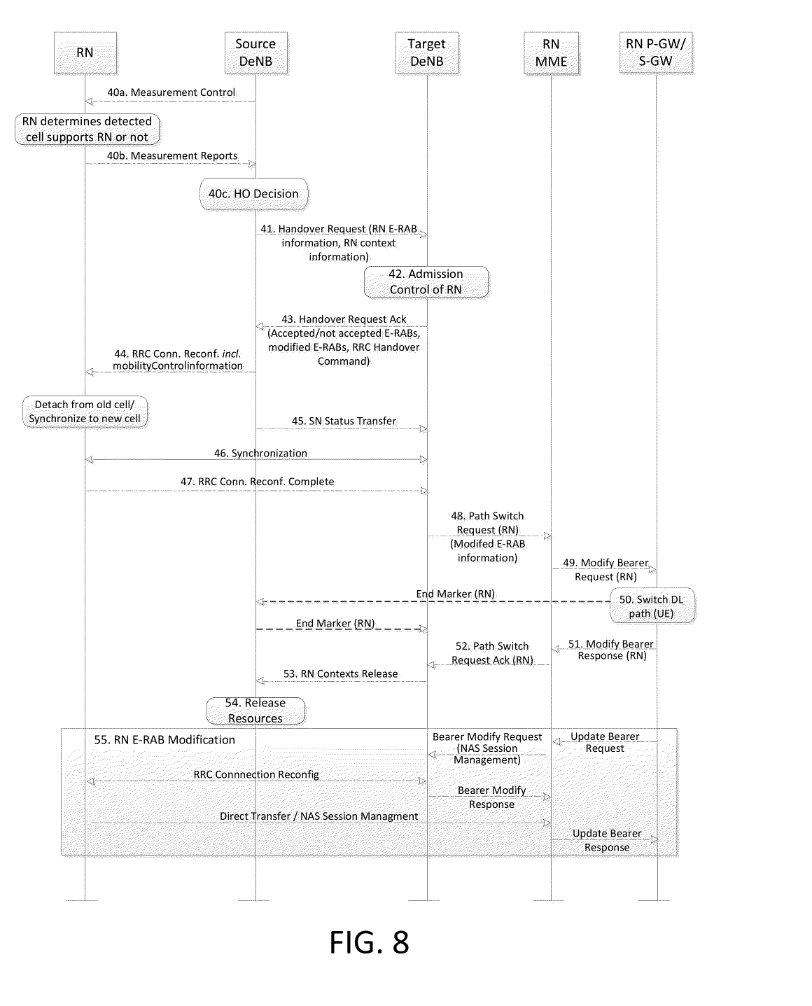

FIG. 8 illustrates an example embodiment of a sequence diagram of an example RN handover procedure with a RN E-RAB modification that may be determined or decided during a RN call admission control at target DeNB and the subsequent signaling that may be provided between the UE RN, RN, target DeNB, and/or the core network to complete the bearer modification of the RN and RN UEs. According to an embodiment, a handover decision may be made, as described herein, using measurements (e.g. at 40a-c).

As shown in FIG. 8, at 41, a handover request may be provided from a source DeNB to a target DeNB that may include RN context and E-RAB information. Additionally, at 42, the target DeNB may perform admission control of the RN based on information received. In one embodiment, rather than reject the RN E-RAB, the target DeNB may determine or decide to modify a GBR bearer of a RN E-RAB.

The target DeNB may respond to the source DeNB with list of admitted and not admitted RN E-RABs at 43. Additionally, at 43, the admitted and modified E-RAB information may also be provided. According to one embodiment, the RRC handover command or handover request acknowledgement that may also be provided and sent by the target DeNB may include the modified RB information for the RN as described herein. A handover may then be performed (e.g. a Rel-10) as indicated in FIG. 8.

As described herein, a RRC connection reconfiguration such as an RRC Conn. Reconfig. Message including mobilityControlinformation may be provided from the source DeNB to the RN (e.g. at 44), a detachment from an old cell and/or a synchronization to a new cell may be provided including synchronization to the target DeNB (e.g. at 46), a RRC connection reconfiguration complete such as an RRC Conn. Reconfig. Complete message may be provided from the RN to the target DeNB (e.g. at 47).

At 48, the target DeNB may indicate a PATH SWITCH to a RN MME such that a data path may be switched (e.g. at 50) from the source to target DeNB which may result in a modify bearer response message being sent (e.g. at 51) and/or a path switch request acknowledgment being sent (e.g. at 52). In embodiments, the target DeNB may indicate the modification of RN E-RAB bearers to the MME. The information may then be transferred to RN P-GW (e.g. at 49).

The RN handover procedure may be completed (e.g. a RN contexts release message may be sent (e.g. at 53) and/or resources may be released (e.g. at 54) and a RN P-GW initiated E-RAB modification procedure may be performed at 55. For example, at 5, based on the PATH SWITCH information, the RN P-GW may initiate the RN E-RAB modification procedure. The E-RAB QoS configuration for the RN may or may not be different from the configuration that may have been provided to the RN during handover procedure.

Based on the outcome of the RN E-RAB modification, the target DeNB may modify the mapped RN UE E-RAB accordingly. To perform such a modification described herein, the target DeNB may provide or send a message to UE MME that may then be forwarded to the UE P-GW/S-GW requesting a bearer modification based on a requested QoS set of parameters. The P-GW may then perform the RAB modification procedure (e.g. similar to Rel-10 procedures). Additionally, in an embodiment, the RN and/or target DeNB may accommodate the mapped RN UE E-RAB to the modified RN E-RAB by releasing certain UE E-RABs.

Systems and/or methods for handling or managing RN UE context maintenance may also be provided and/or used as described herein. For example (e.g. in Rel-10), a MME selection for an attaching RN and/or for an UE attaching to the RN may be performed by the DeNB. For load balancing, the DeNB may select different MMEs for each incoming RN and RN UEs.

In an example embodiment, mobile relays, MRNs, and/or RNs may perform UE MME selection and network node selection function for any incoming UEs to the RN cell. In such an embodiment, the S1 interface and S1-AP interaction may be performed directly between the mobile relay and the UE MME. Additionally, the S1 interface relationship between RN and all MMEs in the accessible MME pools may be performed at mobile relay startup. In an embodiment, an OAM and/or a DeNB may provide the list of MMEs to which the RN may establish an S1 interface. In such an embodiment, the DeNB may be transparent to the interactions between the RN and MME for UE specific S1 signaling.

Additionally, in the case of the RN handover procedure, the RN moving to another DeNB may cause the MMEs of certain or particular RN UEs to become inaccessible as the accessibility of MMEs from the RN may be dependent on the connectivity from the target DeNB to that MME. This issue may further be complicated by RN handover over X2 where the MME is not involved with the control plane signaling. When the RN may no longer be able to access the UE MME that may serve one or more of the RN UEs, a S1 interface breakage may occur or may have occurred.

As such, in an embodiment, detection of a S1 interface breakage may also be provided and/or used. For example, in the instances that a DeNB may select the UE MME for an incoming RN UE, upon a RN handover, the target DeNB may be aware of the S1 interface relationship it may have with accessible MMEs as well as the GUMMEIs of incoming RN UEs. As such, the DeNB may independently detect whether a RN UE may have lost its connectivity to the UE MME.

For the embodiment where mobile relay selects MME for incoming RN UEs, breakages in S1 interface upon RN handover may not be readily detected. Due to the transparency of a DeNB, the target DeNB may be unaware of MMEs to which the RN UEs may be connected, and the RN may be unaware of the accessibility of MME and MME pools through the target DeNB upon a RN handover. The following may be example methods that a RN may use to detect UE MMEs that may no longer be accessible.

In one embodiment, the target DeNB may be aware of the RN UE context and the MME to which it may be connected. For example, the target DeNB may indicate to the RN a list of UEs whose MME connection may have been lost. The target DeNB may further indicate to the RN a list of MMEs and/or MME pools to which access may be possible. The RN may then use such information to detect whether UE MMEs may no longer be accessible. In an embodiment, the RN may receive such information through the source DeNB handover command message and/or from the target DeNB itself upon RN handover completion.

Additionally, a RN may detect lost accessibility to a particular MME using information associated with the neighboring eNB, including the target DeNB and the neighbor's MME accessibility information. The RN may derive or detect such accessibility and/or information by being informed with the GU ID information that may be included in the X2 eNB Configuration Update information exchange between the RN and DeNBs.

In another embodiment, a RN may be informed by an OAM the MMEs that may no longer be accessible through the target DeNB.

Furthermore, the disconnect of the S1 interface between RN and UE MME may be handled upon detection of S1 interface failure during the first S1-AP interaction between the RN and the no longer accessible MME.

The following example methods or procedures including a network triggered TAU, an intra-cell handover over S1, a RRC connection release, a MME relocation, a network configuration, and the like may enable or allow the MMEs of the RN UEs to be changed as part of or upon completion of the RN handover procedure.

In an embodiment, a network commanded Tracking Area Update (TAU) may be used to change or select a MME. For example, a RN, based on signaling from the DeNB, may signal or indicate to the UE to perform a tracking area update procedure that may result in the selection of another accessible MME for the UE. In such an embodiment, the RN may receive a S1 UE Context Release with the cause “Load Balancing TAU Required” from the DeNB. The RN may then signal an RRC message, such as RRC Connection Release message with a cause code of “load re-balancing TAU required,” to trigger the RN UE to perform the TAU. Additionally, the “idleModeMobilityControlInfo” IE may be included in the RRC message to enable or allow the RN UE to reselect the RN cell after or upon establishing an RRC connection for the TAU. As part of the procedure, the RN UE may be notified of the new GUMMEI and/or security context information. Additionally, transfer of the UE context between old and new MME may be initiated by the newly selected MME.

An intra-cell handover (e.g. over S1) may also be used to change or select a MME. For example, the RN may command an intra-cell handover to the RN UE. In such an embodiment, the handover signaling between the RN and the network may take place over the S1 interface. Additionally, the RN UE may remain on the RN cell, and the DeNB (e.g. while on the network side) may select an appropriate MME for the RN UE. The selected MME may communicate with the original MME serving the RN UE to transfer the UE context to the newly selected MME. As part of the intra-cell handover, the RN UE may be notified of the GUMMEI change and security context changes with the new MME.

Additionally, a RRC connection release may be used to change or select a MME. For example, upon detection of a MME disconnect to a particular UE, a RN may release the RRC connection of the RN UE such that the RN may re-establish a connection with another MME. In an embodiment, the RN may provide a UE with re-direction information such that the released UE may immediately try and re-connect to the same RN cell.

According to another embodiment, a MME relocation may be used to change or select a MME. For example, without a UE mobility procedure, a RN may trigger a procedure to relocate the MME of the UE. Once the S1-MME interface for the UE may have been found to be broken, the RN may signal to a newly selected UE MME, for example, based on the MME selection function. Such an indication may be sent, for example, via a S1-AP with a S1 “Relocation Required” message. The RN may send such a message with information about the UE or multiple UEs and its context information and the RN may also include the old MME ID along with the reason for relocation in, for example, a “S1 connection disconnect.” The newly selected MME may, in response to this indication, attempt to contact the old UE MME to retrieve the context information of the UE(s), if the RN may not have already provided the information. If the context information of the UE may be sufficiently collected, the MME may respond to the RN via a S1-AP. Otherwise, if MME may be unable to locate the context information of the incoming UEs or may otherwise be unable to accept the incoming UEs for other reasons such as load balancing, the MME may then respond with a negative response to the RN. This procedure between RN and MME may take place prior to the RN moving to the target DeNB. The RN may request a MME relocation with the original UE MME and the UE MME may select the appropriate replacement UE MME through the target DeNB and may respond with the new MME information to the RN. The UE context information may then be transferred between the old and new MME. In response to an accept to a MME relocation, a RN may then send an RRC message to the UEs notifying the MME change along with the new serving GUMMEI and/or security context information, for example. The UE may also perform a Security Mode Command to re-establish and synchronize the security procedure with the new UE MME at the NAS level. In an embodiment, in response to a rejection to MME re-location, the RN may re-select and re-attempt the relocation to another MME or may perform a RRC connection release with the UEs (e.g. as described herein) upon failing a pre-defined number of relocation attempts with a new UE MME.

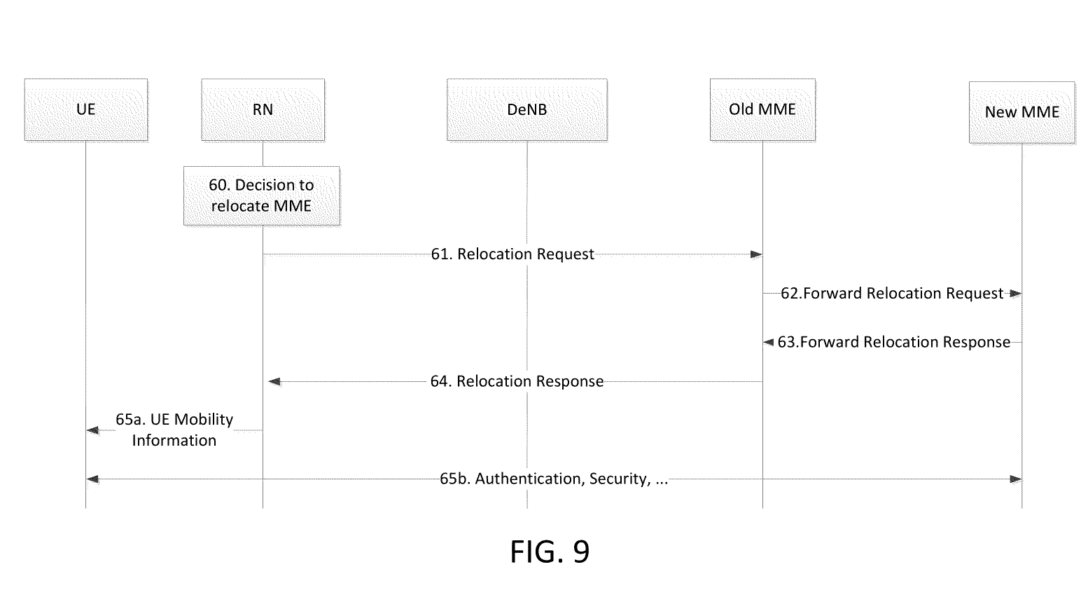

An embodiment example sequence diagram of a MME relocation method or procedure may be shown in FIG. 9. As shown in FIG. 9, at 60, a determination or decision to relocate a MME may be made. When the determination or indication may indicate that the MME may be relocated, a relocation request may be sent from the RN and may be received by the prior or old MME at 61. The prior or old MME may then provide or send (e.g. forward) the relocation request to the new MME. At 63, a relocation response may then be provided or sent (e.g. forwarded) from the new MME to the old MME. The old MME may then further provide the relocation response, a portion of the relocation response, or information associated with the relocation response to the RN at 64. Mobility information such as UE mobility information may be provided from the RN to the UE, for example, at 65a and authentication and/or security may be established and/or performed between the UE and new MME at 65b.

In embodiments, a network configuration may be used to change or select a MME. For example, the MME selection may be accomplished (e.g. performed) by the DeNB such that the MME serving the RN and the RN UEs may be the same. Rather than the MME selection being based on load balancing, the DeNB may select the MME based on mobility of one or both of the RN and/or the RN UEs attached to it to ensure that the UE MME may remain accessible upon the RN mobility and/or change of DeNB. For example, in a mobile RN in a high speed train scenario, a single MME may serve both the RN and incoming RN UEs and may be shared by each or a group of DeNBs that may be configured along the RN mobility path (e.g. along the train tracks).

A reachability associated with a UE for MMEs upon a RN handover may further be provided and/or used. For example, upon completion of the RN handover and/or if the RN may have changed its E-CGI to reflect the target DeNB's eNB ID, the MMEs serving the RN UEs may be notified of the cell ID change of RN cell such that a reachability of the RN UEs may be maintained. In a handover such as a UE handover (e.g. a Rel-10 handover), a UE MME may be notified of the change in a UE serving cell by a S1 PATH SWITCH. In case of RN handover, the change in cell by the RN UE may not be indicated to UE MMEs since they may not involved with the RN handover procedure itself. As such, the RN or target DeNB may notify the UE MME of the E-CGI change of the UE serving RN cell. In an embodiment, the RN or target DeNB may indicate this with a S1 Path Switch Request (e.g. but indicate that this may be for E-CGI change and not for an actual path change). It may also be possible for a new S1-AP message to be defined to indicate the E-CGI change.

Systems and/or methods for changing E-CGI and/or exchanging neighbor information may further be provided and/or used. For example, for relays such as RNs or mobile relays (e.g. including Rel-10 relays or RNs), the RN E-CGI may be assigned by a RN OAM. The E-CGI may include the eNB ID of the DeNB to which it may have attached along with an 8 bit identifier which may be unique amongst the cells served by the DeNB. In addressing the RN via X2 interface, this may enable or allow the RN to appear as a served cell of the DeNB to neighboring eNBs.

Additionally, for relays such as mobile relays or RNs (e.g. including Rel-10 relays or RNs), with each RN handover procedure to a different DeNB, the E-CGI of the mobile RN may be re-assigned due to the change in the eNB ID of the new DeNB. The 8-bit portion of the E-CGI may no longer be unique, and, as such, may also be changed. The E-CGI of the mobile RN may be re-assigned by the DeNB rather than the RN-OAM, since the DeNB may also be aware of the other cells, both RN and non-RN, that it may be serving.

For an eNB configuration that may be shared amongst neighboring eNBs, upon each RN handover, the source DeNB may effectively lose a served cell from its configuration and the target DeNB may gain a served cell. Such a change of served cells in target and source DeNBs may be indicated to one or more neighboring cells such that neighbor relationships may be updated.

In an embodiment, once the RN procedure to the target DeNB cell may have been completed, the target DeNB may notify one or more of its neighbors. The indication may include information of an RN handover with both the old and new E-CGI of the RN. The set of RN E-CGIs (e.g. old and/or new) may indicate to a neighbor eNB to update its neighbor relationship, accordingly.

Additionally, the target DeNB may use the X2 eNB Configuration Update message to indicate a change to served cell information by adding the information of the RN that may have moved to the target cell, and, for example, include in the message, in addition to or in lieu of the new E-CGI of the RN, the old E-CGI of the RN to indicate original RN serving DeNB cell. In such an embodiment, a handover indication and change of E-CGI may be performed and/or accomplished in a single message that may be used for neighbors common to both the source and target DeNBs.

In example embodiments, the source and target DeNBs may also perform one or more of the following. The target DeNB may indicate the newly added served RN cell to one or more neighbor cells. The source DeNB, for example, upon or after receiving a notification from the target DeNB of a successful RN handover, may indicate to one or more neighbor cells that the served RN cell may have moved and may be removed from the served cell list. The source and/or the target DeNBs may use the X2 eNB Configuration Update to notify one or more neighbors of the added or removed RN. Such an embodiment or method may be used when the two DeNBs may not share a common (e.g. the same) neighbor eNB.

In another example embodiment or method, the RN may be allocated an E-CGI, for example, at initial startup by the RN OAM. The E-CGI may be fixed and independent of the serving DeNB eNB ID and may not change upon the RN handover or cell re-selection. In such an embodiment, the serving DeNB may indicate to its neighbor eNBs that it may be currently serving a RN with the specific E-CGI, for example, rather than indicating the RN as a served cell.

The fixed E-CGI may be indicated to the neighbor cells along with the DeNB eNB ID based E-CGI that may change upon or after the RN mobility procedure such that the E-CGIs may be be mapped.

The neighboring cells may address the RN via the serving DeNB by an indication such as an explicit indication rather than using the DeNB eNB ID to locate the RN. For example, the serving DeNB may use an X2 eNB Configuration Update message to indicate that an RN may be served by such an DeNB. The RN information including, for example, E-CGI, PCI, EUARFCN, and the like may be included as a separate RN specific information element rather than as part of the served cell list IE.

Systems and/or methods for bundling a data plane control during a handover including a RN handover may be provided and/or used. For example, to enable a lossless data transfer during a RN handover procedure, the X2 data plane path may be established between the target DeNB and the source DeNB, for example, for each RN E-RAB that may have been established and accepted by the target DeNB.

In such an embodiment, one or more of the following may be performed. The source DeNB may forward to the target DeNB, for example, on the X2 data paths, RN data that may not have been transmitted to the RN by the source DeNB or that may not have been acknowledged by the RN. The source DeNB may forward to the target DeNB incoming (DL) UE data that the source DeNB may have and may not have been multiplexed into RN data and/or transmitted to the RN. Additionally, in an embodiment, the mapping of the UE data for forwarding to the target DeNB, for example, on the allocated X2 data paths, may follow the DSCP-to-QCI mapping for the UE RB to RN RB bearers as configured by the target DeNB. The source DeNB may multiplex incoming (DL) UE data and may process it into RN data prior to forwarding the data to the target DeNB. In such an embodiment, the UE data may be multiplexed into RN data according to the DSCP-to-QCI mapping as configured by the target DeNB.

Data forwarding of one or both the RN E-RAB data and the UE E-RAB data for the RN or the UE E-RABs that may have not been accepted by the target DeNB as part of admission control may be discarded by the source DeNB and may not be subject to data forwarding.

According to an example embodiment, once the RN has re-synchronized with the target DeNB, the target DeNB may notify the MME or MMEs to complete the RN handover procedure by switching the data path of the P-GW to the target DeNB from the source DeNB. The target DeNB may request a path switch one or more of the MMEs that may serve the RN UEs. Each path switch request, for example, the S1 Path Switch Request message, may be provided for each individual RN UE. Additionally, a single path switch request may be sent from the target DeNB to each MME that may be serving a RN UE. For example, a single path switch request may be sent to the RN MME for a path switch for a group or each of the RN UEs.

In an embodiment, for example, with a mobile RN or RN on a high speed train, the serving DeNB may select the same S-GW/P-GW for each of UEs that may be served by the RN. The target DeNB may then request a path switch to the same MME and then on to the same P-GW, for example, for each of the RN UEs in a single path switch request.

RAN sharing (e.g. for relays or RNs such as mobile relays or RNs) may also be provided and/or used as described herein. For example, according to an embodiment, mobile relays or relay nodes (MRNs or RNs) may support RAN sharing using one or more of the following: mobile relay configurations for RAN sharing (e.g. information associated with retrieval of information by the RN in terms of RAN sharing); mobile relay attach and authentication procedures (e.g. enhancements to RN attach or attachment procedures such that the RN may support operator to multiple PLMNs configurations); use of a handover procedure (e.g. a fake or simulated handover procedure) for multi-operator authentication of a RN; mobile relay mobility procedures for RAN sharing (e.g. procedures where a RN may handle changes to RAN sharing configurations due to mobility of the MRN or RN); and multiple Un interface support for multiple DenBs (e.g. supporting RAN sharing where a mobile relay (a MRN or RN) may be shared, but the DeNB that the RN may be attached to may not support the same PLMNs. To provide RAN sharing (e.g. for relays or RNs such as mobile relays or RNs), a MRN RAN sharing configuration may be provided and/or used as described herein. For example, a RN may receive a list of PLMNs that may be supported in RAN sharing and may broadcast such a list in system information (SI) associated with the RN such that an RN cell associated with the RN may reflect on or use the RAN sharing configuration.

The RN or relay may be able to determine or generate such information (e.g. the list of PLMNs and system information) as described herein (e.g. using at least one of the following). For example, in one embodiment, after powering up and, for example, before a start up procedure that may be executed by the RN, the RN may read a set of USIMs that may have been loaded in the RN and may be provided with the list of PLMNs that may be part of the RAN sharing associated with the RN. According to an example embodiment, the USIM (or set of USIMs) may provide an indication of operators/PLMNs for which RAN sharing may be supported on or by the RN. Additionally, before executing the start up procedure (e.g. during a phase I attach), the RN may know at least the possible list of operators that may be shared by the RN during the RN operation.

Additionally, in an embodiment, during the startup procedure (e.g. during phase I or phase II of the startup procedure), the RN may be provided with a list of operators/PLMNs for which the RN may be shared. For example, during a phase I RN (as UE) attach operation, the OAM may provide the RN may be provided with a list of possible PLMN IDs that may share the RN for each DeNB cell associated with a DeNB and list thereof. Alternatively, the RN may be provided with a list of PLMN operators, independent of a DeNB cell to which RN may subsequently attach. In another example embodiment, during a phase II RN (as RN) attach, the OAM may provide the RN with a list of PLMN IDs that may be broadcast via the system information by OAM. The list of PLMN IDs in such an embodiment may be based on the DeNB cell to which RN may be attaching and the operators that may share the DeNB.

According to further embodiments, during a phase II attach, the RN may derive the RAN sharing configuration based on reading the broadcast information and list of PLMN IDs of the DeNB cell to which the RN may be attaching. According to an embodiment, the PLMN ID list of the DeNB cell may, in part, indicate to the RN possible operators that may share or be shared with the RN when the RN starts its RN operation.

In an embodiment, the RAN sharing configuration may also be a part of the RNAI and the RN may use the information (e.g. as part of the RNAI) to determine which operators to select for attach.

Additionally, the RN or relay may further scan for DeNB cells, for example, in RNAI or DeNB list, may read the system information of the DeNB cells, and may determine possible PLMN IDs that may be shared with the RN.

According to embodiments, the RN may use any of the PLMN and RAN sharing configuration information in combination to determine which PLMN IDs may be valid for RAN sharing of the RN. For example, a PLMN ID list that may be provided by to the RN by the OAM may be a subset of a PLMN ID list in the system broadcast information of the DeNB cell. In such an embodiment, the RN may choose to incorporate the PLMN list of the DeNB SIB over the PLMN list provided by the OAM (e.g. when the RN may use established S1 connections of the DeNB to the MMEs associated with the various operator/PLMNs). Additionally, the RN may use the subset OAM PLMN list over that of the DeNB SIB.

As described herein, the PLMN list may provide the RN with possible PLMNs for RAN sharing. In one embodiment, the RN may then authenticate itself with the multiple PLMNs in order for RAN sharing to be used as described here.

For example, an RN Attach and Authentication for RAN Sharing may be provided and/or used (e.g. performed). For an attach procedure (e.g. a RN start up phase II in e.g. Rel-10), a RN may establish an RRC connection with a DeNB and the RN may be authenticated for RN operation by the EPC (e.g. by HSS). The RN attach procedure may be used for an RN to attach to a single operator/PLMN and may follow a UE attach procedure

Additionally, for RAN sharing, the RN may provide or perform authentication to multiple operators/PLMNs that may be included by the PLMN list to ensure that the RN may be configured for RN operation for each individual operator. According to example embodiments, the RN may execute one or more of the following (e.g. in addition to the existing RN attach procedure) to authenticate the RN with multiple operators.

In an embodiment, to authenticate the RN for a single RRC connection to a DeNB, a multiple NAS attach may be provided and/or used (e.g. or performed). For example, as part of a RN multiple attach procedure, a RN may initiate a single RRC connection establishment towards or with a DeNB. Once the RRC connection may be established, the RN may concatenate the NAS ATTACH message towards the first operator on RRC Connection Setup Complete (e.g. following Rel-10 Attach procedures).

In such an embodiment, a multiple NAS attach may be piggybacked on separate RRC messages. For example, for a subsequent attach to the other operators on the PLMN list, the RN may concatenate the NAS ATTACH to a RRC UL Information Transfer message and/or a RRC Connection Reconfiguration Complete message. Based on the contents of second and subsequent NAS messages, the DeNB may select or determine the MME corresponding to the correct operator and may follow NAS attach procedures. Additionally, based on the outcome of the authentication, the DeNB may then respond to the RN with the appropriate outcome. Such a procedure or signaling may be used for a RN when a PLMN ID list for RAN sharing may be provided to RN by reading the DeNB system information and/or by a OAM in the phase II of a RN attach as described above.

Additionally, in such an embodiment, a multiple NAS attach may be piggybacked on a single RRC message. For example, a RN may concatenate two or more instances of a NAS ATTACH, for example, for each operator and may piggyback that message onto a RRC Connection Setup Complete message. In such a case, the DeNB, for example, after receiving the multiple NAS ATTACH messages, may send the S1 messages to the corresponding MMEs (e.g. serially or in parallel for greater time efficiency). The RN may use such a signaling when the PLMN ID list for RAN sharing may be known prior to a RN attach (e.g. Phase II) of the start up procedure.

In both signaling instances or procedures (e.g. multiple NAS attach using a single RRC message or separate RRC messages) described above, the RN may use the NAS ATTACH to the first PLMN as the “primary” PLMN where the selected MME of that PLMN may then become the RN serving MME for RN context and configuration management. The RN may follow the normal RN attach procedure with the first NAS ATTACH. All subsequent NAS ATTACH(s), whether in a separate or single RRC message may be treated as a “secondary” NAS ATTACH procedures where the RN may use a subset of the ATTACH procedure(s) to identify to the DeNB a PLMN that may used to authenticate a valid RN for operation with that particular PLMN. For example, the partial ATTACH may not include the establishment of initial default EPS bearers, as such bearers may have already been set up by the first ATTACH procedure. Additionally, as part of the secondary ATTACH, the DeNB may select an MME for authentication of RN with the HSS of a particular operator.

Additionally, as a RN may be authenticated with each PLMN, the RN may include the PLMN ID in its system information PLMN ID list as an indicator for any incoming RN UE. Additionally, the RN may not be provided with any additional connectivity to the secondary PLMN MME and may maintain a single serving MME with the primary selected MME.

A RN may also maintain a NAS context and connection with the secondary RN MME for multiple operators as a result of the multiple ATTACH procedures, along with the primary RN MME whose connections and contexts may be established in the initial RN attach. In such an instance, the RN may be acting with UE-like behavior, and, as such, may use RRC/NAS signaling to the multiple RN MMEs. The DeNB, for example, acting as the proxy for RN, may route the signals to the appropriate RN MMEs.

In an additional embodiment, to authenticate the RN for a single RRC connection to a DeNB, a single NAS attach may be provided and/or used (e.g. or performed). For example, a RN may perform a single RRC connection establishment and single NAS ATTACH to the “primary” PLMN, as part of a RN attach procedure. Additionally, to provide identification of the RN (e.g. an assigned IMSI) that may be used for authentication with the primary PLMN, the RN may indicate in NAS AT TACH or RRC connection complete message operator PLMNs with which the RN may be authenticated for RN operation. The PLMNs with which the RN may be authenticated for RN operation may be a list of PLMN IDs and possibly unique IMSIs that may be assigned to the RN for each operator PLMN and/or a list of old temporary identities such as a GUTI that may have previously been assigned to the RN. According to one embodiment, the RN may include a PLMN list and identity into a message in the form of a new information element. With such information, the DeNB may perform an authentication procedure with each operator MME and HSS to ensure that the RN may be valid, or, additionally, the selected primary operator MME may contact the HSS of other operators for authentication if MMEs of one operator may have connection (e.g. a S6a connection) to the HSS of another operator.

In such an example embodiment, the RN may receive the outcome of the ATTACH procedure with primary operator, and authentication procedure with all other PLMNs in a NAS ATTACH ACCEPT message if the ATTACH procedure and authentication with the primary operator may be successful. The indication of PLMNs with which authentication may have succeeded and/or failed may be included in the message allowing the RN to determine which PLMN ID may be broadcasted for RAN sharing.

If or when there may be a negative outcome with a NAS ATTACH to the primary PLMN, the RN may receive an ATTACH REJECT with an indication of outcome of authentication with other PLMNs. The RN may use the successful authentication indication in another ATTACH REQUEST for RN operation. Additionally, the RN may receive, in both such messages, an authentication outcome list in the form of a new information element.

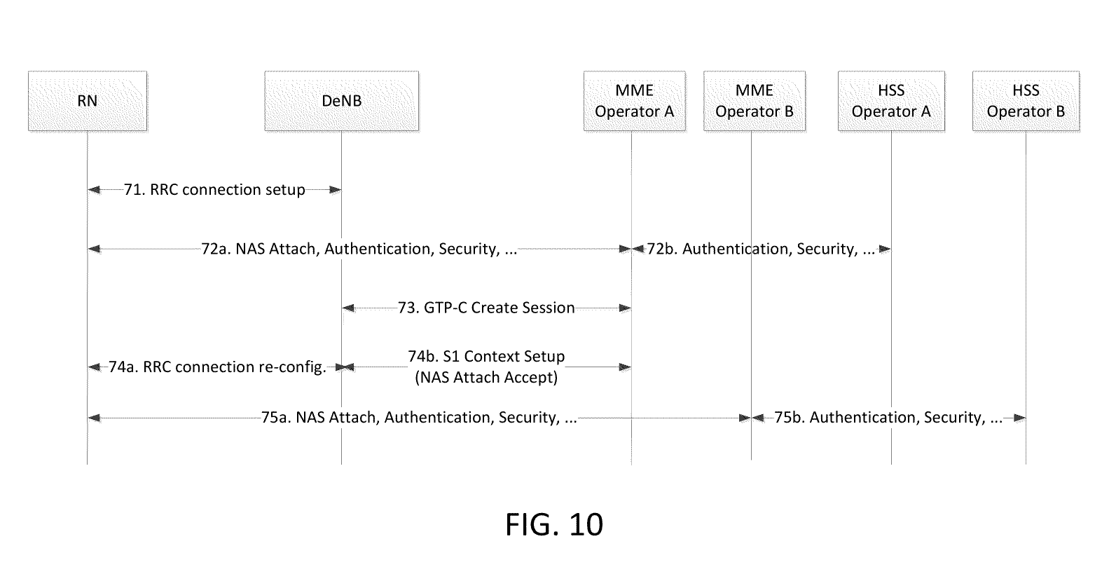

FIG. 10 illustrates an example embodiment of a sequence diagram or method for signaling of an ATTACH procedure. For example, as shown in FIG. 10, an RN attach procedures with authentication to multiple operators (e.g. piggybacked on separate RRC messages) may be performed.

Additionally, as shown in FIG. 10, at 71-74, an RN attach procedure may be performed or executed (e.g. between a RN, DeNB, a MME and HSS associated with an operator such as an operator A or a first operator). Then, at 75a and 75b, a “secondary” ATTACH procedure to an operator such as an operator B or a second operator for RN authentication may be performed or executed (e.g. between a RN, DenB, a MME and/or HSS associated with the operator such as the operator B or second operator). The DeNB may recognize the second attach as an authentication procedure and select and indicate the procedures, as such, to the MME of operator B. According to an example embodiment, the second ATTACH procedure may or may not (as shown in FIG. 10) create another set of EPS bearers with an operator such as the operator B or the second operator.

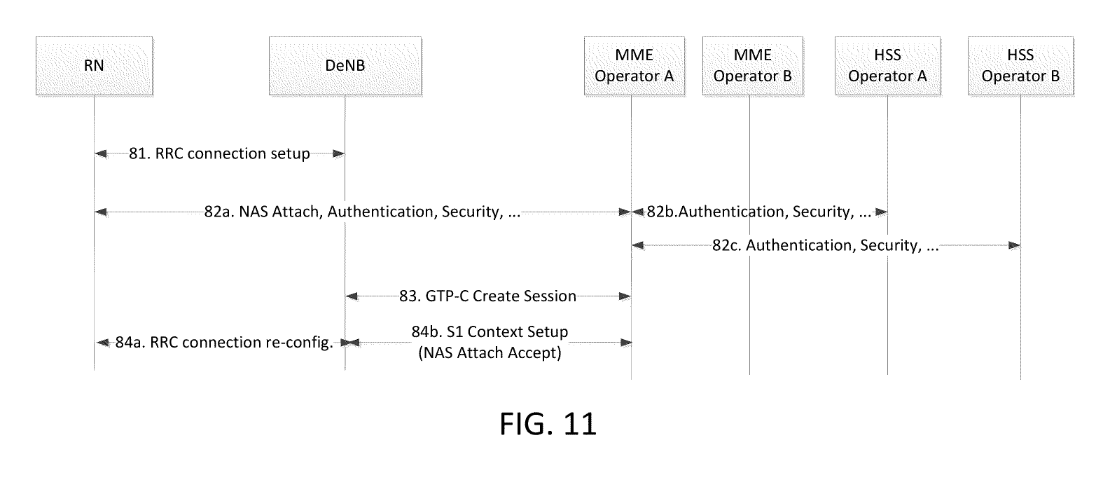

FIG. 11 further illustrates an example embodiment of an ATTACH and authentication procedure. As shown in FIG. 11, a RN may provide a single ATTACH procedure to a DeNB where the authentication to one operator may be done or performed by another operator (e.g. an operator A or first operator and/or an operator B or second operator).

For example, at 81 a RRC connection setup may be performed between a RN and/or DeNB. At 82a, a RN may provide a DeNB with an indication for an attach and authentication to multiple operators and MMEs by, for example, providing multiple identifies or identities. The DeNB may select an operator MME based on such information and may forward the ATTACH message (e.g. in its entirety) to the MME. At 82b, a normal authentication procedure of the RN with an operator A may be performed or executed. Then, at 82c, a MME may authenticate the RN with an operator B using a MME of operator B or possible directly with a HSS depending on the connectivity of EPC entities between operators. The authentication outcome and NAS attach outcome to the RN may indicate partial or full authentication failure.

Following the authentication, at 83, a session such as a GTP-C create session may be established between the DeNB and/or MME of an operator such as the operator A or the first operator; at 84a, a RRC connection reconfiguration (e.g. RRC Conn. Reconfig.) may be provided between the RN and/or the DeNB; and/or, at 84b, a S1 context setup (e.g. a NAS attach accept) may be performed between the DeNB and/or MME of an operator such as the operator A or first operator.

In both example embodiments shown in FIGS. 10 and 11, the outcome of a successful authentication for both operator A and B may allow or enable the RN to indicate such a successful authentication in, for example, the form of a PLMN ID for operator A and B that may be broadcast in a PLMN ID list in the system broadcast such that incoming RN UEs may select such operators.

Additionally, a multi-operator RN Registration such as a “Fake” Handover procedure or methods may be provided and/or used (e.g. performed as described herein). For example, as an alternative to the use of a RN attach procedure for a RN to authenticate itself to multiple operators and create contexts and instances as described herein, a DeNB may perform a handover like signaling procedure (a “fake” handover) toward or with additional core networks to be served by the RN.

To initiate the handover like signaling procedure (or “fake handover), a RN and/or DeNB may perform one or more of the following. The RN may attach to the DeNB and may perform authentication to an operator following a RN attach procedure (e.g. such as a Rel-10 RN attach procedure). The DeNB and RN may initiate a modified handover procedure that may resemble a S1 handover procedure, but that may be mainly for the purpose of creating a context for the RN to one or more operators for RAN sharing as well as establishing signaling and data bearers. The connectivity between the RN and DeNB (e.g. a Un interface) may not change. From a core network perspective, the handover-like procedure may genuinely look like a regular handover, although the MME may recognize the modified handover procedure. According to an example embodiment, as part of this handover-like procedure, the authentication of the RN may take place in an additional operator core network to be served by the RN.

As such, the RN context may be registered and authenticated to the core networks with the establishment of RN S1-MME traffic bearers and RN S1-U traffic bearers toward the core networks while one RRC/Attach procedure may be executed. According to an embodiment, such a procedure may be viewed as a core network aggregation procedure.

RAN sharing and user plane embodiments may further be provided and/or used. For example, as described herein, a single MME that may serve a RN may be selected (e.g. from a “primary” operator for the control plane side). According to an example embodiment (e.g. from the user plane perspective), if a serving GW (S-GW) and PDN GW (P-GW) for the RN may be selected from the EPC (as opposed to a DeNB co-located S-GW/P-GW for Rel-10 RN), then the RN may establish connection to multiple S-GWs/P-GWs from each PLMN. In order for the RN to properly route UE user plane traffic to the proper UE P-GW, the RN P-GW may be connected via GTP tunnel to a UE P-GW. In an example embodiment, due to network configuration, operator EPC elements that may be sharing the RN may not be inter-connected.

Additionally, the connection to the primary operator may be done by normal ATTACH procedures as described herein. For a subsequent S-GW/P-GW connectivity, a RN may initiate a NAS Service Request Procedure with the appropriate operator indicated such that the DeNB may properly route the message.

A RN may also initiate a bearer setup request towards a secondary RN MME to establish a second set of default EPS bearers towards the secondary operator P-GW/S-GW. The RN and RN P-GW/S-GW may then be provided with a different set of RN-to-UE EPS bearer mapping information for different operators that may be applied separately. As such, the set of available RN EPS bearers (e.g. which in Rel-10 RNs may be a maximum of 8 EPS bearers) may be distributed and divided amongst RN supporting operators. Such a distribution and division may be done on a pre-arranged pre-configuration basis where a certain number of RN EPS bearers may be allocated to a first operator, another number to a second operator and so on, or may be allocated on a more dynamic basis depending on the resource needs of the RN UEs and the level of QoS services that may be provided by the RN for the various operators. In some embodiments, given the limited number of RN EPS bearers, the number of operators in such a case may affect the QoS of bearers that the RN may be able to provide to each individual operator.

Additionally, RAN sharing and MRN mobility may be provided and/or used as described herein. For example, according to an example embodiment, a RN configuration for RAN sharing may be determined by RN OAM and operator MMEs that may available via connections to DeNB. As part of MRN mobility and inter-DeNB handovers, the availability of operator MMEs through the target DeNB may change and, as such, the RAN sharing configuration of a RN may also change upon a RN handover. According to an example embodiment, it may be desirable and efficient for the RN, and the least disruptive for RN UEs to have a static RAN sharing configuration throughout the lifetime of the MRN operation but due to network deployment and configurations, especially if the MRN crosses national borders a common RAN sharing for the RN may not be possible.

As part of a RN handover preparation, a source DeNB may incorporate a RAN sharing configuration of the RN and the RAN sharing configuration of neighboring candidate DeNBs along with other factors such as measurements from RN to determine a target DeNB for the RN.

In the instance of a RN handover where the RN may change its serving RN MME, the source MME may choose a target MME from an operator for which the RN is shared as part of the RAN sharing configuration, and for which the RN has already been authenticated.

After or during a handover, a RN may, based on DeNB RAN sharing configuration and/or RN OAM issued RAN sharing configuration for the RN, determine that the RAN sharing configuration may change from a configuration prior to the handover. The RAN sharing configuration of the target DeNB may be provided to the RN prior to execution of a handover by the RRC Handover Command from the source DeNB, or the RN may have the opportunity to read the target DeNB SIB as part of a synchronization procedure, or the RN may be provided with the target DeNB SIB via dedicated RRC signalling in the RN RRC Reconfiguration message.

Additionally, in example embodiments, the RN may add a PLMN and/or remove a PLMN for a RAN sharing configuration upon a handover with the target DeNB. For example, a new operator/PLMN may be added to list of RAN sharing operators and the RN may initiate an ATTACH procedure with the new operator for authentication purposes as described herein. Additionally, a RN may decide that a particular PLMN may no longer accessible and may remove such a PLMN. For example, the RN may perform a RN Detach procedure towards the network, signaling that the RN may be detaching from the particular inaccessible PLMN.

In an example embodiment, due to a RAN sharing configuration, a RN may change the corresponding PLMN ID list in a SIB associated therewith. Such a change may be reflected in available PLMNs/operators. According to an embodiment, such a change and reflection may impact the RN UEs such that the MMEs and PLMN may no longer be available through the MRN. In such a situation, the RN may attempt to redirect the UEs to another PLMN on the same cell or may release the UE until the appropriate PLMN becomes available.

RN support of Un connections or interfaces to multiple DeNBs may also be provided and/or used. For example, as disclosed herein, a RN may, based on pre-configuration or possibly configurations from OAM, be configured for RAN sharing. However, in an embodiment, the current DeNB to which the RN may attached may not support RAN sharing to the same operators. When the current DeNB may not support such a RAN sharing, a RN may have the radio capability to support multiple Un connections or interfaces to multiple DeNBs to fulfill a RAN sharing configuration. The RN may consider each Un connection independent from each other in each aspect of configuration of Un interface. The RN Uu interface may also continue to be single LTE cell (e.g. as specified in Rel-10).

As an example, a RN that may be configured for RAN sharing to an operator A and an operator B may connect to a DeNB that may belong to the operator A. The DeNB, however, may not provide RAN sharing support to operator B. In such a case, the RN may initiate an independent Un connection or interface to the operator B via another DeNB.

Additionally, a RN may attach to a DeNB that may belong to a particular operator (e.g. operator B), for example, based on the DeNB list that may be obtained from a RN OAM. Alternatively, a RN may use the existing Un connection or interface (e.g. to operator A) to establish another RN OAM (e.g. belonging to operator B) connection such that the appropriate DeNB list for operator B DeNBs may be retrieved or accessed. If a suitable operator B DeNB may not be found, a RN may perform a normal RN attach procedure (e.g. a Rel-10 attach procedure associated with the RN) towards the operator B.

The RN may, based on a current DeNB connection to the operator A, attempt to find a DeNB for the operator B that may be on a different carrier such that Un subframe configurations may not be used and may not interfere with a Un interface for DeNB of the operator A or may perform a cell re-selection type procedure in which the RN may scan the area for other suitable DeNB cells that may support both the operator A and B, for example, based on reading the broadcast information for the suitable DeNB cell. Additionally, a RN may re-adjust its cell selection priorities to avoid having multiple Un connections to support the configured RAN sharing.

For a RN with multiple Un connections or interfaces, mobility procedures may also be performed independently including measurements on the Un interface and a handover procedure as described herein.

A RN may also detach from a DeNB if the other Un connection or interface may properly support operators that may be part of the RAN sharing. In such a case, the RN and DeNB, prior to a detach, may transfer the context of the RN UEs such that the UEs may be supported now by the same DeNB.

Although the terms UE or WTRU may be used herein, it may and should be understood that the use of such terms may be used interchangeably and, as such, may not be distinguishable.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method of managing a handover of a mobile relay from a source eNB to a target eNB, the source eNB providing a backhaul link to the mobile relay and the mobile relay providing an access link to user equipment (UE), the method comprising:
receiving access information;
determining whether one or more target eNBs are capable of handling the mobile relay based on the access information;
selecting a target eNB that is capable of handing the mobile relay from the one or more target eNBs to handover the mobile relay to, the selected target eNB having a communication link with the source eNB; and
handing over the mobile relay from the source eNB to the selected target eNB using the communication link between the source eNB and selected target eNB.

2. The method of claim 1, wherein the access information is configured to indicate target eNBs that are mobile relay capable or mobile relay accessible.

3. The method of claim 2, wherein the access information further comprises measurements.

4. The method of claim 3, wherein selecting the target eNB that is capable of handling the mobile relay from one or more of the target eNBs to handover the mobile relay to further comprises:
determining a best neighboring target eNB from the one or more target eNBs that are capable of handing the mobile relay using the measurements, and
selecting the target eNB as the best neighboring target eNB from the one or more target eNBs based on the measurements.

5. The method of claim 4, wherein the access information comprises information associated with operating frequencies of cells associated with neighboring target eNBs; and wherein the measurements comprises at least one of the following: intra-frequency measurements associated with cells that are operating at the same operating frequency than the operating frequency of the mobile relay or inter-frequency measurements associated with cells that are operating at a different operating frequency as the operating frequency of the mobile relay.

6. The method of claim 4, wherein the handover of the mobile relay from the source eNB to the selected target eNB is responsive to the measurements indicating a higher communication quality with the best neighboring eNB than with the source eNB.

7. The method of claim 1, wherein the handover of the mobile relay from the source eNB to the selected target eNB is at least one of the following: autonomously initiated by the mobile relay using an indication to the source eNB or by initiating synchronization to the target eNB; initiated by the current base station; or preconfigured based on a known route of the mobile relay.

8. The method of claim 1, wherein the handing over of the mobile relay from the source eNB to the selected target eNB further comprises changing the mobile relay configuration to satisfy the selected neighboring base station operating parameters.

9. The method of claim 1, wherein the handover is responsive to a radio link failure (RLF) between the mobile relay and the source eNB.

10. The method of claim 9, wherein a re-establishment is configured to be performed to re-connect the mobile relay to at least one of the source eNB or selected target eNB when the RLF occurs.

11. The method of claim 1, further comprising determining whether one or more of the target eNBs is capable of handing the mobile relay operating in at least one of connected mode or IDLE mode, wherein the selected target eNB to handover the mobile relay to is further capable of handling the mobile relay in at least one of the connected mode or the IDLE mode.

12. The method of claim 1, wherein the mobile relay is configured to use radio access network (RAN) sharing.

13. The method of claim 12, wherein the mobile relay is configured to perform multiple authentication procedures to different operators or networks for the RAN sharing.

14. The method of claim 1, wherein handing over the mobile relay from the source eNB to the selected target eNB comprises modifying a E-UTRAN radio access bearer (E-RAB) associated with the mobile relay.

15. The method of claim 1, wherein handing over the mobile relay from the source eNB to the selected target eNB comprises selecting or re-selecting a mobility management entity (MME) for the UE under the mobile relay.

16. The method of claim 1, wherein the source eNB comprises a source donor eNB, and wherein the target eNB comprises a target donor eNB.

17. The method of claim 1, wherein the handover for the mobile relay from the source eNB to the selected target eNB is over a Un connection or interface.

18. The method of claim 17, further comprising:
providing mobility and connection control for the mobile relay over the Un connection or interface.

19. The method of claim 1, wherein information associated with the UE under the mobile relay as part of the handover is configured to be handled in a group or bundle such that the information associated with the UE and path switching of the UE is configured to be performed in a single or consolidated signal to the target DeNB and a MME.

20. A system for managing a handover of a mobile relay from a source eNB to a target eNB, the source eNB providing a backhaul link to the mobile relay and the mobile relay providing an access link to at least one wireless transmitter/receiver unit (WTRU), the system comprising:
a processor configured to:
receive access information;
determine whether one or more target eNBs are capable of handling the mobile relay based on the access information;
select a target eNB that is capable of handing the mobile relay from the one or more target eNBs to handover the mobile relay to, the selected target eNB having a communication link with the source eNB; and
handover the mobile relay from the source eNB to the selected target eNB using the communication link between the source eNB and selected target eNB.

21. The system of claim 20, wherein the access information is configured to indicate target eNBs that are mobile relay capable or mobile relay accessible.

22. The system of claim 21, wherein the access information further comprises measurements.

23. The system of claim 22, wherein, when selecting the target eNB that is capable of handling the mobile relay from one or more of the target eNBs to handover the mobile relay to, the processor is further configured to:
determine a best neighboring target eNB from the one or more target eNBs that are capable of handing the mobile relay using the measurements, and
select the target eNB as the best neighboring target eNB from the one or more target eNBs based on the measurements.

24. The system of claim 20, wherein the handover of the mobile relay from the source eNB to the selected target eNB is at least one of the following: autonomously initiated by the mobile relay using an indication to the source eNB or by initiating synchronization to the target eNB; initiated by the current base station; or preconfigured based on a known route of the mobile relay.

25. The system of claim 20, wherein the processor is further configured to determine whether one or more of the target eNBs is capable of handing the mobile relay operating in at least one of a connected mode or an IDLE mode, and wherein the selected target eNB to handover the mobile relay to is capable of handling the mobile relay in at least one of the connected mode or the IDLE mode based on the determination.

26. The system of claim 20, wherein the source eNB comprises a source donor eNB, and wherein the target eNB comprises a target donor eNB.

27. The system of claim 20, wherein the handover for the mobile relay from the source eNB to the selected target eNB is over a Un connection or interface.

28. The system of claim 27, wherein the processor is further configured to:
provide mobility and connection control for the mobile relay over the Un connection or interface.

29. The system of claim 20, wherein the mobile relay is configured to use radio access network (RAN) sharing.

30. The system of claim 29, wherein the mobile relay is configured to perform multiple authentication procedures to different operators or networks for the RAN sharing.
